(19) United States
(12) Patent Application Publication
(10) Pub. No.: US 2024/0123475 A1
(43) Pub. Date: Apr. 18, 2024

(54) CLEANING SYSTEM

(71) Applicant: Bristola, LLC, Waukee, IA (US)

(72) Inventor: Jared Burma, Waukee, IA (US)

(21) Appl. No.: 18/460,130

(22) Filed: Sep. 1, 2023

Related U.S. Application Data
(60) Provisional application No. 63/403,545, filed on Sep. 2, 2022.

(51) Int. Cl. B08B 9/08; B08B 5/04

(52) U.S. Cl. CPC B08B 9/08; B08B 5/04

(57) ABSTRACT

In one or more arrangements, a cleaning system for an anaerobic digester tank or covered lagoon is presented which has a box assembly attached to the tank or covered lagoon and a hose system is configured to move through the box assembly and the tank or covered lagoon. In one or more arrangements, the cleaning system may include a hose mover configured to move the hose system in and out of the tank or covered lagoon. In one or more arrangements, the hose system extends into and through an aperture of the box assembly and the cleaning system includes a seal configured to prevent liquid from escaping through the aperture of the box assembly. In one or more arrangements, the cleaning system may also include a collection box assembly configured to hold liquid which escapes from the box assembly.

### CROSS REFERENCE TO RELATED APPLICATIONS

This application claims the benefit of U.S. Provisional Application No. 63/403,545 filed on Sep. 2, 2022, titled “CLEANING SYSTEM,” the entirety of which is hereby incorporated by reference herein in its entirety.

### FIELD OF THE DISCLOSURE

This disclosure relates to removal of waste material from floors. More specifically, this disclosure relates to a cleaning system which allows for a cleaning device to enter into and be removed from an anaerobic digester tank or anaerobic lagoon, in order to clean the floors without allowing gasses and liquid to escape from the anaerobic digester tank or anaerobic lagoon.

### OVERVIEW OF THE DISCLOSURE

Removal of waste material from floors that are inaccessible during operation (inaccessible floors) conventionally requires halting operations to remove the waste material. For example, a floor may be inaccessible due to coverage with liquid, such as the floor of an anaerobic digester tank or anaerobic lagoon.

For optimate performance, waste accumulation on the inaccessible floor must be removed. Waste accumulates on an inaccessible floor under normal operating conditions. For example, with respect to inaccessible floors of anaerobic digester tanks or lagoons, the process of anaerobic digestion produces waste. During anaerobic digestion microorganisms (e.g. acetogenic bacteria, archaea) breakdown organic matter into biogas (e.g. methane, carbon dioxide) and solid and liquid digested material (e.g. waste) having elemental nutrients, such as nitrogen, phosphorus, and potassium. Biogas is used as a fuel for combustion and energy product. The waste may be further processed for other uses (e.g. fertilizer), may be recycled back into the digester, or may be discarded.

As an anaerobic digestion is carried out in the closed system of an anaerobic digester tank or lagoon that is sealed from the presence of oxygen, the anaerobic digester tank or lagoon fills with waste. This leads to reduced volume for anaerobic digestion to take place, with volume for anaerobic digestion reducing continuously as anaerobic digestion continues. Eventually anaerobic digester tank or lagoon require cleaning to remove the waste to maximize volume for anaerobic digestion to take place and to maintain the health of the microorganisms carrying out anaerobic digestion.

Conventional methods for cleaning anaerobic digester tanks and lagoons typically require manual cleaning, whereby production is first shut down, and the anaerobic digester tank or lagoon is vented and drained. After venting and draining, manual cleaning requires that a human enter the tank or lagoon to assist raking digested contents toward a vacuum where they can be removed. This manual process is both time consuming and hazardous.

The manual process of cleaning an anaerobic digester tank or lagoon can take at least two weeks, with additional time required to re-seed the anaerobic digester tank or lagoon with microorganisms to start anaerobic digestion. Not only does production cease all together during this cleaning period, but because cleaning requires shutting down the entire digester operation, anaerobic digester tanks and lagoons tend to be cleaned less frequently. Less frequent cleaning means that the anaerobic digester tank or lagoon operates at sub-optimal volume.

The manual process of cleaning an anaerobic digester tank or lagoon anaerobic digester tank or lagoon is hazardous for humans. Venting the anaerobic digester tank or lagoon requires releasing explosive and hazardous gasses that may be poisonous to humans (sulfuric acid and ammonia). Moreover, it is dangerous to put a human in a digester tank, as they encounter hazards in a confined space handling mechanical equipment.

Therefore, for all the reasons stated above, and the reasons stated below, there is a need in the art for an improved cleaning system for cleaning inaccessible floors without requiring shutting down operations to increase operational production. Thus, it is a primary objective of the disclosure to provide a cleaning system that improves upon the state of the art.

Another objective of the disclosure is to provide a cleaning system which is safe to operate.

Yet another objective of the disclosure is to provide a cleaning system which is relatively easy to build.

Another objective of the disclosure is to provide a cleaning system which is relatively friendly to build.

Yet another objective of the disclosure is to provide a cleaning system which can be built relatively quickly and efficiently.

Another objective of the disclosure is to provide a cleaning system which is easy to operate.

Yet another objective of the disclosure is to provide a cleaning system which is relatively cost friendly to manufacture.

Another objective of the disclosure is to provide a cleaning system which is relatively easy to transport.

Yet another objective of the disclosure is to provide a cleaning system which is aesthetically appealing.

Another objective of the disclosure is to provide a cleaning system which is robust.

Another objective of the disclosure is to provide a cleaning system which is relatively inexpensive.

Yet another objective of the disclosure is to provide a cleaning system which is not easily susceptible to wear and tear.

Another objective of the disclosure is to provide a cleaning system which has a long useful life.

Yet another objective of the disclosure is to provide a cleaning system which is efficient to use and operate.

These and other objects, features, or advantages of the disclosure will become apparent from the specification, figures, and claims.

### SUMMARY OF THE DISCLOSURE

In one or more arrangements, a cleaning system for an anaerobic digester tank or covered lagoon is presented which has a box assembly attached to the tank or covered lagoon and a hose system is configured to move through the box assembly and the tank or covered lagoon. In one or more arrangements, the cleaning system may include a hose mover configured to move the hose system in and out of the tank or covered lagoon. In one or more arrangements, the hose system extends into and through an aperture of the box assembly and the cleaning system includes a seal configured to prevent liquid from escaping through the aperture of the box assembly. In one or more arrangements, the cleaning system may also include a collection box assembly configured to hold liquid which escapes from the box assembly.

### BRIEF DESCRIPTION OF THE FIGURES

FIG. 1 is a perspective view of a cleaning system; the view showing the cleaning system having a box assembly with a carrier assembly, a collection box assembly with two collection boxes, and a hose mover assembly.

FIG. 2 is a perspective view of a collection box assembly; the view showing the collection box assembly having two collection boxes, each with a top plate, a bottom plate, opposing left and right side plates, a front end plate, and a rear end plate.

FIG. 3 is a side elevation view of a cleaning system; the view showing the cleaning system having a box assembly, a collection box assembly, and a drain assembly connected to the box assembly and the collection box assembly.

FIG. 4 is a perspective view of a box assembly; the view showing the box assembly having a frame assembly and a drive assembly of a carrier assembly within the frame assembly.

FIG. 5 is another perspective view of a box assembly; the view showing the box assembly having a frame assembly with end supports, side supports, floor supports, and vertical supports.

FIG. 6 is another perspective view of a box assembly; the view showing the box assembly having a carrier assembly within the frame assembly.

FIG. 7 is another perspective view of a box assembly; the view showing the box assembly having a carrier assembly within the frame assembly.

FIG. 8 is a top elevation view of a box assembly; the view showing the box assembly having a carrier assembly within the frame assembly.

FIG. 9 is an end elevation view of a box assembly; the view showing the box assembly having a cover assembly and a carrier assembly within a frame assembly.

FIG. 10 is an end elevation view of a box assembly; the view showing the box assembly having a cover assembly and a carrier assembly within a frame assembly; the view also showing portion of the drain assembly connected to the bottom side of the box system.

FIG. 11 is a side elevation view of a box assembly; the view showing the box assembly having a frame assembly with a side panel, a first end plate, and a second end plate.

FIG. 12 is a cut-away view of a box assembly; the view showing a side elevation view of the inside of a box assembly with a carrier assembly within the frame assembly of the box assembly.

FIG. 13 is another cut-away view of a box assembly; the view showing a side elevation view of the inside of a box assembly with a carrier assembly within the frame assembly of the box assembly.

FIG. 14A is a top elevation view of a first side panel; the view showing the panel having an upper portion and notches in the first side panel.

FIG. 14B is a side elevation view of a first side panel; the view showing the panel having notches in the first side panel.

FIG. 15A is a front elevation view of a carrier mount of a carrier assembly.

FIG. 15B is a side elevation view of a carrier mount of a carrier assembly.

FIG. 16A is a front elevation view of a guide support of a carrier assembly.

FIG. 16B is a side elevation view of a guide support of a carrier assembly.

FIG. 17A is a top elevation view of a carrier guide of a carrier assembly.

FIG. 17B is a side elevation view of a carrier guide of a carrier assembly.

FIG. 18A is a side elevation view of a cover assembly of a frame assembly of a box assembly.

FIG. 18B is a front elevation view of a cover assembly of a frame assembly of a box assembly.

FIG. 18C is a top elevation view of a cover assembly of a frame assembly of a box assembly.

FIG. 19 is a side elevation view of a carriage of a carrier assembly; the view showing the carriage having a main tube, support tubes, and connector plates.

FIG. 20 is a top elevation view of a carriage of a carrier assembly; the view showing the carriage having a main tube, support tubes, and connector plates.

FIG. 21 is a front elevation view of a carriage of a carrier assembly; the view showing the carriage having a main tube with an orifice, support tubes, and connector plates.

FIG. 22A is a top elevation view of carrier chains of a drive assembly of a carrier assembly.

FIG. 22B is a front elevation view of carrier chains of a drive assembly of a carrier assembly.

FIG. 22C is a side elevation view of carrier chains of a drive assembly of a carrier assembly.

FIG. 23 is a perspective view of a hose mover assembly; the view showing the hose mover assembly having a frame, a guide assembly, and a roller system with a drive assembly.

FIG. 24 is a perspective view of a hose mover assembly; the view showing the hose mover assembly having a frame, a guide assembly, and a roller system.

FIG. 25 is a perspective view of an upper roller assembly of a roller system of a hose mover assembly; the view showing the upper roller assembly having springs, shaft holders, and idler roller shafts.

FIG. 26 is a perspective view of a frame and a guide assembly of a hose mover assembly; the view showing the frame having a forward end member, support members, a rear end member, roller mounting plates, a drive assembly mounting plate, and a motor mounting plate.

FIG. 27 is a front elevation view of a frame and a guide assembly of a hose mover assembly; the view showing the frame having a forward end member with connection plates; the view also showing the guide assembly having a top member, side members, and gussets.

FIG. 28 is a top elevation view of a frame and guide assembly of a hose mover assembly; the view showing the frame having a forward end member, support members, a rear end member, roller mounting plates, a drive assembly mounting plate, and a motor mounting plate.

FIG. 29 is a side elevation view of a frame and guide assembly of a hose mover assembly; the view showing the frame having a forward end member, support members, and a rear end member with leg tubes; the view also showing the guide assembly having a top member, side members, and a gusset.

FIG. 30 is another side elevation view of a frame and guide assembly of a hose mover assembly; the view showing the frame having a forward end member, support members, a rear end member with leg tubes, roller mounting plates, and a drive assembly mounting plate; the view also showing the guide assembly having a top member, side members, a bottom member, and a gusset.

FIG. 31A is a front elevation view of a connection plate of a frame of a hose mover assembly.

FIG. 31B is a side elevation view of a connection plate of a frame of a hose mover assembly.

FIG. 32A is a top elevation view of a drive assembly mounting plate of a frame of a hose mover assembly.

FIG. 32B is a side elevation view of a drive assembly mounting plate of a frame of a hose mover assembly; the view showing the drive assembly mounting plate having an upper portion and a lower portion with openings.

FIG. 33A is a top elevation view of a second tensioner bar with an idler shaft and slots.

FIG. 33B is a side elevation view of a second tensioner bar with an idler shaft and slots.

FIG. 34A is a side elevation view of a connector chain of a drive assembly of a roller system of a hose mover assembly.

FIG. 34B is a front elevation view of a connector chain of a drive assembly of a roller system of a hose mover assembly.

FIG. 35A is a side elevation view of a drive chain of a drive assembly of a roller system of a hose mover assembly.

FIG. 35B is a front elevation view of a drive chain of a drive assembly of a roller system of a hose mover assembly.

FIG. 36A is a front elevation view of an idler roller shaft of an upper roller assembly of a hose mover assembly.

FIG. 36B is a side elevation view of an idler roller shaft of an upper roller assembly of a hose mover assembly; the view showing the idler roller shaft having opposing ends.

FIG. 37A is a side elevation view of a mounting plate of an upper roller assembly of a hose mover assembly; the view showing the idler roller shaft having opposing ends.

FIG. 37B is a top elevation view of a mounting plate of an upper roller assembly of a hose mover assembly; the view showing the idler roller shaft having opposing ends; the view showing the mounting plate having outer openings and inner openings.

FIG. 38A is a top elevation view of a lower angle of a lower roller assembly of a hose mover assembly; the view showing the lower angle having a base with slots.

FIG. 38B is a side elevation view of a lower angle of a lower roller assembly of a hose mover assembly; the view showing the lower angle having a base and a vertical portion.

FIG. 38C is a front elevation view of a lower angle of a lower roller assembly of a hose mover assembly; the view showing the lower angle having a vertical portion with holes.

FIG. 39A is a front elevation view of a roller shaft of roller sprockets of a drive assembly of a hose mover assembly.

FIG. 39B is a side elevation view of a roller shaft of roller sprockets of a drive assembly of a hose mover assembly.

FIG. 40A is a front elevation view of a drive shaft of a motor of a drive assembly of a hose mover assembly.

FIG. 40B is a side elevation view of a drive shaft of a motor of a drive assembly of a hose mover assembly.

FIG. 41A is a top elevation view of a shaft holder of an upper roller assembly of a hose mover assembly; the view showing the shaft holder having a top opening.

FIG. 41B is a front elevation view of a shaft holder of an upper roller assembly of a hose mover assembly.

FIG. 41C is a side elevation view of a shaft holder of an upper roller assembly of a hose mover assembly; the view showing the shaft holder having a side opening.

FIG. 42A is a front elevation view of a sprocket guard of a drive assembly of a hose mover assembly; the view showing the sprocket guard having a top end, a bottom edge, and an interior surface.

FIG. 42B is a side elevation view of a sprocket guard of a drive assembly of a hose mover assembly; the view showing the sprocket guard having opposing ends, an exterior surface, and notches.

FIG. 43A is a front elevation view of a roller of a guide assembly of a hose mover assembly; the view showing the rollers having an attachment member.

FIG. 43B is a side elevation view of a roller of a guide assembly of a hose mover assembly; the view showing the rollers having an attachment member.

FIG. 43C is a top elevation view of a roller of a guide assembly of a hose mover assembly; the view showing the rollers having an attachment member.

FIG. 44A is a side elevation view of a leg of a frame of a guide assembly of a hose mover assembly; the view showing the leg having a ground engagement member.

FIG. 44B is a top elevation view of a leg of a frame of a guide assembly of a hose mover assembly; the view showing the leg having a ground engagement member.

FIG. 45A is a front elevation view of a top angle of an upper roller assembly of a hose mover assembly; the view showing the top angle having an upper surface and tabs.

FIG. 45B is a side elevation view of a top angle of an upper roller assembly of a hose mover assembly; the view showing the top angle having tabs.

FIG. 45C is a bottom elevation view of a top angle of an upper roller assembly of a hose mover assembly; the view showing the top angle having slots and tabs with a hole.

FIG. 46A is a top elevation view of a tab of a top angle of an upper roller assembly of a hose mover assembly; the view showing the tab having a hole.

FIG. 46B is a side elevation view of a tab of a top angle of an upper roller assembly of a hose mover assembly.

FIG. 47A is a top elevation view of a first tensioner bar of a drive assembly of a hose mover assembly; the view showing the first tensioner bar having openings and an idler shaft.

FIG. 47B is a side elevation view of a first tensioner bar of a drive assembly of a hose mover assembly; the view showing the first tensioner bar having an idler shaft.

FIG. 48 is a perspective and partial cut-away view of a hose system; the view showing the hose system having an outer hose, an inner hose, a hose connector, an electrical cable, a fill valve, a pressure relief valve, and a pressure gauge.

FIG. 49 is a perspective view of a hose connector of a hose system; the view showing the hose connector having a first end with a first threaded portion and an angled portion; the view showing the hose connector having a body with a cap; the view also showing the hose connector having a second end with a first threaded portion, an angled portion, and a second threaded portion.

FIG. 50 is a top elevation view of a body of a hose connector of a hose system; the view showing the body having a groove.

FIG. 51 is a side elevation view of a body of a hose connector of a hose system; the view showing the body having a top surface with a groove and an internally threaded hollow interior.

FIG. 52 is a bottom elevation view of a body of a hose connector of a hose system.

FIG. 53 is a cut-away view of a cap of a body of a hose connector of a hose system; the view showing the cap having a groove.

FIG. 54 is a bottom elevation view of a cap of a body of a hose connector of a hose system; the view showing the cap having a groove.

FIG. 55 is a side elevation view of a cap of a body of a hose connector of a hose system.

FIG. 56 is a perspective view of a cap of a body of a hose connector of a hose system; the view showing the cap having a top surface, a bottom surface, and a groove.

FIG. 57 is a front elevation view of a cap of a body of a hose connector of a hose system; the view showing the cap having a top surface, a bottom surface, and a groove.

FIG. 58 is a top elevation view of a first half of a seal of a hose system; the view showing the first half having a second side and a first side with notches and contact surfaces.

FIG. 59 is a side elevation view of a first half of a seal of a hose system; the view showing the first half having end surfaces and a rounded interior surface.

FIG. 60 is a perspective view of a first half of a seal of a hose system; the view showing the first half having a rounded interior surface, end surfaces, and a backer ring.

FIG. 61 is a top elevation view of a second half of a seal of a hose system; the view showing the second half having a second side and a first side with notches and contact surfaces.

FIG. 62 is a side elevation view of a second half of a seal of a hose system; the view showing the second half having end surfaces, a rounded interior surface, and a backer ring.

FIG. 63 is a perspective view of a second half of a seal of a hose system; the view showing the second half having a rounded interior surface, end surfaces, and a backer ring.

FIG. 64A is a front elevation view of a backer ring of a seal of a hose system.

FIG. 64B is a side elevation view of a backer ring of a seal of a hose system.

FIG. 65 is an elevation view showing a seal within an aperture of a second end plate of a frame assembly of a box assembly.

FIG. 66 is a section view of a seal within an aperture of a second end plate of a frame assembly of a box assembly; the view also showing the hose system passing through the seal and the aperture of the second end plate.

FIG. 67 is a perspective view of a cleaning system; the view showing the cleaning system having a box assembly, a collection box assembly, and a hose system; the view showing the hose system extending through the box assembly and the collection box assembly; the view also showing the hose system connected to a tank of a tanker truck configured to haul away waste cleaned from the floor of the closes system and pumped through the hose system.

FIG. 68 is a side elevation view of a cleaning system; the view showing the cleaning system having a box assembly, an inflatable seal assembly, a collection box assembly, and a hose mover assembly.

FIG. 69 is a side elevation view of an inflatable seal assembly; the view showing the inflatable seal assembly having a front plate, a rear plate, spacers, and a housing.

FIG. 70 is a section view of a cleaning system; the view showing the cleaning system having a box assembly, an inflatable seal assembly, a collection box assembly, and a hose mover assembly.

FIG. 71 is a perspective view of an inflatable seal assembly; the view showing the inflatable seal assembly having a front plate, a rear plate, and an inflatable seal.

FIG. 72 is a section view of an inflatable seal assembly; the view showing the inflatable seal assembly having a front plate, a rear plate, a housing, and an inflatable seal that is at least partially inflated.

FIG. 73 is a section view of an inflatable seal assembly; the view showing the inflatable seal assembly having a front plate, a rear plate, a housing, and an inflatable seal that nearly or completely deflated.

FIG. 74 is a perspective view of a cleaning system; the view showing the cleaning system having a box assembly, an inflatable seal assembly, a collection box assembly, and a hose mover system.

FIG. 75 is a perspective view of a sensor of a carrier assembly; the view showing the sensor positioned near the front of a main tube.

FIG. 76 is a perspective view of a sensor of a carrier assembly; the view showing the sensor positioned near the back of a main tube.

FIG. 77 is a perspective view of a sensor of a carrier assembly; the view showing the sensor in contact with a portion of a cleaning device in an “up” position.

FIG. 78 is a perspective view of a sensor of a carrier; the view showing the sensor disconnected from a portion of a cleaning device.

FIG. 79 is a wiring diagram of an electrical system of system 10.

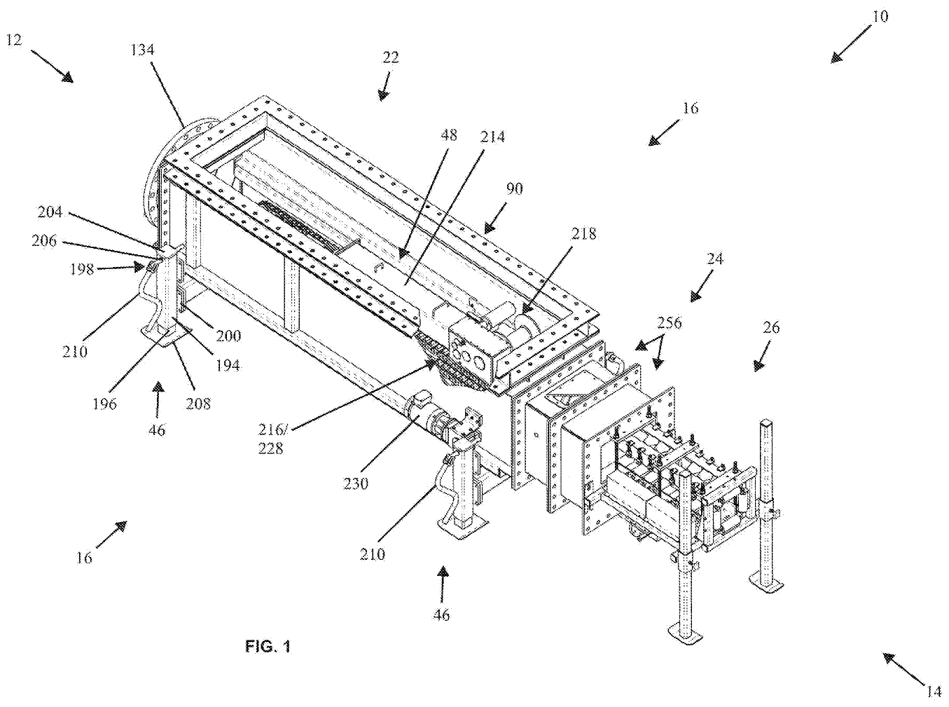

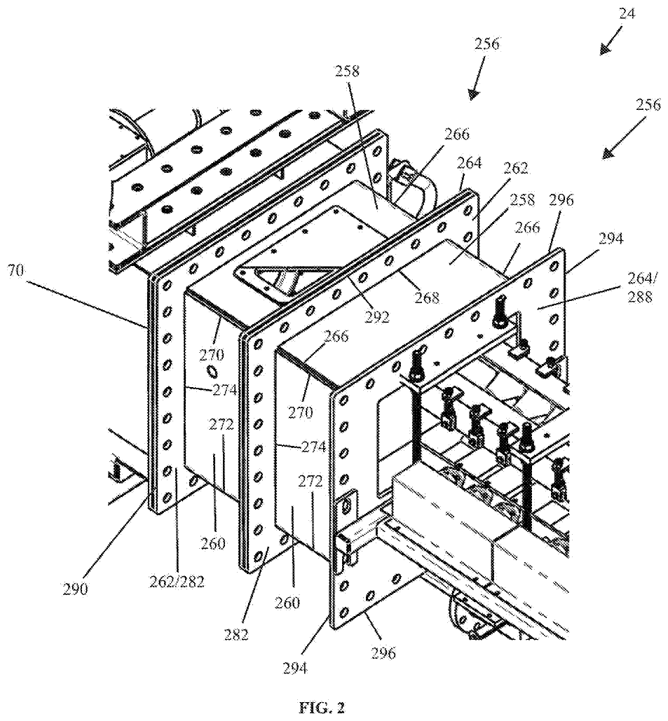

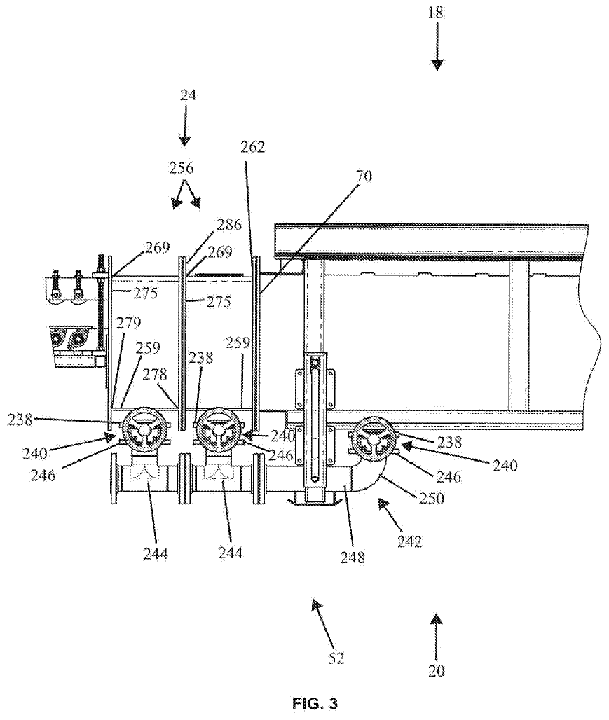

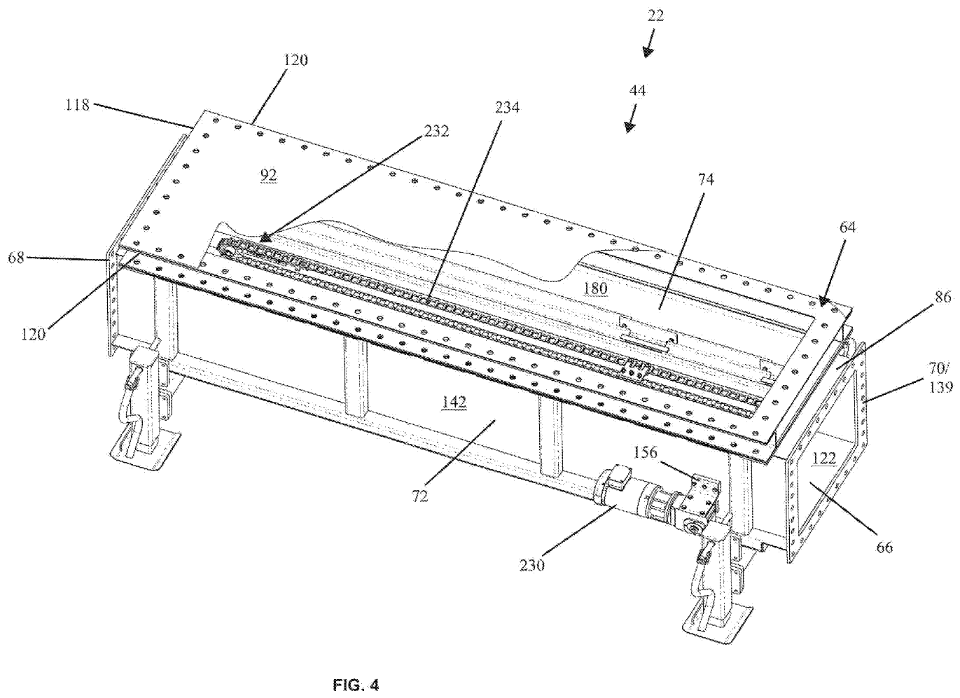

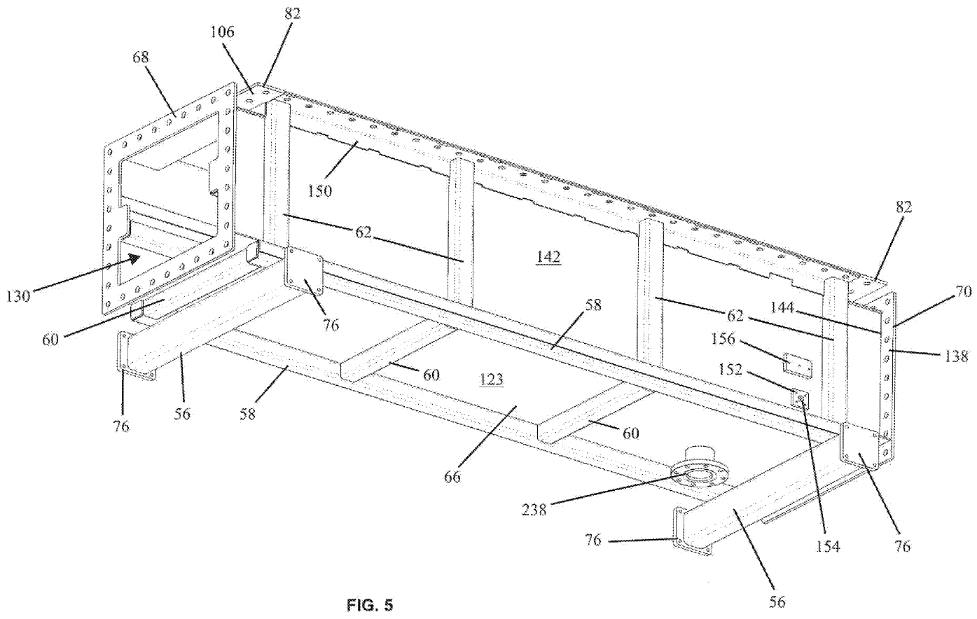

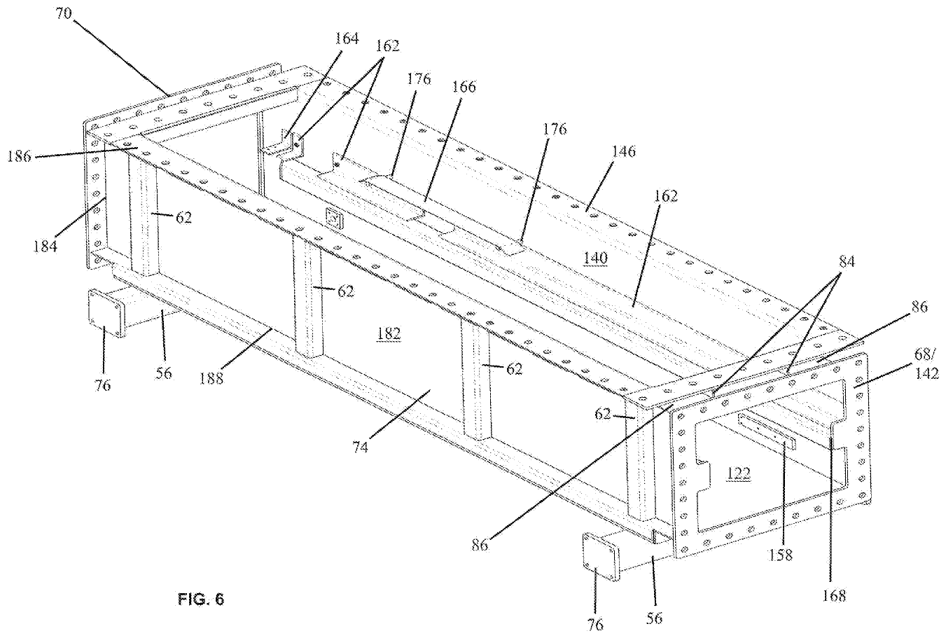

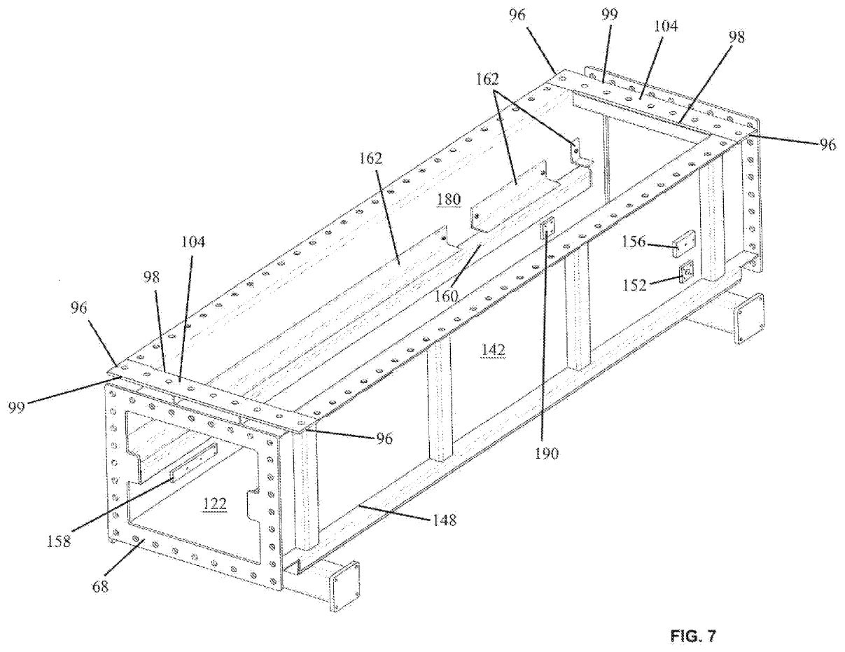

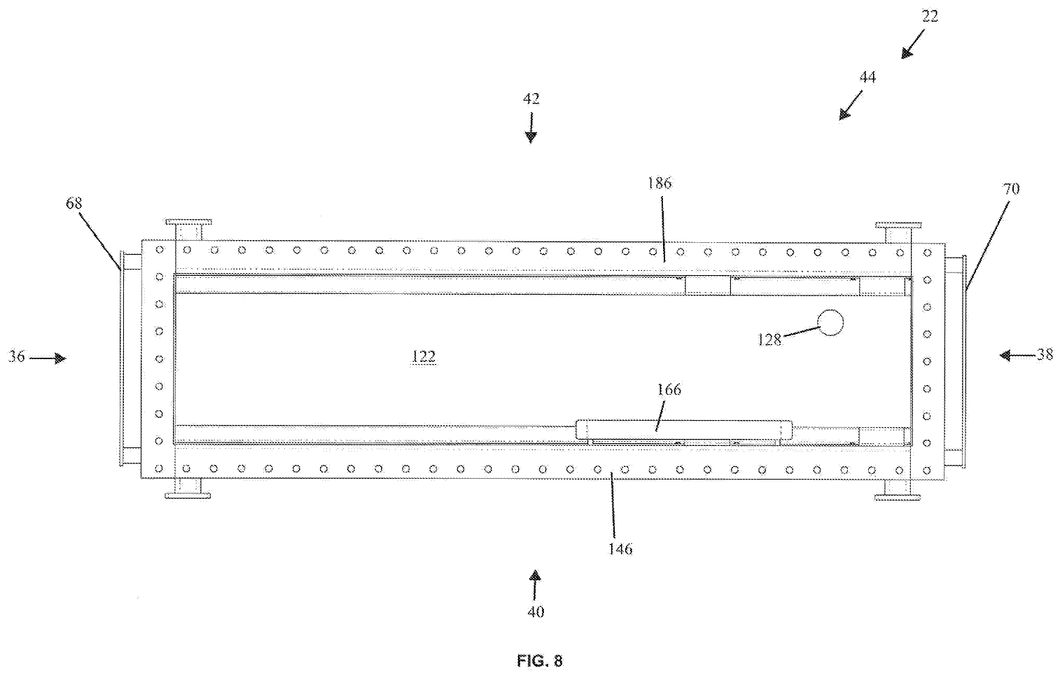

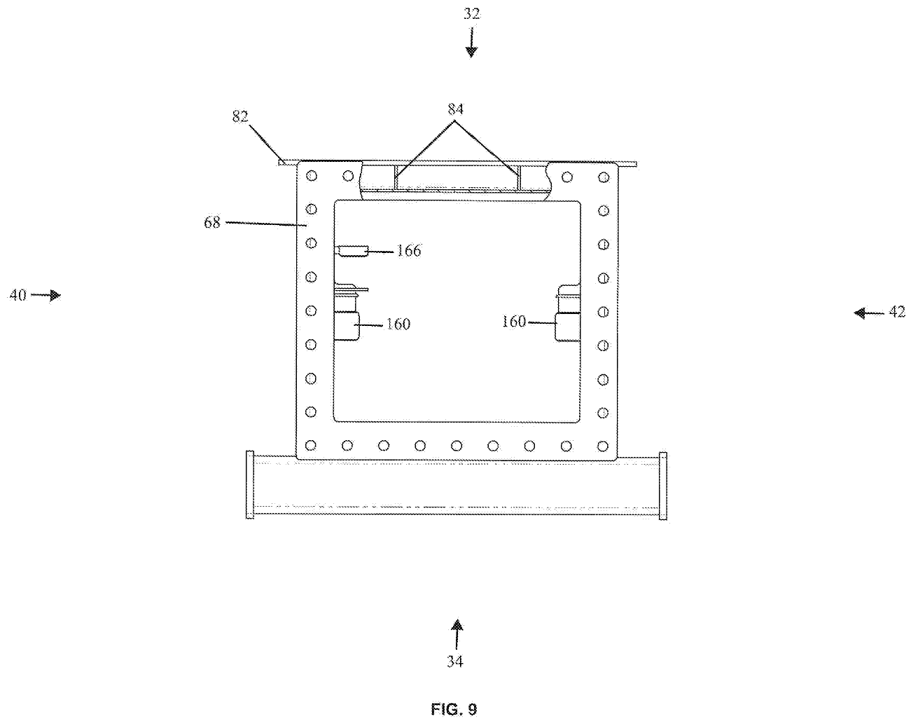

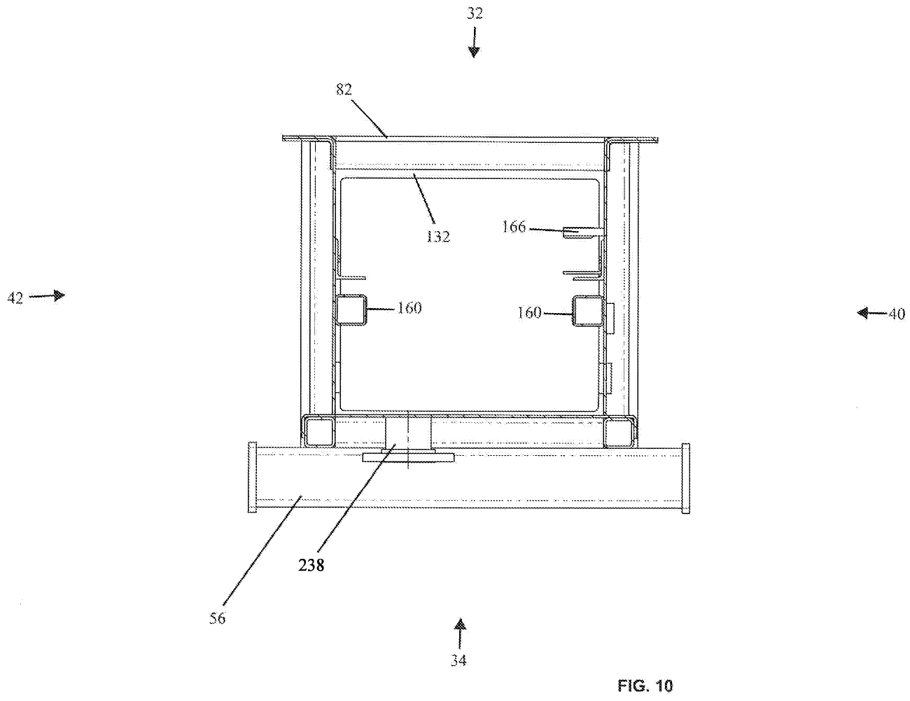

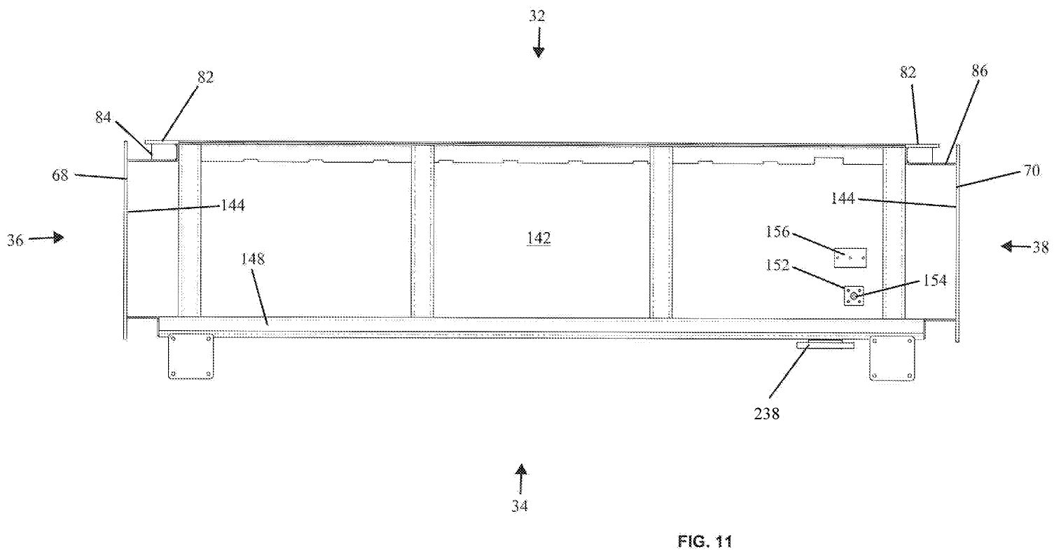

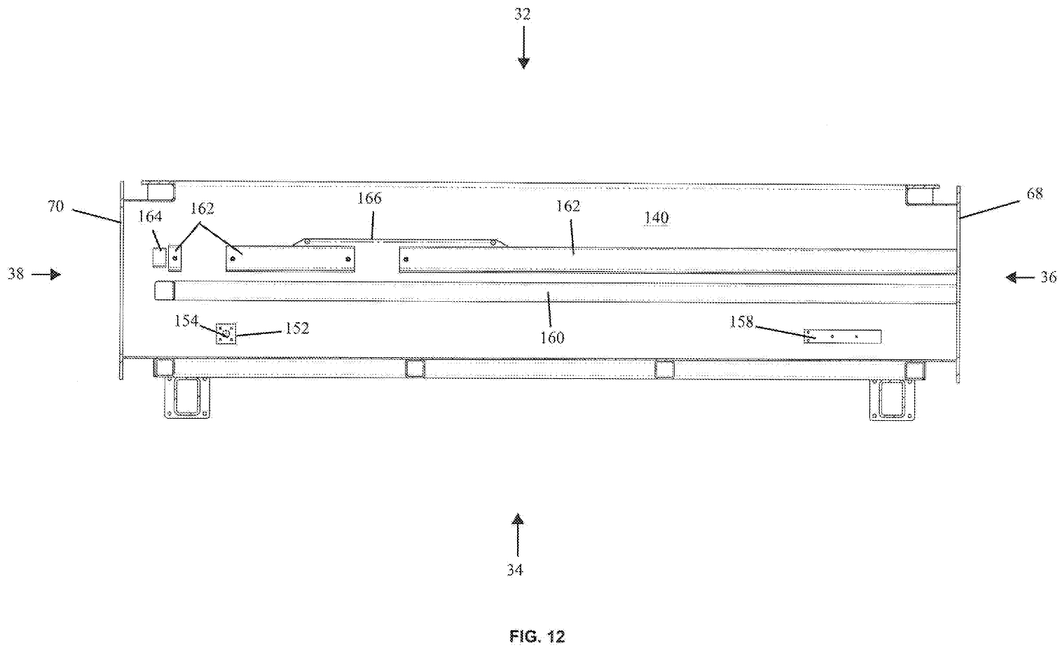

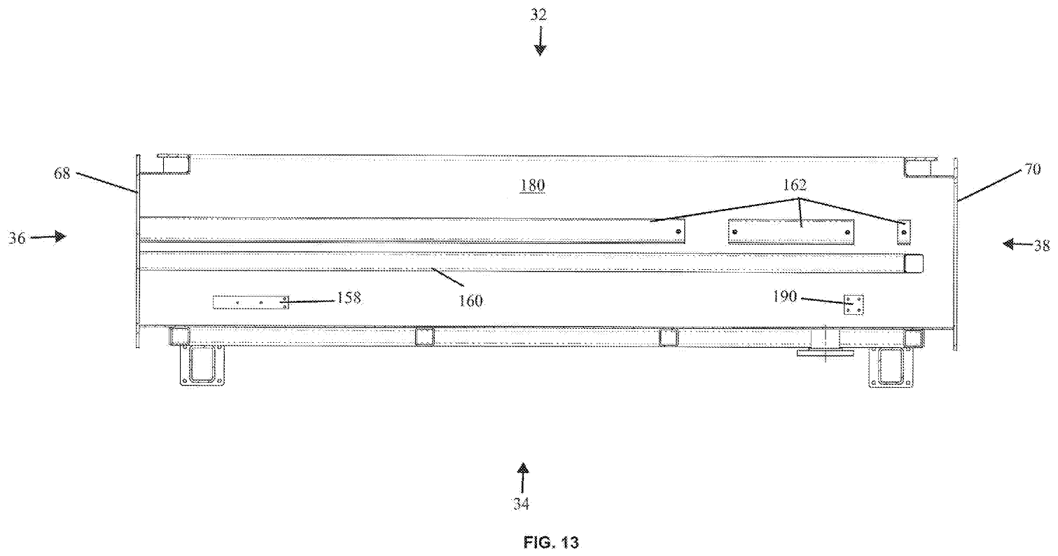

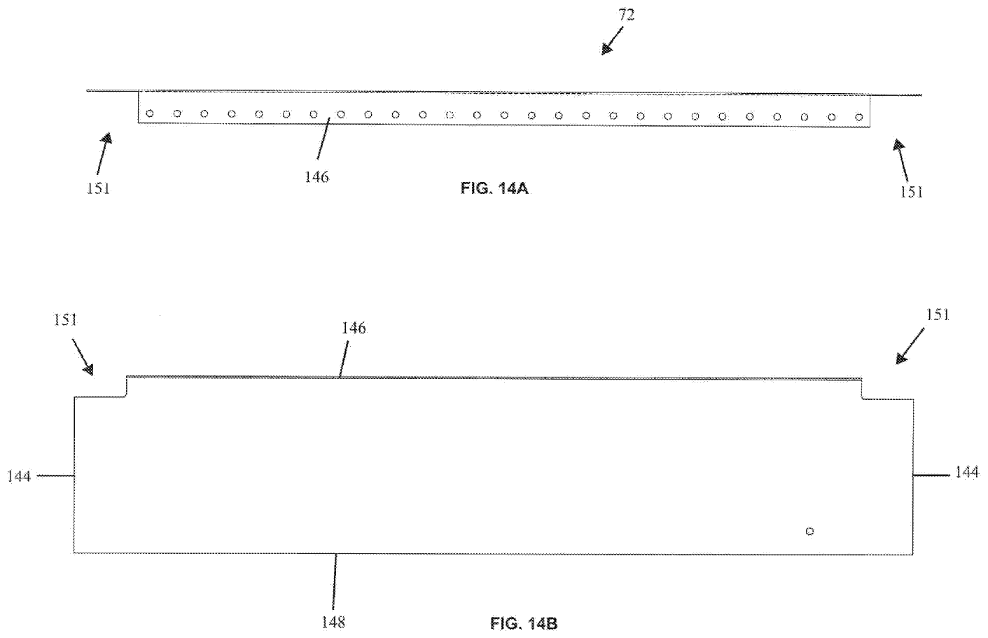

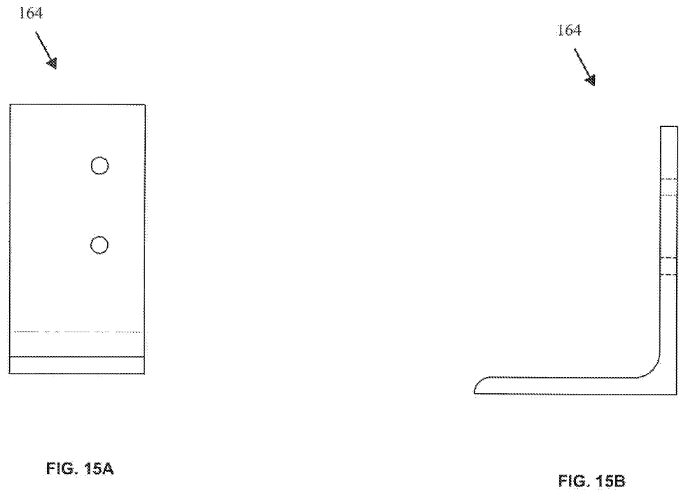

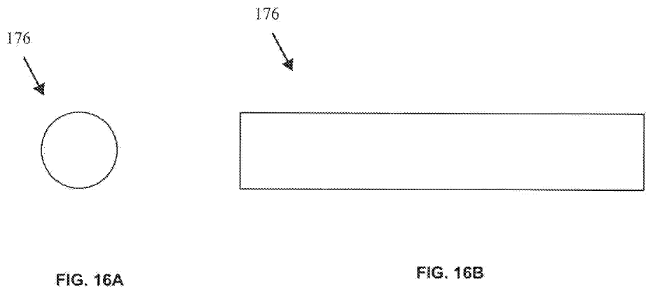

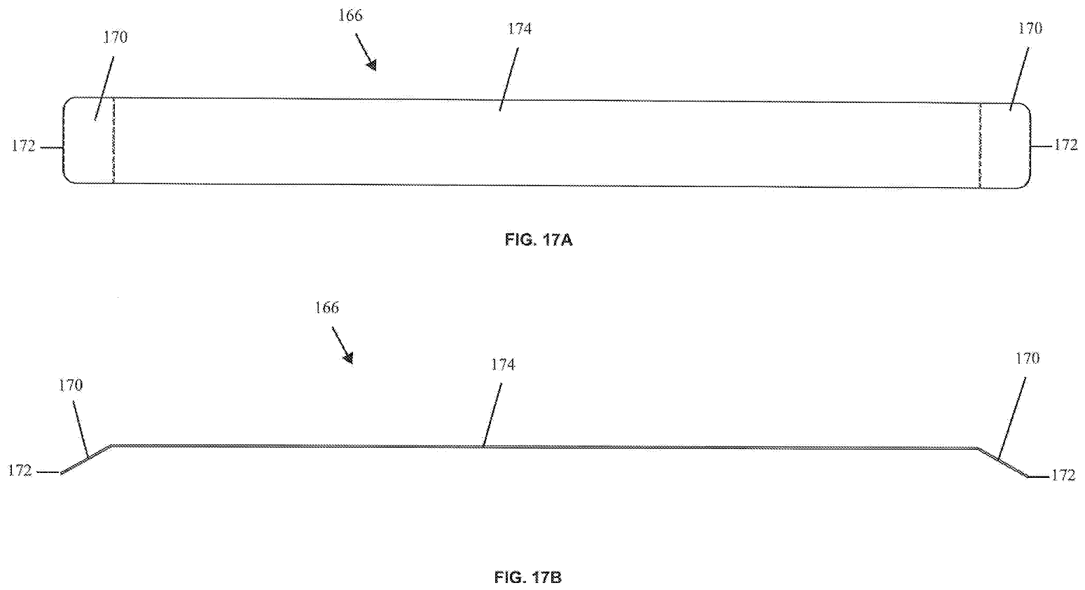

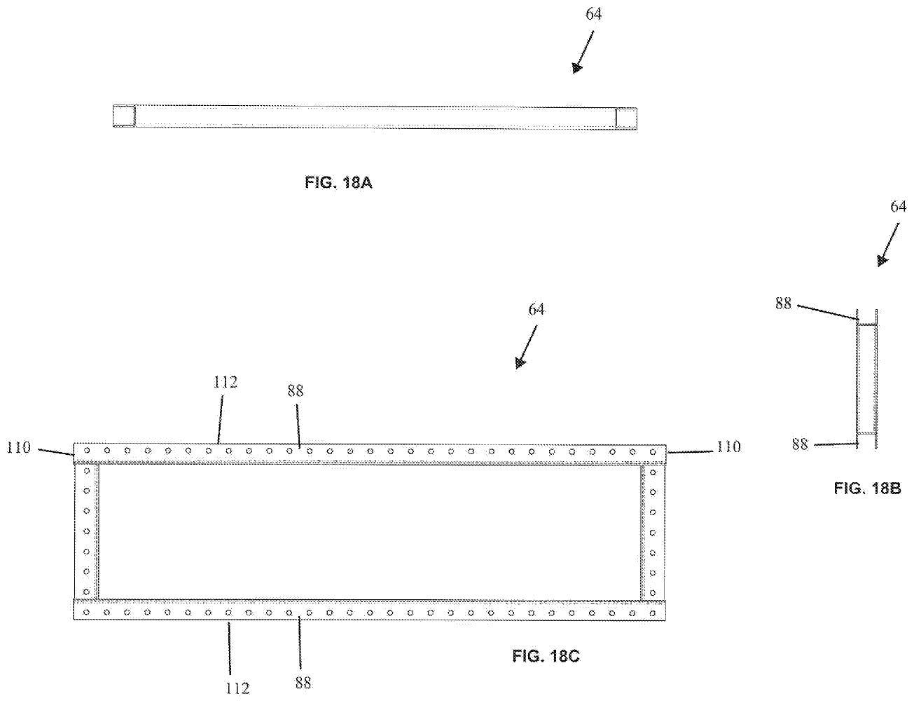

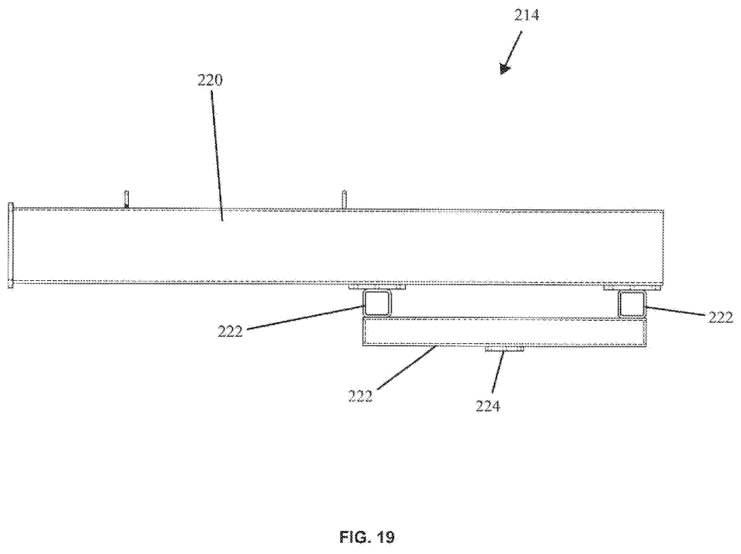

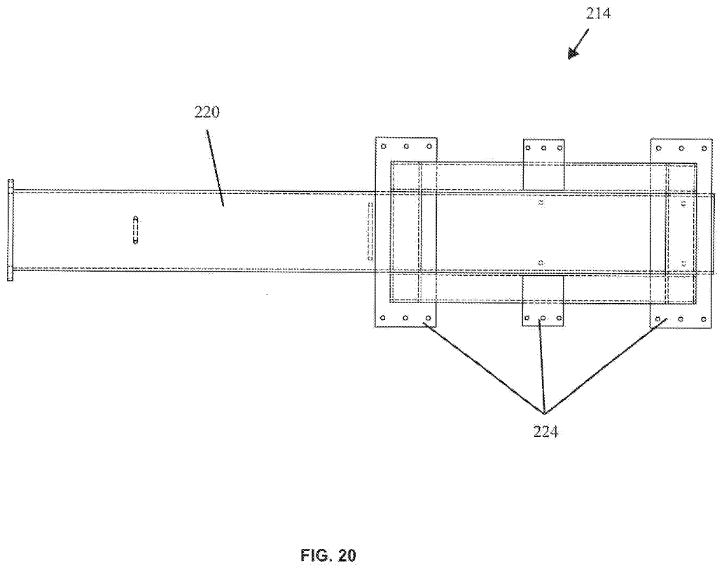

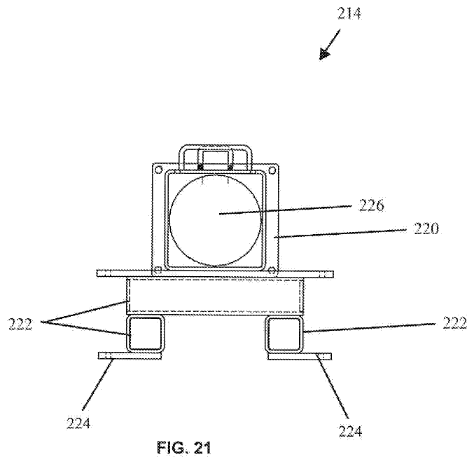

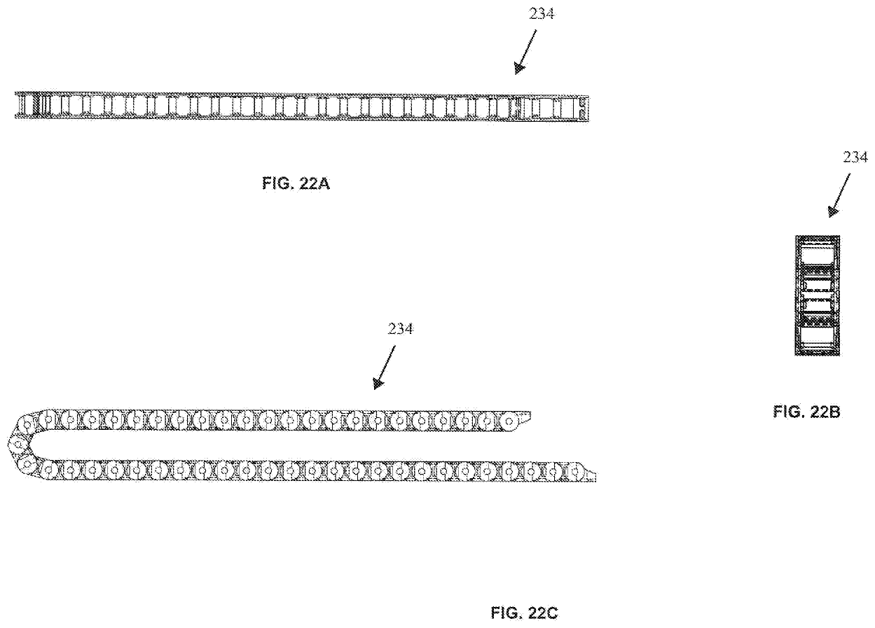

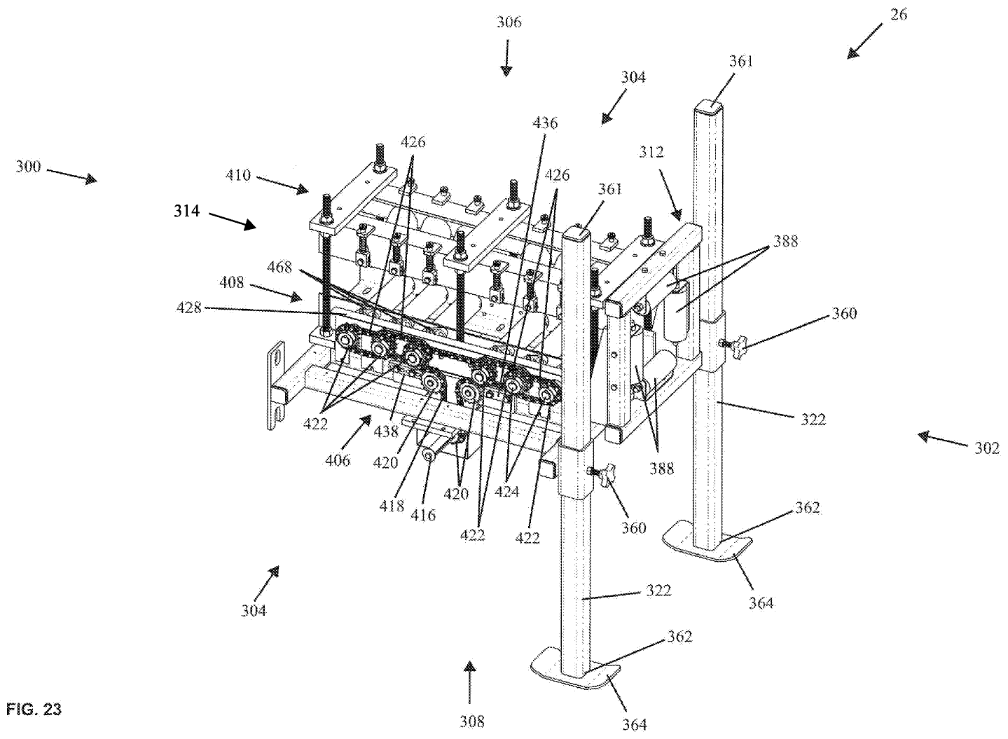

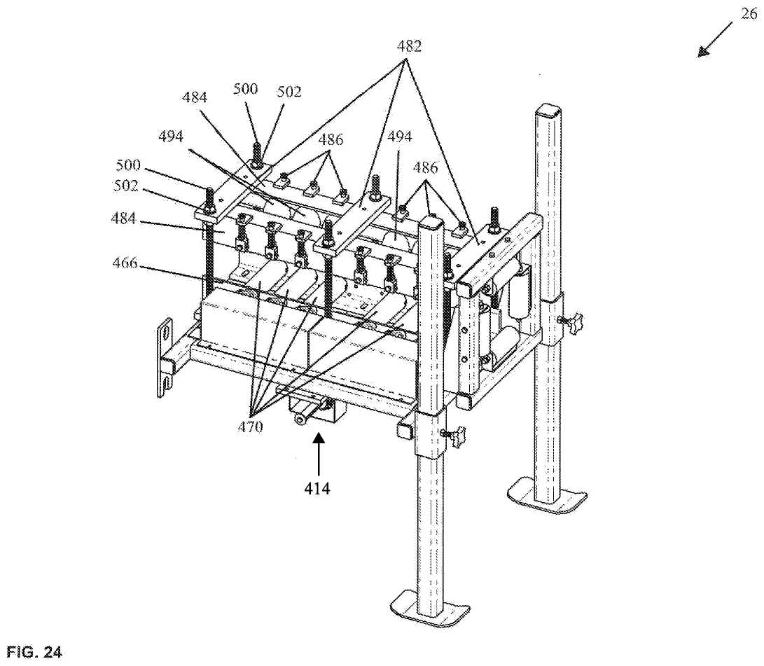

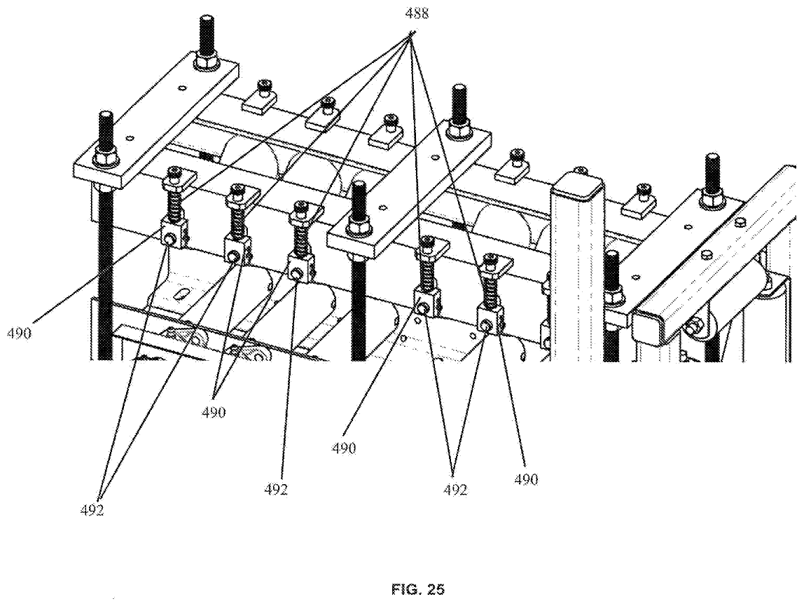

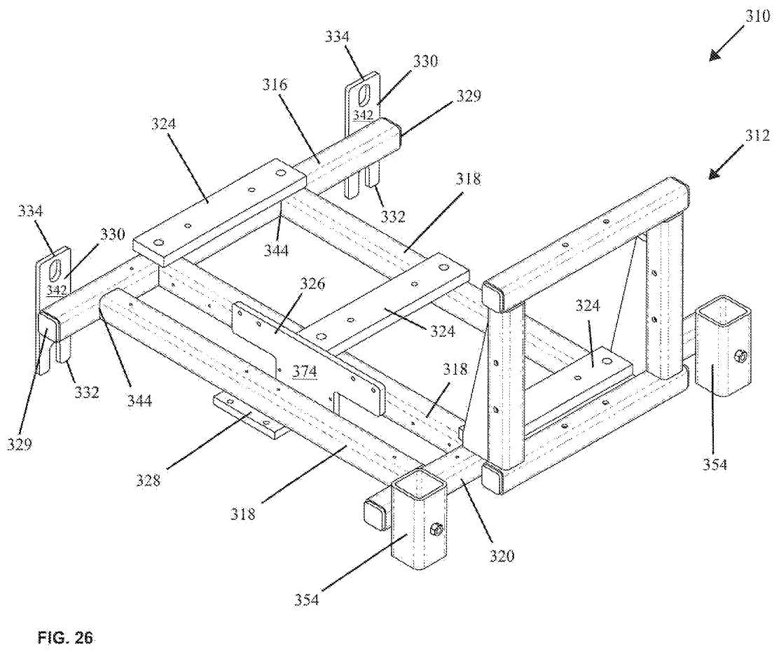

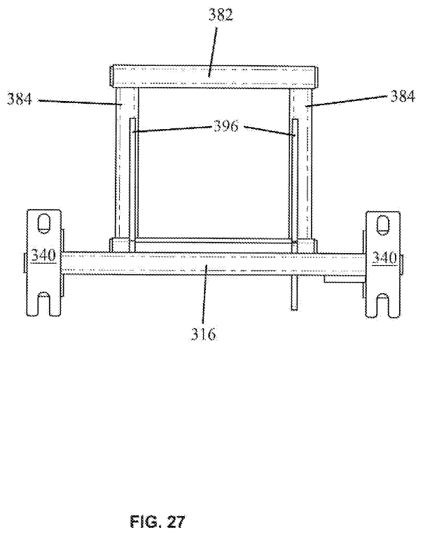

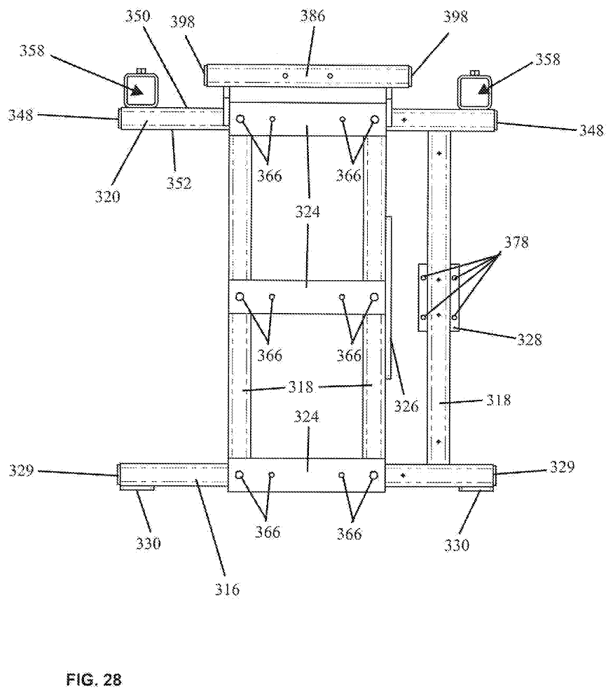

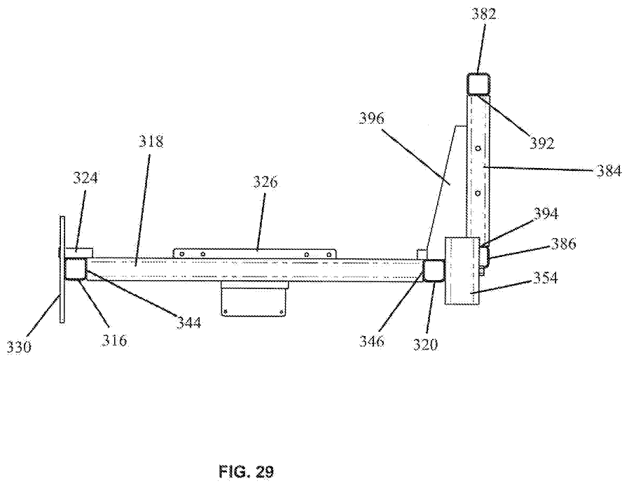

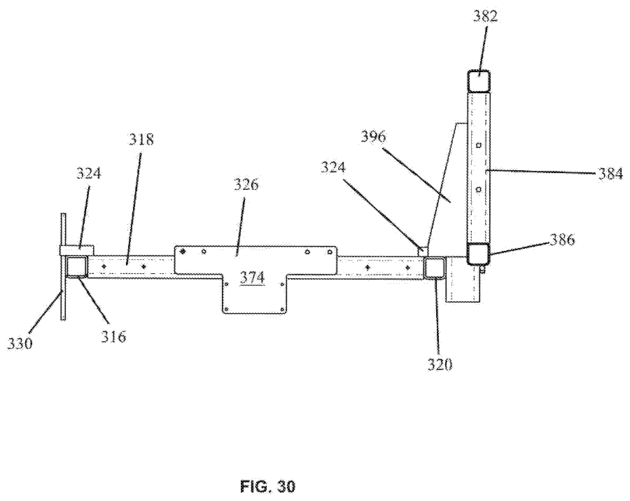

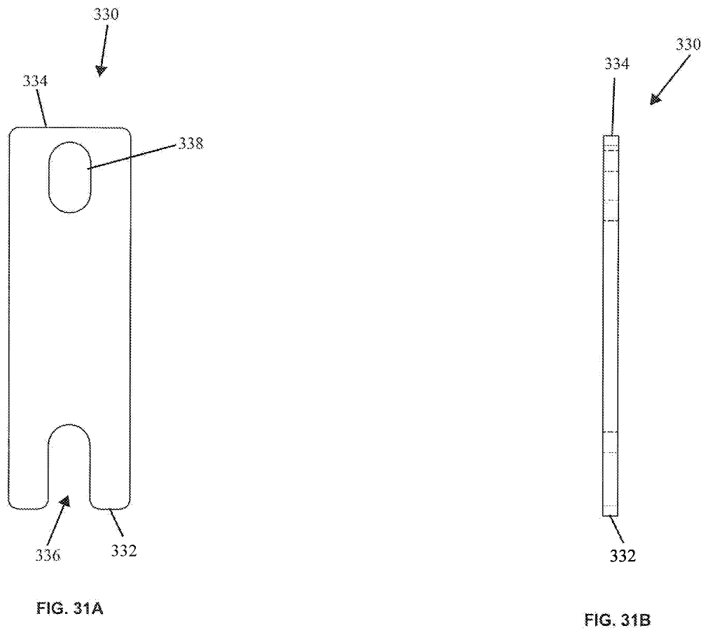

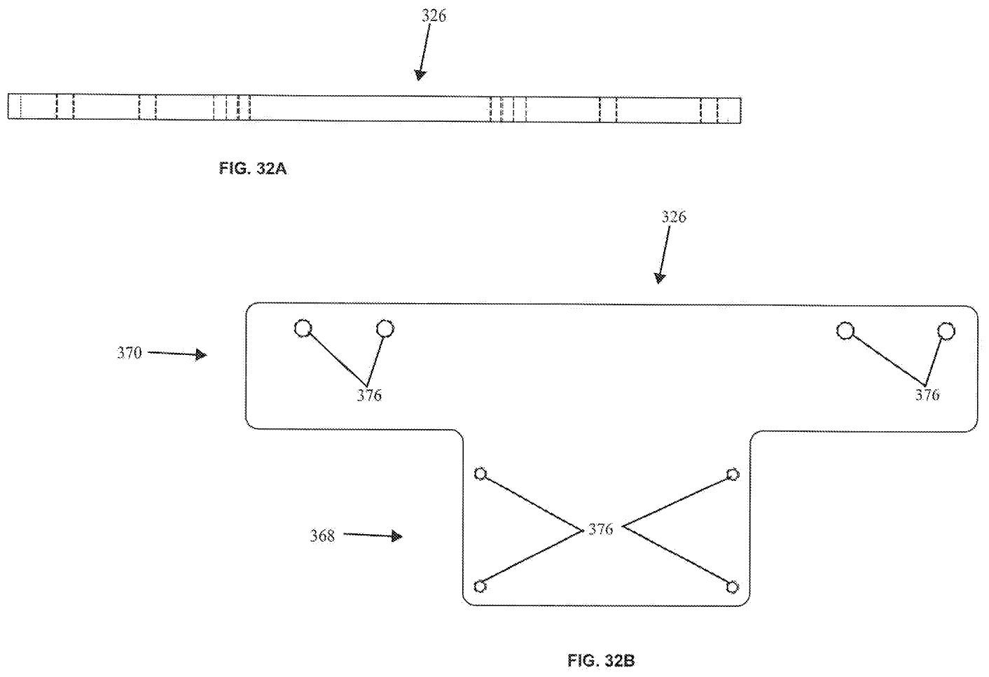

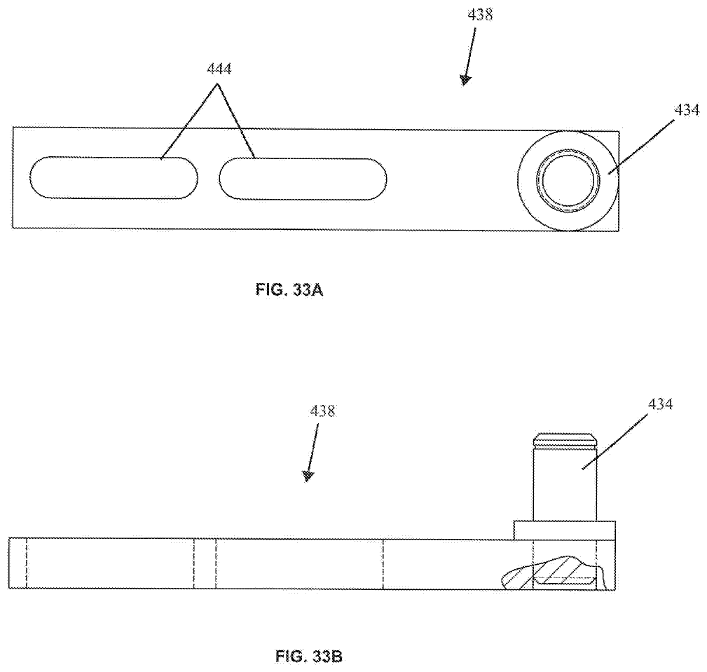

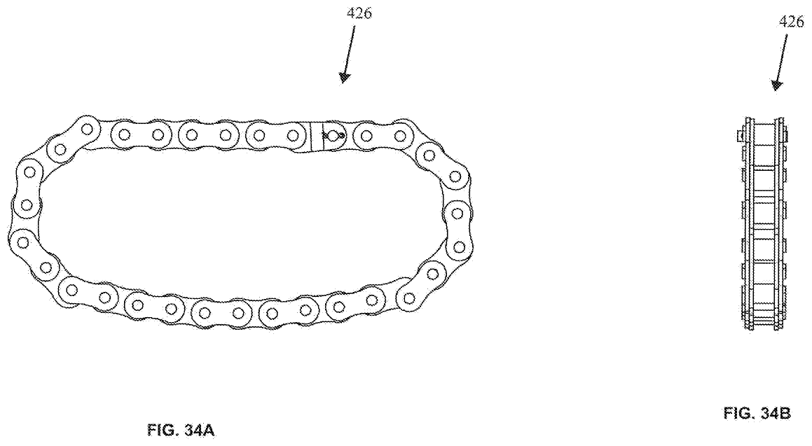

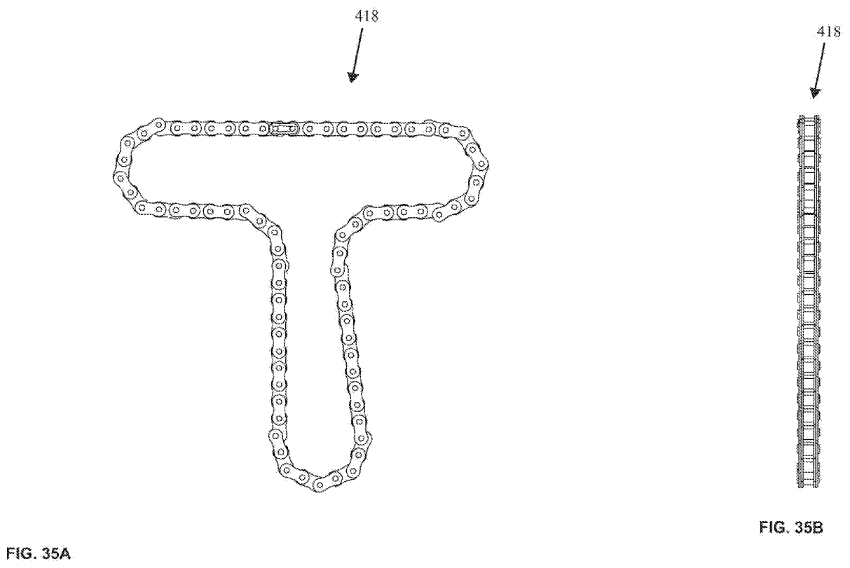

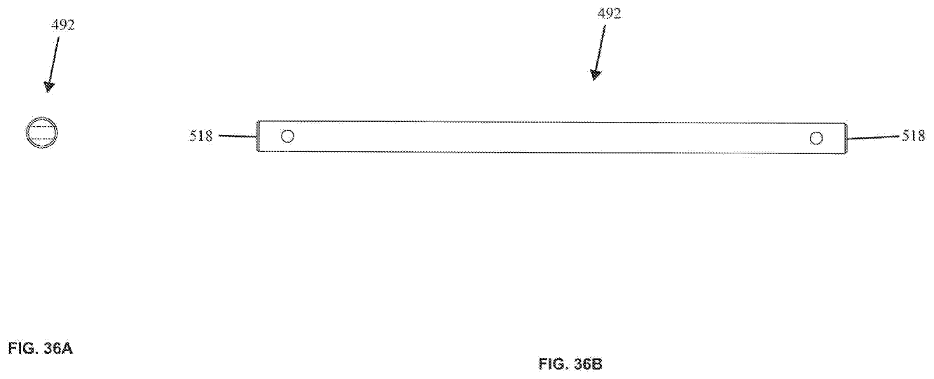

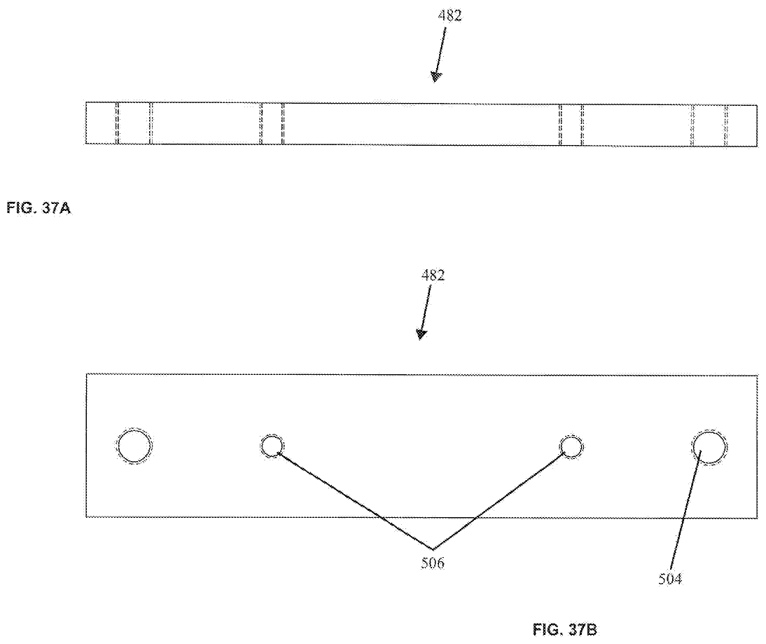

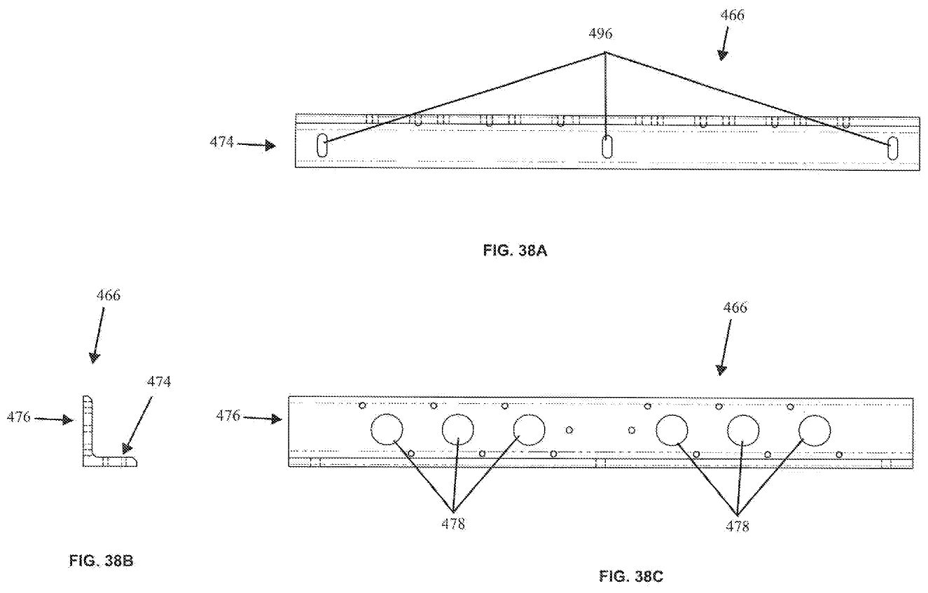

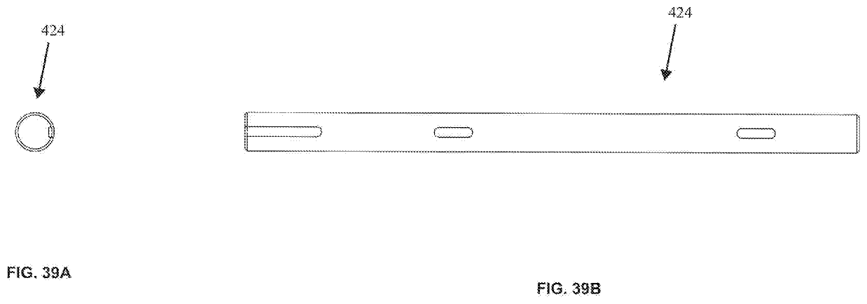

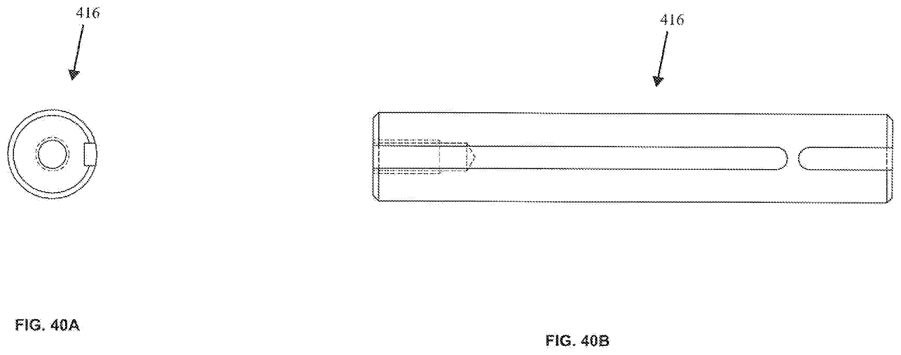

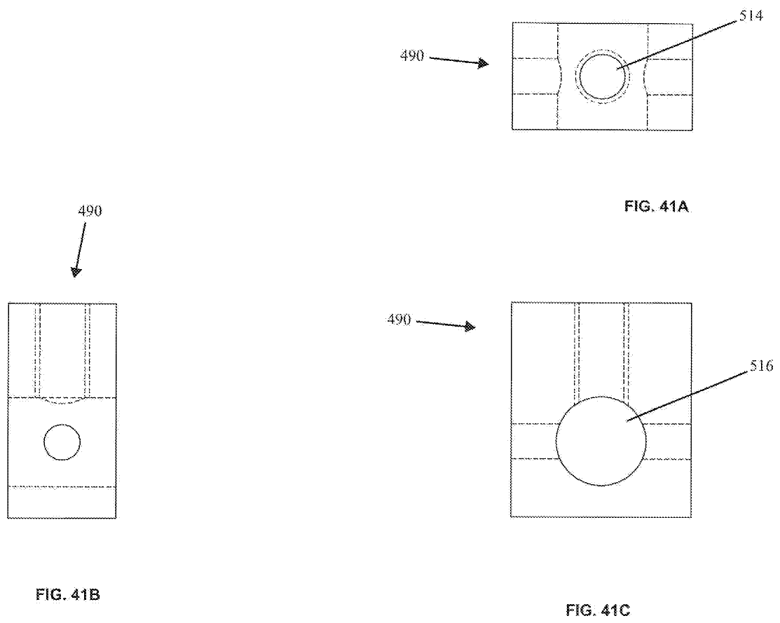

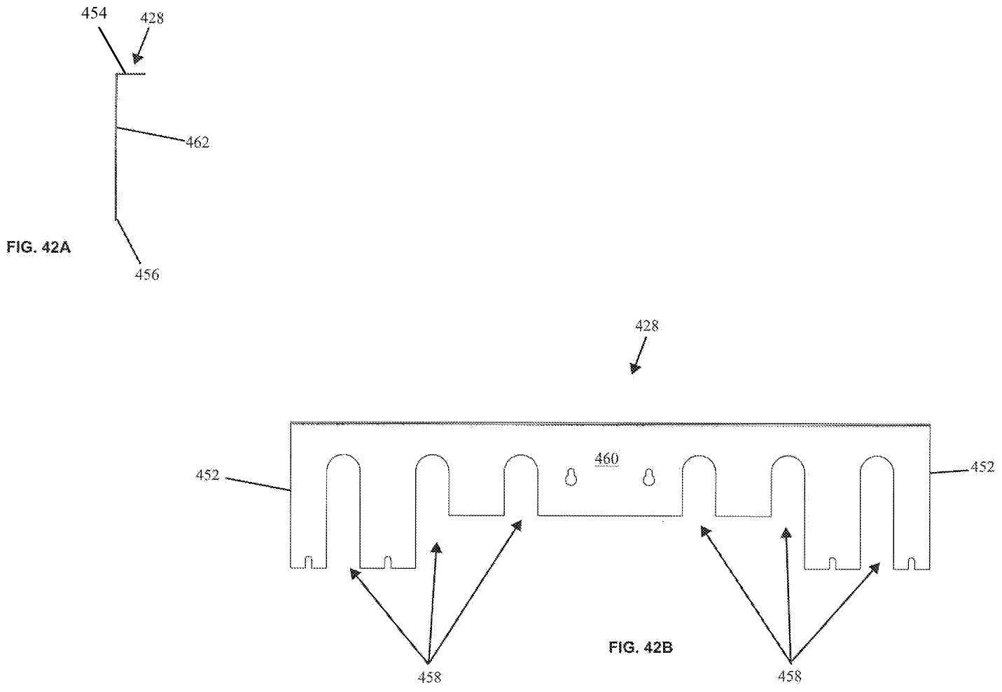

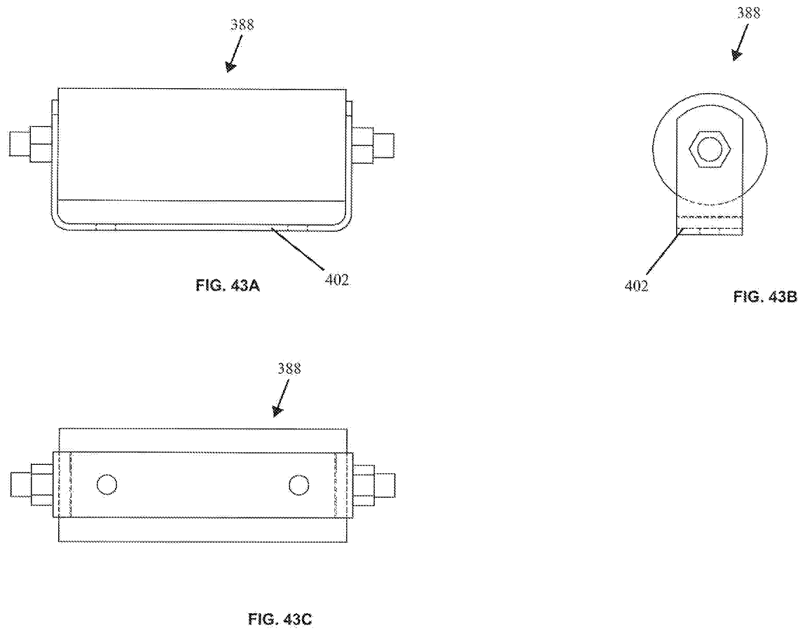

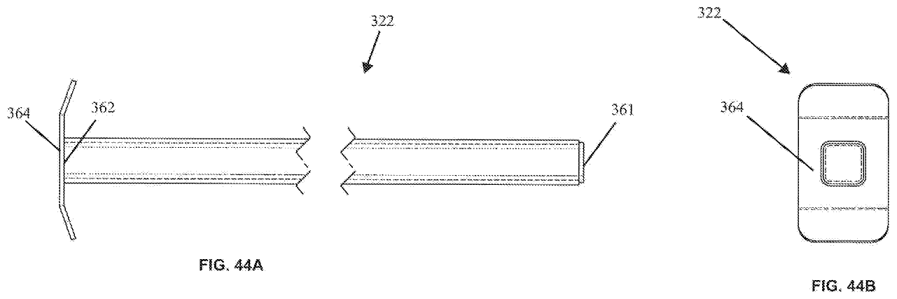

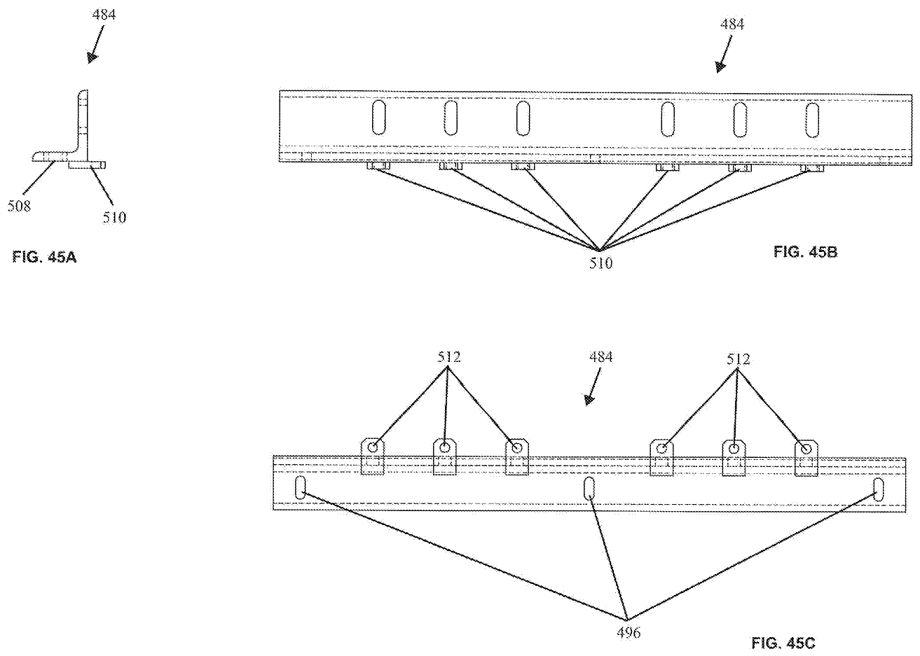

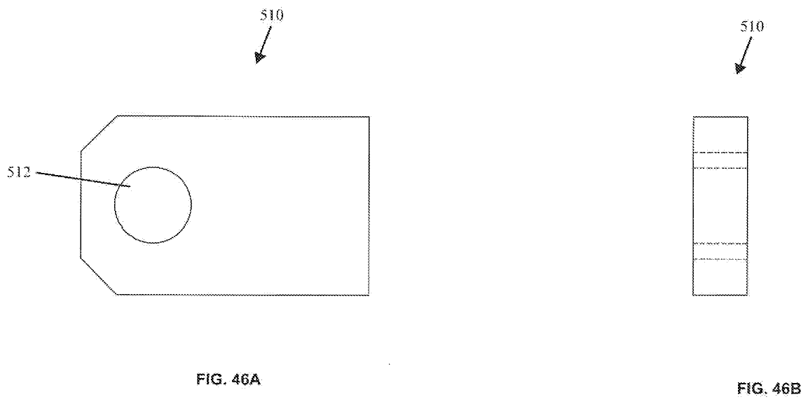

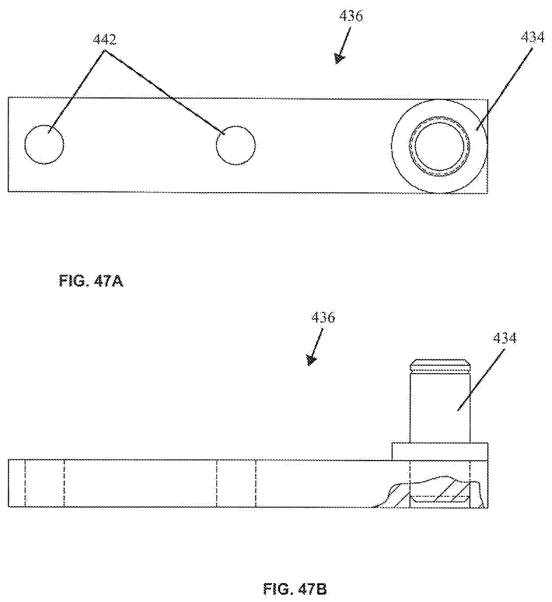

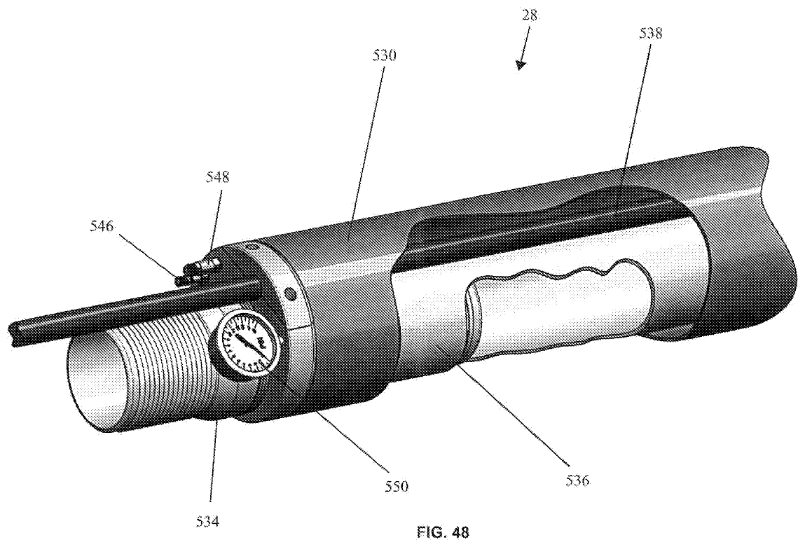

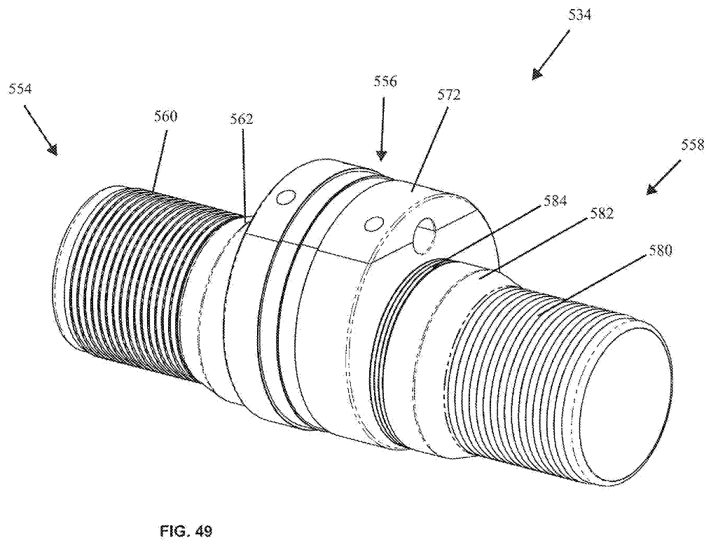

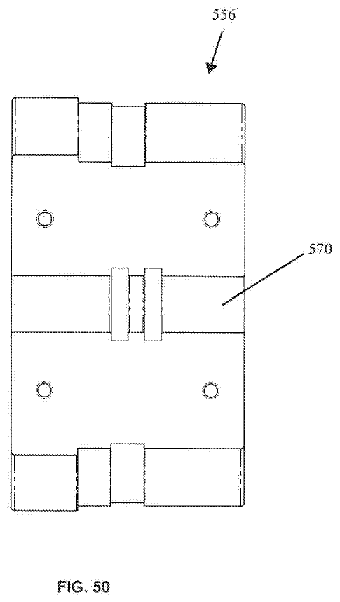

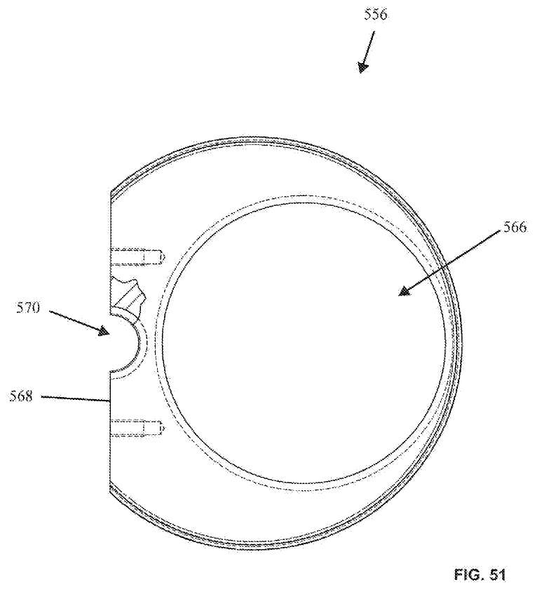

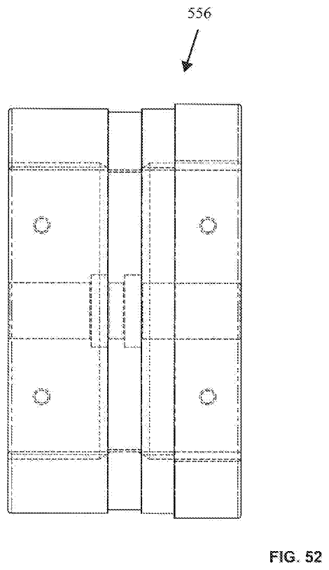

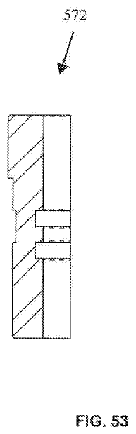

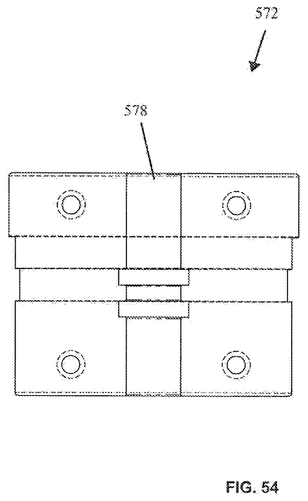

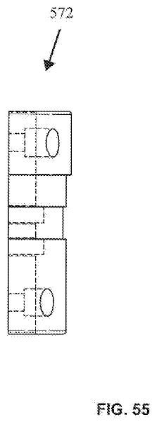

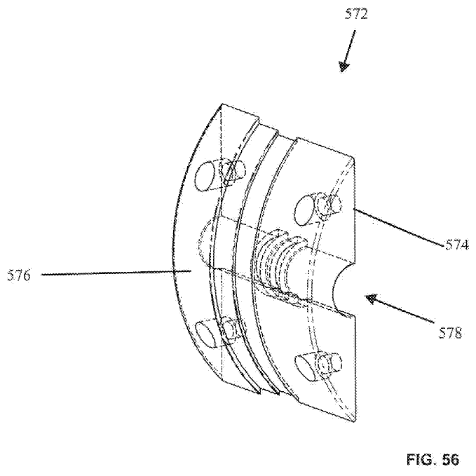

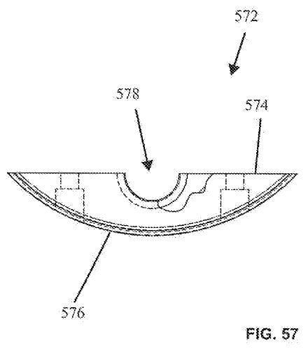

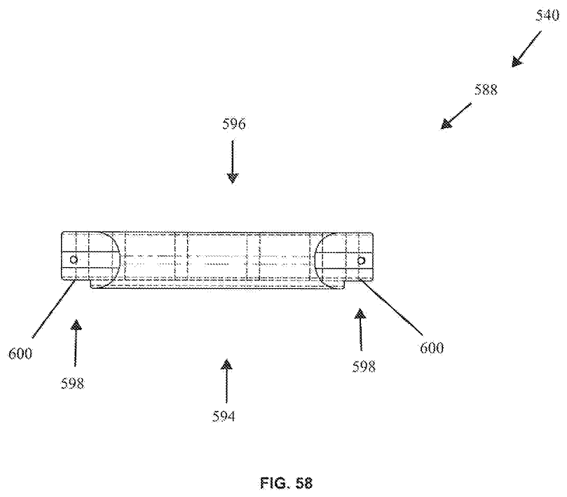

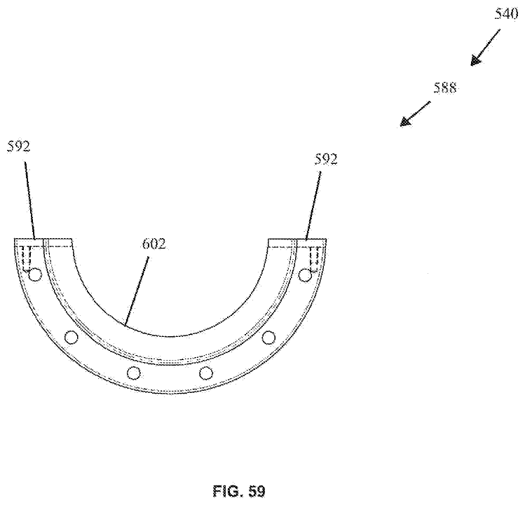

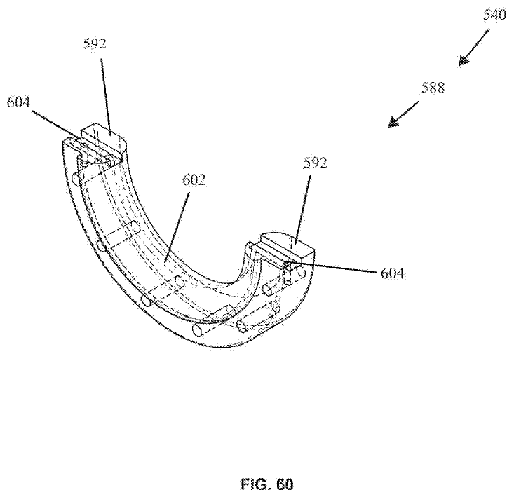

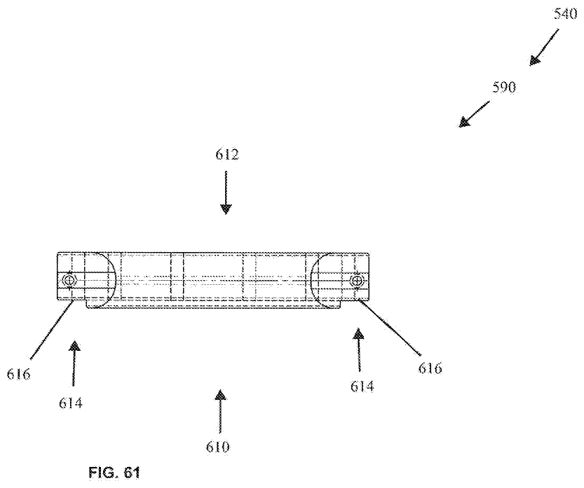

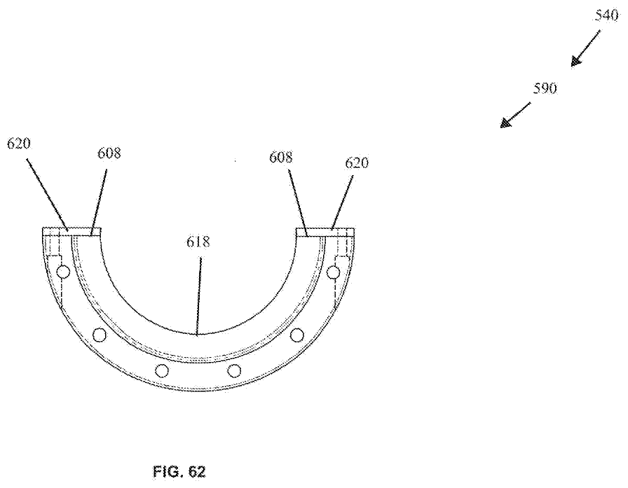

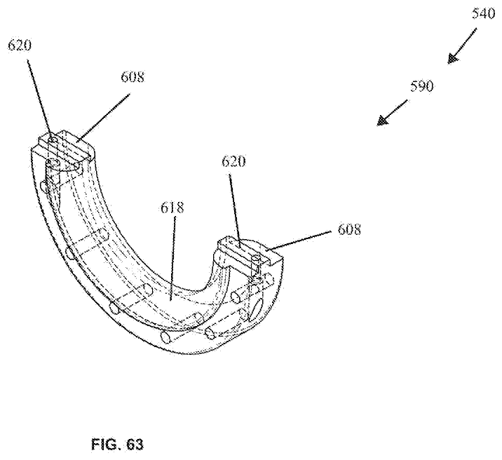

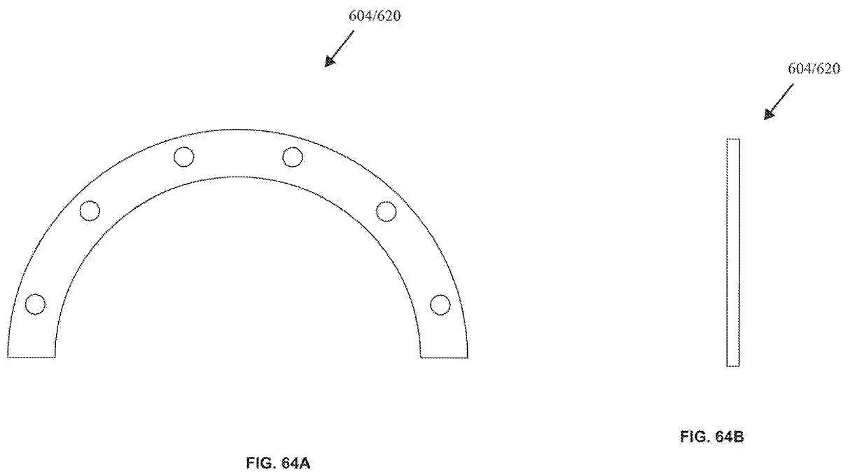

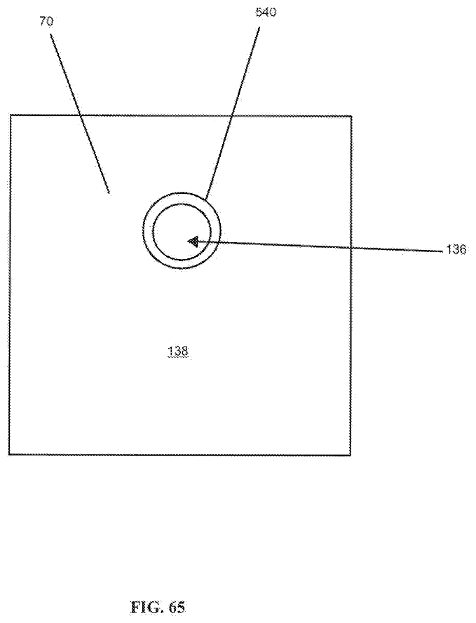

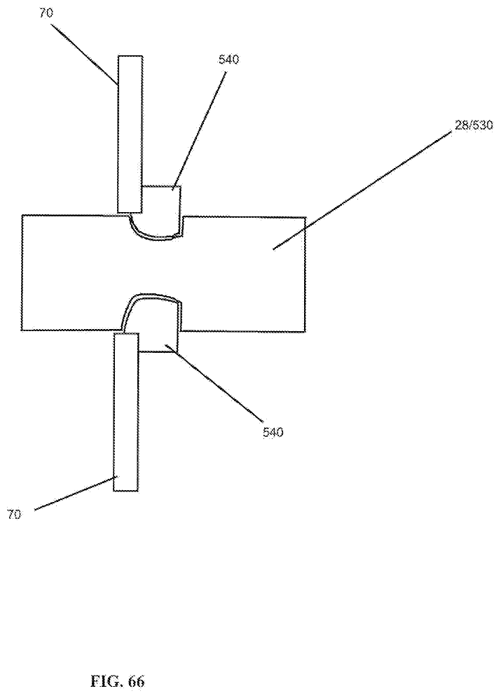

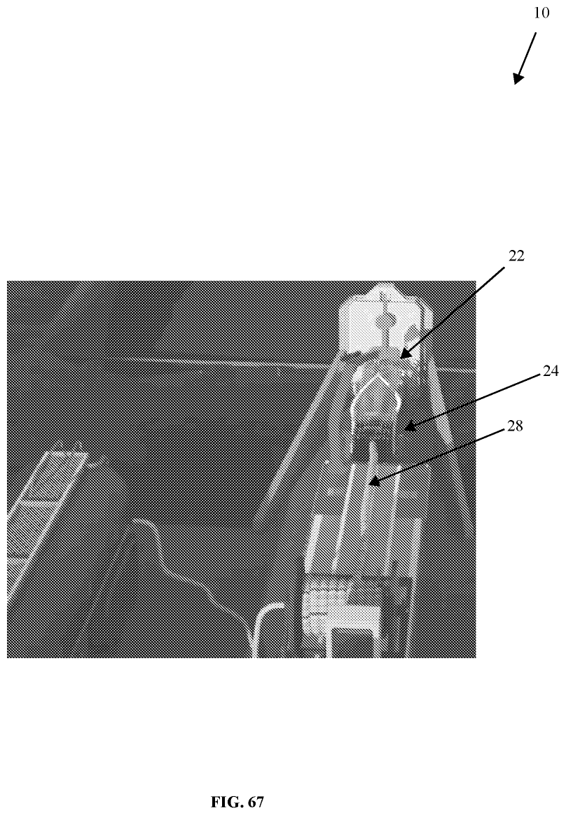

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s).

As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described at comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of the anaerobic digester tanks or lagoons. However, the embodiments are not so limited. It is appreciated that the embodiments may be adapted for use in other applications which may be improved by the disclosed structures, arrangements and/or methods. The system is merely shown and described as being used in the context of anaerobic digester tanks or lagoons for ease of description and as one of countless examples.

### Anaerobic Digester Tank or Lagoon

The cleaning system presented herein is configured to be used in an enclosed space, including as examples, an anaerobic digester tank or lagoon. The cleaning system may be installed on an anaerobic digester tank or lagoon during construction of the tank or lagoon, or the cleaning system may be retrofit to an existing anaerobic digester tank or lagoon. In one or more arrangements, as examples, the anaerobic digester tank or lagoon to which the cleaning system is connected will have a gate complex. In one or more arrangements, the cleaning system is connected to the gate complex and the gate complex provides fluid communication between the inside of the anaerobic digester tank or lagoon and the cleaning system. In this way, the cleaning system can deliver a cleaning device into the anaerobic digester tank or lagoon in order to clean the inaccessible floor of the anaerobic digester tank or lagoon.

### Cleaning System

With reference to the figures, a cleaning system 10 (or simply “system 10”) is presented. System 10 is formed of any suitable size, shape, and design and is configured to clean a portion of an enclosed space, such as the inaccessible floor of an anaerobic digester tank or lagoon. In the arrangement shown, as one example, system 10 has a forward end 12, a rearward end 14, opposing left and right sides 16 (or simply “sides 16”), a top side 18, and a bottom side 20. In the arrangement shown, as one example, system 10 includes a box assembly 22, a collection box assembly 24, a hose mover assembly 26, a hose system 28, and a cleaning device (not shown), among other components as described herein. While system 10 has been described according to the arrangement shown, as one example, any combination or arrangement may be used and is hereby contemplated for use.

### Box Assembly:

In the arrangement shown, as one example, system 10 includes a box assembly 22. Box assembly 22 is formed of any suitable size, shape, and design and is configured to fluidly connect to an anaerobic digester tank or lagoon, receive and hold a cleaning device, and facilitate the insertion and removal of the cleaning device into the anaerobic digester tank or lagoon. In the arrangement shown, as one example, box assembly 22 has a top side 32, a bottom side 34, a front end 36, a rear end 38, a left side 40, and a right side 42. In the arrangement shown, as one example, box assembly 22 includes a frame assembly 44, legs 46, a carrier assembly 48, and a drain assembly 52.

Frame Assembly: In the arrangement shown, as one example, box assembly 22 includes a frame assembly 44. Frame assembly 44 is formed of any suitable size, shape, and design and is configured to form a housing within which carrier assembly 48 and the cleaning device are contained. In the arrangement shown, as one example, frame assembly 44 has end supports 56, side supports 58, floor supports 60, vertical supports 62, cover assembly 64, a floor panel 66, a first end plate 68, a second end plate 70, a first side panel 72, and a second side panel 74.

In the arrangement shown as one example, frame assembly 44 is formed of multiple pieces that are connected or assembled to one another through bolting, however any other means of connecting or assembling the multiple pieces may be used, including screwing, welding, friction fitting, riveting, or the like. Alternatively, frame assembly 44 may be formed of a single, unitary member that is formed in a manufacturing process such as machining, extrusion, forming, additive manufacturing, or the like to form a unitary and monolithic member. In the arrangement shown, as one example, frame assembly 44 and, unless specified otherwise herein, its component pieces are formed primarily of a metallic material such as steel, aluminum, chromium, or any other metallic material, alloy, and/or composite thereof. Alternatively, frame assembly 44 and its component pieces may be formed of a non-metallic material such as a plastic material, a fiberglass material, or any other non-metallic material and/or composite thereof.

In the arrangement shown, as one example, when viewed from top side 18 of system 10, frame assembly 44 is generally rectangular in shape, with first end plate 68 and second end plate 70 extending in approximate parallel planar spaced relation to one another and in approximate perpendicular planar relation to each of first side panel 72 and second side panel 74. In the arrangement shown, as one example, when viewed from either side 16 of system 10, frame assembly 44 is generally rectangular in shape, with cover assembly 64 and floor panel 66 extending in approximate parallel planar spaced to one another and in approximate perpendicular planar relation to each of first end plate 68 and second end plate 70. In the arrangement shown, as one example, when viewed from either forward end 12 or rearward end 14 of system 10, frame assembly 44 is approximately square or rectangular in shape, with cover assembly 64 and floor panel 66 extending in approximate parallel planar spaced relation to one another and approximate perpendicular planar relation to each of first side panel 72 and second side panel 74.

End Supports: In the arrangement shown, as one example, frame assembly 44 includes end supports 56. End supports 56 are formed of any suitable size, shape, and design and are configured to provide support to components of frame assembly 44 and connect to legs 46. In the arrangement shown, as one example, there are two end supports 56, one near the first end plate 68 of frame assembly 44 and one near the second end plate 70 of frame assembly 44. In the arrangement shown, as one example, end supports 56 are generally hollow, square, metallic tubes which extend a length between opposing sides, and on each side of the end supports 56, there is an end plate 76. In the arrangement shown, as one example, end plates 76 may be welded to end supports 56, or end plates 76 may be connected to end supports 56 by friction fitting, adhesion, bolting, or any other suitable form of connection. End plates 76 are formed of any suitable size, shape, and design and are configured to facilitate connection between end supports 56 and legs 46. In the arrangement shown, as one example, end plates 76 are generally square or rectangular in shape. In the arrangement shown, as one example, end plates 76 are connected to legs 46 by bolting, however any other type of connection may be used, including screwing, riveting, welding, or the like.

While end supports 56 and end plates 76 are described according to the arrangements shown, as examples, end supports 56 and end plates 76 are not so limited. As an alternative arrangement, as one example, end supports 56 may be cylindrical tubes, triangular tubes, or any other size, shape, or design of tube, and end supports 56 may be any shape or size and may or may not be hollow. As an alternative arrangement, as one example, end plates 76 may be circular, ovular, triangular, or any other shape. As a further alternative arrangement, as one example, end plates 76 may be formed as a part of end supports 56, such as flanges which extend outward from end supports 56. Additionally or alternatively, end supports 56 may be formed of a material other than a metallic material, such as a non-metallic material, a composite material, an alloy, or any other type of material capable of providing support to components of frame assembly 44.

Side Supports: In the arrangement shown, as one example, frame assembly 44 includes side supports 58. Side supports 58 are formed of any suitable size, shape, and design and are configured to provide support to components of frame assembly 44 and connect to floor supports 60 and vertical supports 62. In the arrangement shown, as one example, side supports 58 are generally hollow, square, metallic tubes which extend a length from near front end 36 to near rear end 38 of box assembly 22. In the arrangement shown, as one example, there are two side supports 58, one on each of the left side 40 and the right side 42 of box assembly 22. In the arrangement shown, as one example, side supports 58 rest on top of end supports 56 and are secured to end supports 56 through frictional engagement, welding, adhesion, or the like to ensure side supports 58 do not move or disengage from end supports 56.

While side supports 58 are described according to the arrangements shown, as examples, side supports 58 are not so limited. As an alternative arrangement, as one example, side supports 58 may be cylindrical tubes, triangular tubes, or any other size, shape, or design of tube, and side supports 58 may be any shape or size and may or may not be hollow. Additionally or alternatively, side supports 58 may be formed of a material other than a metallic material, such as a non-metallic material, a composite material, an alloy, or any other type of material capable of providing support to components of frame assembly 44.

Floor Supports: In the arrangement shown, as one example, frame assembly 44 includes floor supports 60. Floor supports 60 are formed of any suitable size, shape, and design and are configured to provide support to components, specifically including floor panel 66, of frame assembly 44 and connect to side supports 58. In the arrangement shown, as one example, floor supports 60 are generally hollow, square, metallic tubes which extend from the side support 58 on the left side 40 of box assembly 22 to the other side support 58 on the right side 42 of box assembly 22. In the arrangement shown, as one example, floor supports 60 may be connected to side supports 58 by any method, including, but not limited to, bolting, screwing, welding, riveting, friction fitting, or the like. In the arrangement shown, as one example, there are four floor supports 60, with one floor support 60 located near front end 36 of box assembly 22, another floor support 60 located near rear end 38 of box assembly 22, and two floor supports 60 located in-between the floor support 60 near the front end 36 and the floor support 60 near the rear end 38. However, any other number of floor supports 60, and any placement, spacing, or arrangement of floor supports 60 may be used in order to support components of frame assembly 44. In the arrangement shown, as one example, floor panel 66 is configured to rest on top of one or more floor supports 60.

While floor supports 60 are described according to the arrangements shown, as examples, floor supports 60 are not so limited. As an alternative arrangement, as one example, floor supports 60 may be cylindrical tubes, triangular tubes, or any other size, shape, or design of tube, and floor supports 60 may be any shape or size and may or may not be hollow. Additionally or alternatively, floor supports 60 may be formed of a material other than a metallic material, such as a non-metallic material, a composite material, an alloy, or any other type of material capable of providing support to components of frame assembly 44.

Vertical Supports: In the arrangement shown, as one example, frame assembly 44 includes vertical supports 62. Vertical supports 62 are formed of any suitable size, shape, and design and are configured to provide support to components, specifically including first side panel 72 and second side panel 74, of frame assembly 44 and connect to side supports 58. In the arrangement shown, as one example, vertical supports 62 are generally hollow, square tubes which extend a height between side supports 58 near bottom side 34 of box assembly 22 to a stiffener 150 near top side 32 of box assembly 22. In the arrangement shown, as one example, vertical supports 62 may be connected to side supports 58 and/or a stiffener 150 by any method including, but not limited to bolting, screwing, welding, riveting, friction fitting, or the like. In the arrangement shown, as one example, there are four vertical supports 62 on the left side 40 of box assembly 22 and four vertical supports 62 on the right side 42 of box assembly 22. However, any other number of vertical supports 62, and any placement, spacing, or arrangement of vertical supports 62 may be used in order to support components of frame assembly 44. In the arrangement shown, as one example, vertical supports 62 help to support cover assembly 64 and vertical supports 62 help provide support to, and help facilitate alignment of, first side panel 72 and/or second side panel 74.

While vertical supports 62 are described according to the arrangements shown, as examples, vertical supports 62 are not so limited. As an alternative arrangement, as one example, vertical supports 62 may be cylindrical tubes, triangular tubes, or any other size, shape, or design of tube, and vertical supports 62 may be any shape or size and may or may not be hollow. Additionally or alternatively, vertical supports 62 may be formed of a material other than a metallic material, such as a non-metallic material, a composite material, an alloy, or any other type of material capable of providing support to components of frame assembly 44.

Cover Assembly: In the arrangement shown, as one example, frame assembly 44 includes cover assembly 64. Cover assembly 64 is formed of any suitable size, shape, and design and is configured to help enclose box assembly 22. In the arrangement shown, as one example, cover assembly 64 includes top plates 82, gusset plates 84, top fillers 86, lid extensions 88, a lid gasket 90, and a lid 92.

In the arrangement shown, as one example, cover assembly 64 includes top plates 82. Top plates 82 are formed of any suitable size, shape, and design and are configured to help support lid 92. In the arrangement shown, as one example, one top plate 82 is present at or near each of the front end 36 and rear end 38 of box assembly 22. In the arrangement shown, as one example, top plates 82 are elongated, rectangular members that extend a length from a first end 96 to a second end 96 and a width from an inner edge 98 to an outer edge 99. In the arrangement shown, as one example, the first end 96 of top plate 82 is approximately coplanar with an outer edge of upper portion 146 of first side panel 72 and the second end 96 of top plate 82 is approximately coplanar with an outer edge of upper portion 186 of second side panel 74. In the arrangement shown, as one example, the top surface of the upper portion 146 of first side panel 72 and the top surface of the upper portion 186 of second side panel 74 are coplanar with the top surface 104 of top plates 82.

In the arrangement shown, as one example, top plates 82 are connected to first side panel 72 and second side panel 74 through a process such as welding, however top plates 82 may be connected to first side panel 72 and/or second side panel 74 using any other method or means of connection including screwing, bolting, riveting, adhesion, or any other method of connection.

In the arrangement shown, as one example, first side panel 72 and second side panel 74 include a notch 151 which is present where top plates 82 connects to first side panel 72 and second side panel 74. With top plates 82 connected to first side panel 72 and second side panel 74 at notches 151, a gap is present between the interior surface 132 of first end plate 68 and top plates 82. Similarly, a gap is present between the interior surface 138 of the second end plate 70 and top plates 82. In the arrangement shown, as one example, to fill this gap, cover assembly 64 includes gusset plates 84 and top fillers 86. Gusset plates 84 are formed of any suitable size, shape, and design and are configured to connect top fillers 86 to top plates 82. Top fillers 86 are formed of any size, shape, and design and are configured to connect with gusset plates 84 and first end plate 68 and/or second end plate 70 to help facilitate the enclosure of box assembly 22.

In the arrangement shown, as one example, there are two gusset plates 84 positioned equidistance from, and on either side of, the center point between the ends 96 of top plates 82. In the arrangement shown, as one example, gusset plates 84 connect at their top sides with the bottom surface 106 of top plates 82 and extend downward until they meet top fillers 86. In the arrangement shown, as one example, top fillers 86 extend a length and a width sufficient to fill the gaps between cover assembly 64 and other components of frame assembly 44, thereby helping to facilitate proper enclosure of box assembly 22.

In the arrangement shown, as one example, cover assembly 64 also includes lid extensions 88. Lid extensions 88 are formed of any suitable size, shape, and design and are configured to connect to the upper portion 146 of first side panel 72 and/or the upper portion 186 of second side panel 74 and provide a surface upon which lid gasket 90 and lid 92 rest. In the arrangement shown, as one example, lid extensions 88 are c-shaped beams (or, said another way, channel beams) which extend from one opposing end 110 at or near the front end 36 to the other opposing end 110 at or near the rear end 38 of box assembly 22. In the arrangement shown, as one example, the opposing ends 110 of lid extensions 88 are in alignment with the outer edges 99 of top plates 82. In the arrangement shown, as one example, a lid extension 88 is present on each of the left side 40 and right side 42 of box assembly 22. In the arrangement shown, as one example, lid extensions 88 rest on top of the upper portion 146 of first side panel 74 and/or the upper portion 186 of second side panel 74 and the outer edges 112 of lid extensions 88 are in alignment with the outer edge of upper portion 146 or upper portion 186.

In the arrangement shown, as one example, the upper surface (not shown) of lid extensions 88 is adjacent the lower surface (not shown) of lid gasket 90. Lid gasket 90 is formed of any suitable size, shape, and design and is configured to rest on top of lid extensions 88 and connect lid 92 to the remainder of cover assembly 64. In the arrangement shown, as one example, lid gasket 90 is a generally thin member which extends a length from one opposing end to the other opposing end, and extends a width from one outer edge to the other outer edge. In the arrangement shown, as one example, lid gasket 90 has an open middle which is formed through a punching process, a laser cutting process, or similar process designed to remove material from a single sheet of material. In the arrangement shown, as one example, lid gasket 90 rests on top of lid extensions 88 with the opposing ends of lid gasket 90 in alignment with the opposing ends 110 of lid extensions 88, and the outer edges of lid gasket 90 in alignment with the outer edges 112 of lid extensions 88.

In the arrangement shown, as one example, cover assembly 64 includes lid 92 which connects to, and rests on top of, lid gasket 90. Lid 92 is formed of any suitable size, shape, and design and is configured to facilitate the enclosure of the top side 32 of box assembly 22. In the arrangement shown, as one example, lid 92 is a flat and rectangular member which extends a length between opposing ends 118 and a width between outer edges 120. While lid 92 has been described as being a flat member, lid 92 is not so limited and lid 92 may be formed of any other shape and/or design in order to facilitate the enclosure of the top side 32 of box assembly 22.

The various components of cover assembly 64 may be formed of any material, such as metallic material, non-metallic material, composites material, or any other material in order to provide a cover to box assembly 22. Additionally, various components of cover assembly 64 are described as being connected to or resting on other components of cover assembly 64. The various components of cover assembly 64 may be connected or joined through any method or process of joining materials including screwing, bolting, riveting, welding, adhesion, friction fitting, or any other method or process of connecting two materials. Further, while cover assembly 64 has been described as having various components according to the arrangement shown, cover assembly 64 is not so limited. As an alternative arrangement, cover assembly 64 may be comprised of simply lid 92 connected directly to other components of frame assembly 44. Similarly, lid 92 may be connected to other components of frame assembly 44 through various other members not shown or described herein, but use of which would be obvious to one of skill in the art. As such, cover assembly 64 is not limited to the arrangements and/or embodiments shown and described herein, as examples.

Floor Panel: In the arrangement shown, as one example, frame assembly 44 includes a floor panel 66. Floor panel 66 is formed of any suitable size, shape, and design and is configured to help enclose box assembly 22, as well as help support components of carrier assembly 48 of box assembly 22 and the cleaning device when it is housed within box assembly 22, and connect to drain assembly 52. In the arrangement shown, as one example, floor panel 66 is positioned directly on top of floor supports 60. In the arrangement shown, as one example, floor panel 66 is a generally flat, rectangular, metallic member which extends a length between opposing ends and a width between opposing sides.

In the arrangement shown, as one example, one opposing end of floor panel 66 is directly adjacent the interior surface 132 of first end plate 68 and the other opposing end is directly adjacent the interior surface 138 of second end plate 70. In the arrangement shown, as one example, one opposing side of floor panel 66 is directly adjacent the interior surface 140 of first side panel 72 and the other opposing side of floor panel 66 is directly adjacent the interior surface 180 of second side panel 74. In the arrangement shown, as one example, floor panel 66 also includes a generally circular drain opening 128 which extends through floor panel 66 from the upper surface 122 to the lower surface 123 of floor panel 66. Drain opening 128 is formed or any suitable size, shape, and design and is configured to facilitate fluid connection of drain assembly 52 to the interior of box assembly 22.

While floor panel 66 has been described according to the arrangement shown, as one example, floor panel 66 is not so limited. In alternative arrangements, as examples, floor panel 66 may be formed of any other suitable shape or design, including a generally planar circular, square, triangular, hexagonal, or other shaped member, and floor panel 66 may or may not be a planar member. Additionally or alternatively, floor panel 66 may be formed of a non-metallic material, or any composite, alloy, or other material capable of helping enclose box assembly 22, support components of carrier assembly 48 and the cleaning device, and connect to drain assembly 52.

First End Plate: In the arrangement shown, as one example, frame assembly 44 includes a first end plate 68. First end plate 68 is formed of any suitable size, shape, and design and is configured to help enclose box assembly 22 and allow selective access into and out of the anaerobic digester tank or covered lagoon in order to facilitate the insertion and removal of the cleaning device. In the arrangement shown, as one example, first end plate 68 is a generally flat, square or rectangular, metallic member which has an open center 130 which allows for the cleaning device to be inserted into and removed from box assembly 22 (and into or out of the closed system). In the arrangement shown, as one example, first end plate 68 has an interior surface 132 which is connected to an opposing end of floor panel 66, an opposing end 144 of first side panel 72, and an opposing end 184 of second side panel 74, thereby helping to facilitating the enclosure of box assembly 22.

In the arrangement shown, as one example, first end plate 68 may be configured to connect directly to a gate complex of the anaerobic digester tank or covered lagoon, and in this arrangement, open center 130 is sized, shaped, and positioned such that the open center 130 is aligned with the gate complex so that the cleaning device can pass through open center 130 to enter into, and be removed from, a closed system, such as an anaerobic digester tank or covered lagoon. In an alternative arrangement, as one example, first end plate 68 may also include a gate connection member 134 configured to connect to the gate complex. As will be understood, first end plate 68 may be connected directly to the gate complex or may be indirectly connected such as through gate connection member 134 or any other intermediary.

While first end plate 68 has been described according to the arrangement shown, as one example, first end plate 68 is not so limited. In alternative arrangements, as examples, first end plate 68 may be formed of any other suitable shape or design, including a generally planar circular, triangular, hexagonal, or other shaped member, and first end plate 68 may or may not be a planar member. Additionally or alternatively, first end plate 68 may be formed of a non-metallic material, or any composite, alloy, or other material capable of helping enclose box assembly 22 and allowing for the cleaning device to be inserted into and removed from the anaerobic digester tank or covered lagoon.

Second End Plate: In the arrangement shown, as one example, frame assembly 44 includes a second end plate 70. Second end plate 70 is formed of any suitable size, shape, and design and is configured to help enclose box assembly 22, connect to collection box assembly 24, and allow for hose system 28 to move into and out of box assembly 22. In the arrangement shown, as one example, second end plate 70 is a generally flat, square or rectangular, metallic member. In the arrangement shown, as one example, second end plate 70 has an interior surface 138 which is connected to an opposing end of floor panel 66, an opposing end 144 of first side panel 72, and an opposing end 184 of second side panel 74, thereby helping to facilitating the enclosure of box assembly 22.

In one or more arrangements, second end plate 70 includes an aperture 136 extending from the interior surface 138 to the exterior surface 139 of second end plate 70. Aperture 136 is formed of any suitable size, shape, and design and is configured to allow hose system 28 to move into and out of box assembly 22 through second end plate 70. In one or more arrangements, aperture 136 is sized such that hose system 28 may pass through aperture 136 while only allowing a minimal amount of liquid to pass through aperture 136 when box assembly 22 contains liquid and hose system 28 is passed through aperture 136. In the arrangement shown, as one example, the exterior surface 139 of second plate 70 is configured to connect to collection box assembly 24 such that any liquid escaping through aperture 136 is captured and contained within collection box assembly 24. Exterior surface 139 may be connected to collection box assembly 24 using any method of connection including welding, riveting, screwing, bolting, adhesion, or any other method of connection.

While second end plate 70 has been described according to the arrangement shown, as one example, second end plate 70 is not so limited. In alternative arrangements, as examples, second end plate 70 may be formed of any other suitable shape or design, including a generally planar circular, triangular, hexagonal, or other shaped member, and second end plate 70 may or may not be a planar member. Additionally or alternatively, second end plate 70 may be formed of a non-metallic material, or any composite, alloy, or other material capable of helping enclose box assembly 22, connect to collection box assembly 24, and allow for hose system 28 to move into and out of box assembly 22.

First Side Panel: In the arrangement shown, as one example, frame assembly 44 includes a first side panel 72. First side panel 72 is formed of any suitable size, shape, and design and is configured to help enclose box assembly 22 and support internal components of box assembly 22 including carrier assembly 48 and motor 230 of carrier assembly 48. In the arrangement shown, as one example, first side panel 72 is a generally flat, rectangular, metallic member with an interior surface 140, an exterior surface 142, opposing ends 144, an upper portion 146, and a lower edge 148. In the arrangement shown, as one example, one opposing end 144 of first side panel 72 connects to the interior surface 132 of first end plate 68 and the other opposing end 144 connects to the interior surface 138 of second end plate 70. In the arrangement shown, as one example, the upper portion 146 of first side panel 72 connects to top plates 82, and a stiffener 150 is provided under the upper portion 146 to help support the upper portion 146 of first side panel 72. In the arrangement shown, as one example, the lower edge 148 of first side panel 72 connects to the upper surface 122 of floor panel 66.

In the arrangement shown, as one example, first side panel 72 includes a drive connection plate 152 which extends through the exterior surface 142 and the interior surface 140 of first side panel 72. Drive connection plate 152 is formed of any suitable size, shape, and design and is configured to facilitate operable connection of motor 230 of carrier assembly 48, positioned adjacent the exterior surface 142 of first side panel 72, to additional components of drive assembly 216 of carrier assembly 48 positioned on the inside of the box assembly 22. In the arrangement shown, as one example, drive connection plate 152 include a shaft opening 154 which extends through drive connection plate 152 and is formed of any suitable size, shape, and design and is configured to allow the drive shaft (not shown) of motor 230 of carrier assembly 48 to extend through drive connection plate 152 and first side panel 72. In the arrangement shown, as one example, the exterior surface 142 of first side panel 72 also includes a motor support plate 156 to help support and ensure secured engagement of motor 230 of carrier assembly 48 to first panel 72.

In the arrangement shown, as one example, the interior surface 140 of first side panel 72 includes an idler connection plate 158, a tray support 160, brackets 162, a carrier mount 164, and a carrier guide 166. In the arrangement shown, as one example, the idler connection plate 158 is formed of any suitable size, shape, and design and is configured to facilitate connection of the idler assembly 232 of carrier assembly 48 to first side panel 72. In the arrangement shown, as one example, idler connection plate 158 is a flat, rectangular, metallic bar connected to the interior surface 140 of first side panel 72, however idler connection plate 158 is not so limited. Rather, idler connection plate 158 may be formed of any non-metallic material, composites material, or an alloy or any other material. Additionally or alternatively, idler connection plate 158 may be any other shape or design, including being in the shape of a circle, oval, triangle, square, or any other shape or design. While the arrangement shown includes an idler connection plate 158 on the interior surface 140 of first side panel 72, it is also contemplated that the idler assembly 232 of carrier assembly 48 may be connected directly to the interior surface 140 of first side panel 72, and idler assembly 232 may be connected to interior surface 140 through other intermediate components in addition to, or in lieu of, idler connection plate 158.

In the arrangement shown, as one example, a tray support 160 is connected to interior surface 140 of first side panel 72. Tray support 160 is formed of any suitable size, shape, and design and is configured to help provide stability and rigidity to first side panel 72 and help support various components connected to first side panel 72. Additionally, tray support 160 may be configured to help support components of carrier assembly 48. In the arrangement shown, as one example, tray support 160 is an elongated, rectangular, metallic member which extends between one opposing end 168, which begins at or near the opposing end 144 of first side panel 72 that is connected to first end plate 68, and the other opposing end 168 which is located near the opposing end 144 of first side panel 72 which is connected to second end plate 70. In the arrangement shown, as one example, tray support 160 may be formed as a part of first side panel 72, or tray support 160 may be a separate component which is connected to first side panel 72 through any means of connection including, by way of example and not limitation, welding, screwing, bolting, fastening, adhesion, or any other means of connection.

In the arrangement shown, as one example, a plurality of brackets 162 are positioned above tray support 160 and are connected to the interior surface 140 of first side panel 72. Brackets 162 are formed of any suitable size, shape, and design and are configured to help support components of carrier assembly 48. In the arrangement shown, as one example, brackets 162 are L-shaped brackets which may be screwed, bolted, riveted, welded, adhered, or otherwise connected to the interior surface 140 of first side panel 72. In the arrangement shown, as one example, carriage 214 of carrier assembly 48 may be set on top of, or otherwise supported by, brackets 162 when carriage 214 of carrier assembly 48 is placed inside of box assembly 22. Additionally or alternatively, other components of carrier assembly 48 may be placed on top of, or otherwise supported by brackets 162 to help facilitate the connection of carriage 214 and/or carrier assembly 48 to frame assembly 44.

In the arrangement shown, as one example, interior surface 140 of first side panel 72 also includes carrier mount 164 and carrier guide 166. Carrier mount 164 is formed of any suitable size, shape, and design and is configured to help facilitate operable connection of carriage 214 of carrier assembly 48 to frame assembly 44. In the arrangement shown, as one example, carrier mount 164 is an L-shaped bracket, however carrier mount 164 is no so limited, and any other shape and design of carrier mount 164 may be used in order to facilitate operable connection of carriage 214 of carrier assembly 48 to frame assembly 44. Carrier guide 166 is formed of any suitable size, shape, and design and is configured to help support carriage 214 of carrier assembly 48, and guide carriage 214, as carriage 214 is facilitating the insertion of the cleaning device into the anaerobic digester tank or covered lagoon, and as it is facilitating the removal of the cleaning device from the anaerobic digester tank or covered lagoon. In the arrangement shown, as one example, carrier guide 166 includes angled portions 170 near each opposing end 172 of carrier guide 166, and a flat middle section 174. In the arrangement shown, as one example, carrier guide 166 includes guide supports 176. Guide supports 176 are formed of any suitable size, shape, and design and are configured to help connect carrier guide 166 to first side panel 72.

While first side panel 72 has been described according to the arrangement shown, as one example, first side panel 72 is not so limited. In alternative arrangements, as examples, first side panel 72 may be formed of any other suitable shape or design, including a generally planar circular, triangular, hexagonal, or other shaped member, and first side panel 72 may or may not be a planar member. Additionally or alternatively, first side panel 72 may be formed of a non-metallic material, or any composite, alloy, or other material capable of helping enclose box assembly 22.

Second Side Panel: In the arrangement shown, as one example, frame assembly 44 includes a second side panel 74. Second side panel 74 is formed of any suitable size, shape, and design and is configured to help enclose box assembly 22 and support internal components of box assembly 22. In the arrangement shown, as one example, second side panel 74 is a generally flat, rectangular, metallic member with an interior surface 180, an exterior surface 182, opposing ends 184, an upper portion 186, and a lower edge 188. In the arrangement shown, as one example, one opposing end 184 of second side panel 74 is connected to the interior surface 132 of first end plate 68 and the other opposing end 184 connects to the interior surface 138 of second end plate 70. In the arrangement shown, as one example, the upper portion 186 of second side panel 74 connects to top plates 82, and a stiffener 150 is provided under the upper portion 186 to help support the upper portion 186 of second side panel 74. In the arrangement shown, as one example, the lower edge 188 of second side panel 74 connects to the upper surface 122 of floor panel 66.

In the arrangement shown, as one example, second side panel 74, and more specifically interior surface 180 of second side panel 74, also includes an idler connection plate 158, a tray support 160, and brackets 162 according to the arrangement shown and described herein. Additionally, in the arrangement shown as one example, second side panel 74 includes a non-drive connection plate 190. Non-drive connection plate 190 is formed of any suitable size, shape, and design and is configured to help facilitate connection of various components of carrier assembly 48 to frame assembly 44. In the arrangement shown, as one example, non-drive connection plate 190 is opposite drive connection plate 152 or, said another way, non-drive connection plate 190 is positioned such that it is in alignment with drive connection plate 152 such that a component of carrier assembly 48 could be connected to drive connection plate 152 at one end, and non-drive connection plate 190 on the other end. In the arrangement shown, as one example, non-drive connection plate 190 is a generally flat, square, metallic member which extends outward from the interior surface 180 of second side panel 74.

While second side panel 74 has been described according to the arrangement shown, as one example, second side panel 74 is not so limited. In alternative arrangements, as examples, second side panel 74 may be formed of any other suitable shape or design, including a generally planar circular, triangular, hexagonal, or other shaped member, and second side panel 74 may or may not be a planar member. Additionally or alternatively, second side panel 74 may be formed of a non-metallic, or any composite, alloy, or other material capable of helping enclose box assembly 22.

While frame assembly 44 and its various components have been described according to the arrangements shown, as examples, frame assembly 44 is not so limited. It is contemplated that various other designs, shapes, configurations, and components may be used to form frame assembly 44 and its various components, and it will be understood by those skilled in the art that any other configuration of frame assembly 44 and its various components may be used in order to form a housing within which carrier assembly 48 and the cleaning device are contained.

Legs: In the arrangement shown, as one example, box assembly 22 includes legs 46. Legs 46 are formed of any suitable size, shape, and design and are configured to facilitate the raising and lowering of box assembly 22 to the proper height in order to connect box assembly 22 to the gate complex of the anaerobic digester tank or covered lagoon, and hold box assembly 22 in order to maintain proper connection. In the arrangement shown, as one example, legs 46 include a first member 194, a second member 196, and an adjustment mechanism 198. In the arrangement shown, as one example, there are four legs 46, with one leg 46 positioned on the left side 40 near front end 36 of box assembly 22, another leg 46 positioned on the right side 42 near the front end 36 of box assembly 22, a third leg 46 positioned on the left side 40 near the rear end 38 of box assembly 22, and the fourth leg 46 positioned on the right side 42 near the rear end 38 of box assembly 22.

First Member: In the arrangement shown, as one example, legs 46 include a first member 194. First member 194 is formed of any suitable size, shape, and design and is configured to connect to the end plate 76 of end supports 56, second member 196, and adjustment mechanism 198, and be raised and lowered in order for box assembly 22 to be placed at the proper height to connect to the gate complex of the anaerobic digester tank or covered lagoon. In the arrangement shown, as one example, first member 194 is a generally square, elongated, tubular member with a hollow interior, a cap 204, and an opening 206.

In the arrangement shown, as one example, first member 194 includes a connection plate 200. Connection plate 200 is formed of any suitable size, shape, and design and is configured to connect to end plate 76 of end supports 56. In the arrangement shown, as one example, connection plate 200 is a generally flat, square, metallic member which is the same size as end plate 76. In this way, when connection plate 200 is connected to end plate 76, the edges of connection plate 200 and the edges of end plate 76 form a singular plane. In the arrangement shown, as one example, when each of the connection plates 200 of each first member 194 of each leg 46 is connected to the appropriate end plate 76 of end supports 56 of frame assembly 44, legs 46 are operably connected to frame assembly 44.

In the arrangement shown, as one example, first member 194 is configured to receive portions of second member 196 and adjustment mechanism 198 within the hollow interior of first member 194. In the arrangement shown, as one example, portions of adjustment mechanism 198 are positioned within the hollow interior of first member 194 near cap 204 (i.e. the top of first member 194). With portions of adjustment mechanism 198 positioned near the top of first member 194, a portion of the handle 210 of adjustment mechanism 198 is inserted through opening 206 of first member 194 and connected to the components of adjustment mechanism 198 positioned within the hollow interior of first member 194. Once adjustment mechanism 198 has been installed, at least a portion of second member 196 can then be inserted into the hollow interior of first member 194.

Second Member: In the arrangement shown, as one example, legs 46 include a second member 196. Second member 196 is formed of any suitable size, shape, and design and is configured to facilitate engagement with the ground and first member 194. In the arrangement shown, as one example, second member 196 is a generally square, elongated, tubular member which is shaped and sized such that it can be inserted into the hollow interior of first member 194.

In the arrangement shown, as one example, second member 196 includes a ground engagement member 208. Ground engagement member 208 is formed of any suitable size, shape, and design and is configured to provide a secure contact with the ground upon which leg 46 is standing. In the arrangement shown, as one example, ground engagement member 208 is a generally flat, square, metallic member which rests on the ground while the remainder of second member 196 extends upward from ground engagement member 208 and into the hollow interior of first member 194.

In the arrangement shown, as one example, second member 196 extends upward from ground engagement member 208 and into hollow interior of first member 194 until it meets with the components of adjustment mechanism 198 positioned within the hollow interior of first member 194.

Adjustment Mechanism: In the arrangement shown, as one example, legs 46 include adjustment mechanism 198. Adjustment mechanism 198 is formed of any suitable size, shape, and design and is configured to facilitate the raising and lowering of first member 194, and subsequently the raising and lowering of box assembly 22, in order for box assembly 22 to connect to the gate complex of the anaerobic digester tank or covered lagoon. In the arrangement shown, as one example, adjustment mechanism 198 is a sidewinder jack with a handle 210 which is positioned on the outside of first member 194. In the arrangement shown, as one example, as a user winds the handle 210 of adjustment mechanism 198, first member 194 is moved either upward or downward, depending on the direction of winding. However, adjustment mechanism 198 is not so limited, as adjustment mechanism 198 can be any other component or mechanism which allows for the raising and lowering of first member 194 and/or box assembly 22 such as, by way of example and not limitation, a scissor jack, a pneumatic jack, a hydraulic jack, an electric powered jack, a gas piston, a hydraulic piston, or any other type of actuator or other force generating means or combination thereof capable of raising and lowering first member 194 and/or box assembly 22.

While legs 46 and its various components have been described according the arrangement shown, as one example, it will be understood by those skilled in the art that any other configuration of legs 46 and its various components, and any number of legs 46, may be used in order to facilitate the raising and lowering of first member 194 and/or box assembly 22.

Carrier Assembly: In the arrangement shown, as one example, box assembly 22 includes a carrier assembly 48. Carrier assembly 48 is formed of any suitable size, shape, and design and is configured to be housed within frame assembly 44 and facilitate the insertion of the cleaning device into, and removal of the cleaning device from, the anaerobic digester tank or covered lagoon. In the arrangement shown, as one example, carrier assembly 48 includes a carriage 214, a drive assembly 216, a winch assembly 218, and optional sensors 219. Certain components of carrier assembly 48 are housed within the interior of frame assembly 44, and certain components, may be located outside of frame assembly 44. In the arrangement shown, as one example, the motor 230 of drive assembly 216 is located on the outside of frame assembly 44. However, it will be understood by those skilled and the art, and it is hereby contemplated, that in certain alternative arrangements all components of carrier assembly 48 may be housed within the interior of frame assembly 44, and in other alternative arrangements, additional components beyond motor 230 of drive assembly 216 may be located outside of frame assembly 44.

Carriage: In the arrangement shown, as one example, carrier assembly 48 includes carriage 214. Carriage 214 is formed of any suitable size, shape, and design and is configured to facilitate movement of the cleaning device into the anaerobic digester tank or covered lagoon. Specifically, in the arrangement shown, as one example, carriage 214 is configured to contact the cleaning device and push the cleaning device forward, towards the front end 36 of box assembly 22 and, eventually, through the open center 130 (and in certain arrangements, the gate connection member 134) of first end plate 68, and into the anaerobic digester tank or covered lagoon when the gate for the tank of lagoon is opened.

In the arrangement shown, as one example, carriage 214 is formed of a main tube 220, support tubes 222, and connector plates 224. Main tube 220 is formed of any suitable size, shape, and design and is configured to facilitate movement of the cleaning device and allow at least a portion of hose system 28 to pass through carriage 214 and connect to the cleaning device. In the arrangement shown, as one example, main tube 220 is a generally elongated tube with an orifice 226 extending through the main tube 220. In the arrangement shown, as one example, portions of the hose system 28 extend through orifice 226 (and therefore, through main tube 220) and connect to the cleaning device.

In the arrangement shown, as one example, main tube 220 is connected to support tubes 222 such that main tube 220 rests on top of one or more support tubes 222. Support tubes 222 are formed of any suitable size, shape, and design and are configured to support main tube 220. In the arrangement shown, as one example, support tubes 222 are connected to connector plates 224 such that one or more support tubes 222 rest on top of connector plates 224. Connector plates 224 are formed of any suitable size, shape, and design and are configured to connect carriage 214 to drive assembly 216. In the arrangement shown, as one example, connector plates 224 are generally flat, rectangular members which extend in approximate perpendicular relation to main tube 220 such that connector plates 224 contact carrier chains 234 of drive assembly 216.

Drive Assembly: In the arrangement shown, as one example, carrier assembly 48 includes drive assembly 216. Drive assembly 216 is formed of any suitable size, shape, and design and is configured to facilitate movement of carriage 214 and movement of the cleaning device. In the arrangement shown, as one example, drive assembly 216 includes a chain drive system 228 having a motor 230, and idler assembly 232, and carrier chains 234.

Chain drive system 228 is formed of any suitable size, shape, and design and is configured to cause the movement of carrier chains 234 and, therefore, movement of carriage 214. In the arrangement shown, as one example, chain drive system 228 is powered by a motor 230. Motor 230 is formed of any suitable size, shape, and design and is configured to facilitate movement of chain drive system 228. Motor 230 may be any type of motor including an electric motor, a gas powered motor, a hydrostatically drive motor, or any other type of power source capable of facilitating movement of chain drive system 228. In the arrangement shown, as one example, chain drive system 228 includes a drive shaft (not shown) which transfers the movement created by motor 230 to carrier chains 234. In the arrangement shown, as one example, the drive shaft extends through the shaft opening 154 of drive connection plate 152 and connects to carrier chains 234.

In the arrangement shown, as one example, carrier chains 234 are formed of links which connect to one another to form a continuous loop. In the arrangement shown, as one example, carrier chain 234 extends from an idler assembly 232, connected to the idler connection plate 158 near the front end 36 of box assembly 22, to the drive connection plate 152 and/or the non-drive connection plate 190. In this way, carrier chain 234 forms a continuous loop around the idler connection plate 158 and drive connection plate 152 and/or non-drive connection plate 190 and carriage 214 may be placed on top of carrier chains 234. More specifically, connector plates 224 of carriage 214 may be operably connected to carrier chains 234 such that when carrier chains 234 rotate, carriage 214 is move toward front end 36 or rear end 38 of box assembly 22. In this way, drive assembly 216 facilitates movement of carriage 214 and movement of the cleaning device.

When the cleaning device needs to be inserted into the anaerobic digester tank or covered lagoon, the motor 230 will activate and cause carrier chains 234 to rotate such that carriage 214 is moved toward front end 36 of box assembly 22. As carriage 214 is moved toward front end 36, carriage 214 pushes the cleaning device forward until the cleaning device has been inserted into the anaerobic digester tank or covered lagoon. In order to remove the cleaning device from the anaerobic digester tank or covered lagoon, the cleaning device must be pulled back to box assembly 22, which is done by winch assembly 218.

Winch Assembly: In the arrangement shown, as one example, carrier assembly 48 includes winch assembly 218. Winch assembly 218 is formed of any suitable size, shape, and design and is configured to facilitate the removal of the cleaning device from the anaerobic digester tank or covered lagoon by pulling the cleaning device upwards and back toward box assembly 22. Winch assembly 218 may be any type of winch capable of pulling back and/or upward, and winch assembly 218 may be a powered winch or a manual winch. Winch assembly 218 is configured to operably connect to the cleaning device in order to facilitate the removal of the cleaning device from the anaerobic digester tank or covered lagoon.

Sensors: In one or more arrangements, carrier assembly 48 includes sensors 219. Sensors 219 are formed of any suitable size, shape, and design and are configured to measure the position of the carriage 214 within box assembly 22 even though the interior of box assembly 22 cannot be viewed. When the cleaning device is being deployed into the closed system, or is returning into the box assembly 22 after performing a cleaning operation in the closed system, the persons operating system 10 may have a difficult time knowing the positioning of the cleaning device and carriage 214 within box assembly 22. In order to help the persons operating system 10 in these times, sensors 219 may be provided in order for the persons operating system 10 to know when carriage 214 is in certain positioned, which also helps indicate when the cleaning device is in certain positions within box assembly 22.

In various arrangements, as examples, there may be any number of sensors 219 to sense the position of carriage 214 within box assembly 22 and such sensors 219 may be positioned at various locations. In the arrangement shown, as one example, there may be three sensors 219: first sensor 219 configured to measure the position of the front of main tube 220 of carriage 214; a second sensor 219 configured to measure the position of the back of main tube 220; and a third sensor 219 configured to measure whether the cleaning device published by carriage 214 is in an up position or not. Said another way, in the arrangement shown as one example a first sensor 219 is positioned near, and operably connected to, the front of main tube 220 in order to measure the position of the front of main tube 220; a second sensor 219 is positioned near, and operably connected to, the back of main tube 220; and a third sensor 219 is positioned near the front of main tube 220 and is positioned such that when the cleaning device is within box assembly 22 and in an “up” position the sensor 219 is configured to contact a portion of the cleaning device and the sensor 219 senses this contact and when the contact is broken, meaning that the cleaning device is no longer in the “up” position. When the person operating system 10 can know the position of the front of main tube 220, the back of main tube 220, and whether the cleaning device is in the “up” position, the person operating system 10 can know where carriage 214, and subsequently the cleaning device, is at within box assembly 22 even though they cannot see the interior of box assembly 22.

While winch assembly 218 and its various components have been described according the arrangement shown, as one example, it will be understood by those skilled in the art that any other configuration of winch assembly 218 may be used in order to facilitate the removal of the cleaning device from the anaerobic digester tank or covered lagoon. Likewise, while carrier assembly 48 and its various components have been described according to the arrangement shown, as one example, it will be understood by those skilled in the art that any other configuration of carrier assembly 48 may be used in order to facilitate the insertion of the cleaning device into, and removal of the cleaning device from, the anaerobic digester tank or covered lagoon.

Drain Assembly: In the arrangement shown, as one example, box assembly 22 includes drain assembly 52. Drain assembly 52 is formed of any suitable size, shape, and design and is configured to facilitate the draining of liquid from box assembly 22 and/or collection box assembly 24. In the arrangement shown, as one example, box assembly 22 is configured to fill with liquid when the gate complex of the anaerobic digester tank or covered lagoon is opened in order for the cleaning device to be inserted. In the arrangement shown, as one example, when box assembly 22 is filled with liquid, there is a possibility that liquid will leak through the aperture 136 of second end plate 70 and into a collection box 256 of collection box assembly 24. This liquid must be removed from box assembly 22 and collection box assembly 24, and this is accomplished by drain assembly 52. In the arrangement shown, as one example, drain assembly 52 includes a plurality of pipe nipples 238, a plurality of valves 240, a box assembly pipe section 242, and a plurality of T-pipes 244.

Plurality of Pipe Nipples: In the arrangement shown, as one example, drain assembly 52 includes a plurality of pipe nipples 238. Pipe nipples 238 are formed of any suitable size, shape, and design and are configured to fluidly connect to the interior of box assembly 22 and the interior of collection box(es) 256 of collection box assembly 24 in order to drain liquid from box assembly 22 and/or collection box(es) 256 of collection box assembly 24. In the arrangement shown, as one example, pipe nipples 238 are generally elongated, cylindrical tubes which extend downward from the floor panel 66 of box assembly 22 and/or the bottom plate 259 of one or more collection box(es) 256 of collection box assembly 24. In the arrangement shown, as one example, the plurality of pipe nipples 238 are configured to extend downward from the drain opening 128 of floor panel 66 and/or downward from a drain opening of the bottom plate 259 of one or more collection box(es) 256 of collection box assembly 24. As one example, in the arrangement shown there are three pipe nipples 238, with one pipe nipple 238 extending downward from the drain opening 128 of floor panel 66 to fluidly connect with the interior of box assembly 22, a second pipe nipple 238 extending downward from the drain opening of the bottom plate 259 to fluidly connect to the interior of a first collection box 256, and a third pipe nipple 238 extending downward from the drain opening of the bottom plate 259 to fluidly connect to the interior of a second collection box 256. However, any number and shape, design, or configuration of pipe nipples 238 may be used in system 10, as will be understood by those skilled in the art.

In the arrangement shown, as one example, each pipe nipple 238 includes a pipe flange 246. Pipe flange 246 is formed of any suitable size, shape, and design and is configured to facilitate connection of the plurality of pipe nipples 238 to other components of drain assembly 52. More specifically, in the arrangement shown as one example, pipe flanges 246 are configured to connect to one of the plurality of valves 240, which are configured to connect to the box assembly pipe section 242 or T-pipes 244. In this way, pipe flanges 246 facilitate the connection of pipe nipples 238 to other components of drain assembly 52.

Plurality of Valves: In the arrangement shown, as one example, drain assembly 52 includes a plurality of valves 240. Valves 240 are formed of any suitable size, shape, and design and are configured to control the flow of liquid through drain assembly 52. In the arrangement shown, as one example, valves 240 are knife gate valves which may be controlled manually, however any other type of valve and/or gate for controlling the flow of liquid through a pipe may be used as valves 240, and valves 240 may be controlled either manually, hydraulically, electronically, remotely, and/or through any other powered means.

In the arrangement shown, as one example, pipe nipples 238 are fluidly connected with the interior of either box assembly 22 or a collection box 256 of collection box assembly 24 and then a valve 240 is connected to the pipe nipple 238 through pipe flange 246. When valves 240 are in the open position, liquid is able to flow from the interior of either box assembly 22 and/or a collection box 256, through pipe nipples 238 and valves 240, and into either the box assembly pipe section 242 and/or T-pipes 244, and through an additional pipe or hose (not shown) of drain assembly 52 and properly disposed of. In the arrangement shown, as one example, when valves 240 are in a closed position, liquid cannot pass through valves 240, therefore liquid is not able to flow from the interior of either box assembly 22 or a collection box 256 through valves 240, and in this way valves 240 control the flow of liquid through drain assembly 52.

Box Assembly Pipe Section: In the arrangement shown, as one example, the valve 240 connected to the pipe nipple 238 extending downward from the drain opening 128 of floor panel 66 of box assembly 22 is connected to box assembly pipe section 242. Box assembly pipe section 242 is formed of any suitable size, shape, and design and is configured facilitate the removal of liquid, as desired, from the interior of box assembly 22. In the arrangement shown, as one example, box assembly pipe section 242 is an elongated pipe member with a straight section 248 and an angled section 250. The angled section 250 connects to the valve 240, thereby fluidly connecting box assembly pipe section 242 to the interior of box assembly 22 through the applicable valve 240 and pipe nipple 238. As angled section 250 extends downward from the applicable valve 240, angled section 250 curves toward the rear end 38 of box assembly 22 and meets straight section 248. Straight section 248 of box assembly pipe section 242 then extends rearward and fluidly connects to T-Pipes 244 and the additional pipe or hose (not shown) of drain assembly 52 in order for the liquid to be properly disposed of.

T-Pipes: In the arrangement shown, as one example, drain assembly 52 includes T-pipes 244. T-pipes 244 are formed of any suitable size, shape, and design and are configured to facilitate the removal of liquid, as desired, from the interior of one or more collection boxes 256 of collection box assembly 24. In the arrangement shown, as one example, T-pipes 244 are generally in the shape of an upside down T, with a vertical portion which extends upward to connect to a valve 240 which is connected to a pipe nipple 238 extending through a drain opening of the bottom plate 259 of a collection box 256. In the arrangement shown, as one example, there are two T-pipes 244 in system 10, however any other number of T-pipes may be used and, ideally, there will be the same number of T-pipes 244 in drain assembly 52 as there are number of collection boxes 256 of collection box assembly 24. That is, in one or more arrangements, as examples, if there is one collection box 256, there will preferably be one T-pipe 244, likewise if there are three collection boxes 256, there will preferably be three T-pipes 244, however any other number of T-pipes 244 may be used as desirable. In the arrangement shown, as one example, a first T-pipe 244 connects to the straight section 248 of box assembly pipe section 242 at one end, has a vertical portion which extends upward to connect with a valve 240, and has a second end which connects to either another T-pipe 244, or the additional pipe or hose (not shown) of drain assembly 52 in order for the liquid to be properly disposed of.

While drain assembly 52 and its various components have been described according the arrangement shown, as one example, it will be understood by those skilled in the art that any other configuration of drain assembly 52 and its various components may be used in order to facilitate the draining of liquid from box assembly 22 and/or collection box assembly 24.

### Collection Box Assembly:

In the arrangement shown, as one example, system 10 includes a collection box assembly 24. Collection box assembly 24 is formed of any suitable size, shape, and design and is configured to collect liquid leaking out of box assembly 22 and prevent liquid from leaking out of system 10 as a whole. In the arrangement shown, as one example, collection box assembly 24 includes two collection boxes 256, however any other number of collection boxes 256 may be utilized in collection box assembly 24, including one collection box 256, three collection boxes 256, four collection boxes 256, five collection boxes 256, and so on.

The purpose of collection box assembly 24 is to prevent liquid from leaking out of system 10 as a whole. In certain situations, such as in situations where the pressure within the closed system (such as an anaerobic digester tank or covered lagoon) and box assembly 22 is high, liquid will try to exit box assembly 22 through the aperture 136 of second end plate 70. As the pressure gets higher, a higher amount of liquid may leak out of box assembly 22. As more liquid leaks out of box assembly 22, liquid will build up within a first collection box 256. As the first collection box 256 fills with liquid, pressure builds and liquid may eventually escape from the first collection box 256 through the aperture (not shown) of rear end plate 264. In this case, a second collection box 256 is provided and connected to the first collection box 256 to capture this liquid. If it is anticipated that liquid may fill up the second collection box 256 such that liquid will escape from the aperture (not shown) of rear end plate 264 of the second collection box 256, a third collection box 256 may be provided. In many situations, two collection boxes 256 will suffice to prevent any liquid from leaking out of system 10, however, as those of ordinary skill in the art will understand, in other situations additional collection boxes 256 may be necessary, therefore any number of collection boxes 256 may be utilized in collection box assembly 24 in order to prevent liquid from leaking out of system 10.

In the arrangement shown, as one example, each collection box 256 is a generally cubicle box having a top plate 258, a bottom plate 259, opposing left and right side plates 260 (or simply “side plates 260”), a front end plate 262, and a rear end plate 264. In the arrangement shown, as one example, the first collection box 256 is connected to the second end plate 70 of frame assembly 44 of box assembly 22 and the second collection box 256 is connected to the rear end plate 264 of the first collection box 256.

Top Plate: In the arrangement shown, as one example, collection boxes 256 include a top plate 258. Top plate 258 is a generally flat, rectangular, metallic member which extends a length between opposing ends 266 and a width between a front side 268 and a rear side 269. In the arrangement shown, as one example, top plate 258 also includes an access hole with an access hole cover. The access hole is provided to allow a user to access the interior of collection box 256, and the access hole cover is configured to cover access hole when access to the interior of collection box 256 is not required. In one or more arrangements, as examples, top plate 258 may not have an access hole. In one or more arrangements, as examples, a number of collection boxes 256 may be present, with a number of such collection boxes 256 including an access hole in top plate 258 with an access hole cover, and a number of such collection boxes 256 not including an access hole in top plate 258.

Side Plates: In the arrangement shown, as one example, one opposing end 266 of top plate 258 is connected to an upper end 270 of a side plate 260 and the other opposing end 266 is connected to an upper end 270 of the other side plate 260. In the arrangement shown, as one example, side plates 260 are generally flat, rectangular, metallic members which extend a length between upper end 270 and lower end 272 and a width between a front side 274 and a rear side 275. In the arrangement shown, as one example, side plates 260 connect at their lower end 272 to the opposing ends of bottom plate 259.

Bottom Plate: In the arrangement shown, as one example, bottom plate 259 is a generally flat, rectangular, metallic member which extends a length between opposing ends and a width between a front side 278 and a rear side 279. In the arrangement shown, as one example, bottom plate 259 also includes a drain opening (not shown). The drain opening is formed of any suitable size, shape, and design and is configured to connect to a pipe nipple 238 of drain assembly 52 in order to facilitate fluid connection between the interior of a collection box 256 and drain assembly 52. In the arrangement shown, as one example, the drain opening is a generally circular hole extending through bottom plate 259, however the drain opening may be formed of any other shape or design in order to facilitate fluid connection between the interior of collection box 256 and drain assembly 52.

Front End Plate: In the arrangement shown, as one example, the front side 268 of top plate 258, the front side 274 of each side plate 260, and the front side 278 of bottom plate 259 all connect to the rear surface 282 of front end plate 262. Front end plate 262 of collection box 256 is formed of any suitable size, shape, and design and is configured to facilitate engagement of collection box 256 to box assembly 22 and/or another collection box 256. In the arrangement shown where there are two collection boxes 256, as one example, the forward surface of front end plate 262 of the first collection box 256 is connected to the exterior surface 139 of second end plate 70 of box assembly 22, and the forward surface of front end plate 262 of the second collection box 256 is connected to the rear surface 288 of a rear end plate 264 of the first collection box 256. If additional collection boxes 256 are desired, the forward surface of the front end plate 262 of the third collection box 256 will connect with the rear surface 288 of the rear end plate 264 of the second collection box 256, and so on as additional collection boxes 256 are added to collection box assembly 24.

In the arrangement shown, as one example, front end plate 262 is a generally flat, square or rectangular, metallic member which extends a length between opposing sides 290 and a height between opposing edges 292. In the arrangement shown, as one example, front end plate 262 also includes an aperture (not shown) which is configured to allow a portion of hose system 28 to extend therethrough. The aperture of front end plate 262 is formed of any suitable size, shape, and design and is configured to allow hose system 28 to move into and out of box assembly 22 and collection box assembly 24 through the aperture and front end plate 262. In one or more arrangements, the aperture of front end plate 262 is sized such that hose system 28 may pass through the aperture and front end plate 262 while only allowing minimal liquid to pass through the aperture of front end plate 262 when hose system 28 is passed through the aperture of front end plate 262. In the arrangement shown, as one example, the aperture of front end plate 262 is positioned such that when the front end plate 262 of collection box 256 is connected to the exterior surface 139 of second end plate 70 of box assembly 22, the aperture of front end plate 262 and aperture 136 of second end plate 70 are in alignment and hose system 28 may pass through both the aperture of front end plate 262 and aperture 136 of second end plate 70.

Rear End Plate: In the arrangement shown, as one example, the rear side 269 of top plate 258, the rear side 275 of each side plate 260, and the rear side 279 of bottom plate 259 connect to the forward surface of rear end plate 264. Rear end plate 264 of collection box 256 is formed of any suitable size, shape, and design and is configured to facilitate engagement of collection box 256 to additional collection boxes 256 (if any) and/or to hose mover assembly 26. In one or more arrangements, as examples, rear end plate 264 connects to the front end plate 262 of additional collection boxes 256 as described above. In one or more arrangements, as examples, rear end plate 264 connects to the connection plates 330 of frame 310 of hose mover assembly 26. In the arrangement shown, as one example, rear end plate 264 is a generally flat, square or rectangular, metallic member which extends a length between opposing sides 294 and a height between opposing edges 296.

Similar to front end plate 262, rear end plate 264 also includes an aperture. The aperture of rear end plate 264 is formed of any suitable size, shape, and design and is configured to allow hose system 28 to move into and out of collection box assembly 24 through the aperture of rear end plate 264. In one or more arrangements, the aperture of rear end plate 264 is sized such that hose system 28 may pass through the aperture and rear end plate 264 while only allowing minimal liquid to pass through the aperture of rear end plate 264 when hose system 28 is passed through the aperture of rear end plate 264. In the arrangement shown, as one example, the aperture of rear end plate 264 is positioned such that when the rear end plate 264 of collection box 256 is connected to the forward surface of a front end plate 262 of an additional collection box 256, the aperture of rear end plate 264 and the aperture of front end plate 262 of the additional collection box 256 are in alignment and hose system 28 may pass through both the aperture of rear end plate 264 and the aperture of front end plate 262 of the additional collection box 256.

While the collection boxes 256, and various components of the collection boxes 256 have been described according to the arrangements shown, as examples, collection boxes 256 are not so limited. Rather it is contemplated and will be understood by those skilled in the art that collection boxes 256 and their component pieces may be made of any material, whether metallic, non-metallic, composites materials, alloys, or any other material. Similarly, which collection boxes 256 have been shown as being cubical, any other shape or design of connection boxes 256 may be utilized and the component pieces of collection boxes 256 may similarly have different shapes and designs to form collection boxes 256 with such shapes and designs, including collection boxes 256 which are cylindrical, triangular, hexagonal, or any other shape or design. While the collection boxes 256 and collection box assembly 24 have been described according the arrangement shown, as one example, it will be understood by those skilled in the art that any other configuration of collection box 256 and collection box assembly 24 may be used in order to facilitate the capture of liquid leaking from box assembly 22 and facilitate the prevention of liquid from leaking out of system 10 as a whole.

In the arrangement shown, as one example, the last collection box 256 of collection box assembly 24 connects to hose mover assembly 26.

### Hose Mover Assembly:

In the arrangement shown, as one example, system 10 includes hose mover assembly 26. Hose mover assembly 26 is formed of any suitable size, shape, and design and is configured to move hose system 28 through, into, and out of box assembly 22, collection box assembly 24, and the anaerobic digester tank or lagoon. In the arrangement shown, as one example, hose mover assembly 26 has a forward end 300, a rearward end 302, opposing sides 304, an upper end 306, and a lower end 308. In the arrangement shown, as one example, hose mover assembly 26 is connected to the outer most collection box 256 of collection box assembly 24, however in other arrangements hose mover assembly 26 may be connected to box assembly 22 or any other component of system 10 in order to move hose system 28 through, into, and out of box assembly 22, collection box assembly 24, and the anaerobic digester tank or covered lagoon. In the arrangement shown, as one example, hose mover assembly 26 includes a frame 310, a guide assembly 312, and a roller system 314.

Frame: In the arrangement shown, as one example, hose mover assembly 26 includes frame 310. Frame 310 is formed of any suitable size, shape, and design and is configured to support the various components of hose mover assembly 26. In the arrangement shown, as one example, frame 310 includes a forward end member 316, support members 318, a rear end member 320, legs 322, roller mounting plates 324, a drive assembly mounting plate 326, and a motor mounting plate 328.

In the arrangement shown as one example, frame 310 is formed of multiple pieces that are connected or assembled to one another through bolting or welding, however any other means of connecting or assembling the multiple pieces may be used, including screwing, friction fitting, fastening, adhesion, or the like. In the arrangement shown, as one example, frame 310 and its components are formed primarily of a metallic material such as steel, aluminum, chromium, or any other metallic material, alloy, and/or composite thereof. Alternatively, frame 310 and its components may be formed of a non-metallic material such as a plastic material, a fiberglass material, or any other non-metallic material and/or composite thereof.

Forward End Member: In the arrangement shown, as one example, frame 310 includes a forward end member 316. Forward end member 316 is formed of any suitable size, shape, and design and is configured to facilitate connection of hose mover assembly 26 to the outermost collection box 256 of collection box assembly 24, as well as help support various components of hose mover assembly 26. In the arrangement shown, as one example, forward end member 316 is a generally elongated, square tube which extends from one opposing end 329 near one side 304 of hose mover assembly 26 to the other opposing end 329 near the other side 304 of hose mover assembly 26.

In the arrangement shown, as one example, forward end member 316 includes a connection plate 330 at or near each of the opposing ends 329 of forward end member 316. Connection plates 330 are formed of any suitable size, shape, and design and are configured to connect hose mover assembly 26 to the rear surface 288 of rear end plate 264 of collection box 256. In the arrangement shown, as one example, connection plates 330 are generally flat, rectangular members with a forward surface 340 configured to removably connect to the rear end plate 264 of collection box 256, and a rearward surface 342 connected to forward end member 316. In the arrangement shown, as one example, connection plates 330 extend generally vertically between a lower end 332 and an upper end 334. In the arrangement shown, as one example, connection plates 330 include a slot 336 at lower end 332 and an opening 338 near upper end 334. In the arrangement shown, as one example, the forward surface 340 of each connection plates 330 is placed against the rear surface 288 of rear end plate 264 of collection box 256 and a bolt may be placed through the slot 336 and/or opening 338 of connection plates 330 and threaded into an opening in the rear end plate 264 and, in this way, hose mover assembly 26 is connected to collection box 256.

In the arrangement shown, as one example, connection plates 330 are connected to the forward surface of forward end member 316. In the arrangement shown, as one example, support members 318 of frame 310 connect to the rearward surface of forward end member 316.

Support Members: In the arrangement shown, as one example, frame 310 includes support members 318. Support members 318 are formed of any suitable size, shape, and design and are configured to help support various components of hose mover assembly 26. In the arrangement shown, as one example, there are three support members 318 which extend from a forward end 344 to a rear end 346. In the arrangement shown, as one example, the forward end 344 of support members 318 connect to the rearward surface of forward end member 316, and the rear end 346 of support members 318 connect to the forward surface 350 of rear end member 320. In the arrangement shown, as one example, support members 318 are generally elongated, square, metallic tubes, however support members 318 may be formed of any suitable shape or design in order to support various components of hose mover assembly 26.

Rear End Member: In the arrangement shown, as one example, frame 310 includes rear end member 320. Rear end member 320 is formed of any suitable size, shape, and design and is configured to connect to legs 322 and guide assembly 312, as well as help support the various components of hose mover assembly 26. In the arrangement shown, as one example, rear end member 320 is a generally elongated, square tube which extends from one opposing end 348 near one side 304 of hose mover assembly 26 to the other opposing end 348 near the other side 304 of hose mover assembly 26.

In the arrangement shown, as one example, rear end member 320 has a forward surface 350 configured to connect to support members 318. Additionally, rear end member 320 has a rearward surface 352 with leg tubes 354. Leg tubes 354 are formed of any suitable size, shape, and design and are configured to connect legs 322 to rear end member 320. In the arrangement shown, as one example, leg tubes 354 are generally square, open tubes which extend generally vertically between opposing ends. In the arrangement shown, as one example, leg tubes 354 are open such that legs 322 can extend through and out both opposing ends of leg tubes 354. In the arrangement shown, as one example, leg tube 354 include a hole 358 extending through the rearward side of leg tubes 354, through which a tightening mechanism 360 is threaded. Tightening mechanism 360 is formed of any suitable size, shape, and design and is configured to force legs 322 into tight, secured engagement with leg tube 354 such that leg tube 354 will not move relative to legs 322 and vice versa. In the arrangement shown, as one example, tightening mechanism 360 is a bolt with a plastic hand knob for easily hand tightening the bolt against legs 322, however any other type of tightening mechanism may be used to hold legs 322 in secured engagement within leg tubes 354.

In the arrangement shown, as one example, leg tube 354 is connected to rear end member 320 through any method of connection, including welding, adhering, screwing, bolting, riveting, or any other means or methods of connection. In the arrangement shown, as one example, a leg 322 is then inserted through the open bottom opposing end of leg tube 354 and, once the hose mover assembly 26 is at the desired height, a user can tighten the tightening mechanism 360 until the legs 322 are held in place due to frictional engagement, thereby facilitating the secured engagement of legs 322 within leg tubes 354.

Legs: In the arrangement shown, as one example, frame 310 includes legs 322. Legs 322 are formed of any suitable size, shape, and design and are configured to hold hose mover assembly 26 at the proper height. In the arrangement shown, as one example, legs 322 are generally elongated, square tubes which extend a length from an upper end 361 to a lower end 362. In the arrangement shown, as one example, legs 322 also include a ground engagement member 364. Ground engagement member 364 is formed of any suitable size, shape, and design and is configured to provide a secure contact with the ground upon which legs 322 are standing. In the arrangement shown, as one example, ground engagement member 364 is a generally flat, square, metallic member which rests on the ground while the remainder of legs 322 extend upward from ground engagement member 364.

Roller Mounting Plates: In the arrangement shown, as one example, frame 310 includes roller mounting plates 324. Roller mounting plates 324 are formed of any suitable size, shape, and design and are configured to facilitate the connection of roller system 314 to frame 310. In the arrangement shown, as one example, there are three roller mounting plates 324, with a first roller mounting plate 324 positioned near the forward end 300 of hose mover assembly 26, a second roller mounting plate 324 positioned near the middle of hose mover assembly 26, and a third roller mounting plate 324 positioned near the rearward end 302 of hose mover assembly 26. However, roller mounting plates 324 are not so limited and any number of roller mounting plates 324 may be used in order to facilitate the connection of roller system 314 to frame 310.

In the arrangement shown, as one example, roller mounting plates 324 are generally flat, rectangular, metallic members which extend a length between opposing ends and a width between opposing sides. In the arrangement shown, as one example, roller mounting plates 324 include a plurality of openings 366 configured to receive a connection member, such as by way of example and not limitation a bolt, screw, or other means of connection, in order to connect portions of roller system 314 to frame 310.

Drive Assembly Mounting Plate: In the arrangement shown, as one example, frame 310 also includes a drive assembly mounting plate 326. Drive assembly mounting plate 326 is formed of any suitable size, shape, and design and is configured to facilitate the connection of drive assembly 406 of roller system 314 to frame 310. In the arrangement shown, as one example, drive assembly mounting plate 326 has an interior surface and an exterior surface 374. In the arrangement shown, as one example, the interior surface of drive assembly mounting plate 326 is connected to the middle support member 318. In the arrangement shown, as one example, drive assembly mounting plate 326 is generally in the shape of a “T”. That is, in the arrangement shown as one example, drive assembly mounting plate 326 includes a lower portion 368 which has a first width that is less than the width of an upper portion 370. In the arrangement shown, as one example, the upper portion 370 of drive assembly mounting plate 326 includes a number of openings 376 configured to facilitate connection of various components of drive assembly 406 of roller system 314 to frame 310.

Motor Mounting Plate: In the arrangement shown, as one example, frame 310 includes a motor mounting plate 328. Motor mounting plate 328 is formed of any suitable size, shape, and design and is configured to facilitate connection of motor 414 of drive assembly 406 of roller system 314 to frame 310. In the arrangement shown, as one example, motor mounting plate 328 is a generally flat, rectangular, metallic member which connects to the bottom of the support member 318 on one opposing side 304 of hose mover assembly 26. In the arrangement shown, as one example, motor mounting plate 328 includes a number of holes 378 configured to receive bolts, screws, or other means of connection in order to connect motor mounting plate 328 to support member 318, and holes 378 also are configured to receive bolts, screws, and other means of connection in order to connect the motor 414 of drive assembly 406 of roller system 314 to motor mounting plate 328.

While frame 310 and its various components have been described according the arrangement shown, as one example, it will be understood by those skilled in the art that any other configuration of frame 310 and its various components may be used in order to support the various components of hose mover assembly 26.

Guide Assembly: In the arrangement shown, as one example, hose mover assembly 26 includes a guide assembly 312 connected to the rear end member 320 of frame 310. Guide assembly 312 is formed of any suitable size, shape, and design and is configured to help guide hose system 28 into hose mover assembly 26. In the arrangement shown, as one example, guide assembly 312 forms generally a square guide at the rearward end 302 of hose mover assembly 26 and includes a top member 382, side members 384, a bottom member 386, and rollers 388.

Top Member: In the arrangement shown, as one example, guide assembly 312 includes a top member 382. Top member 382 is formed of any suitable size, shape, and design and is configured to set an upper boundary for guide assembly 312 in order to help guide hose system 28 into hose mover assembly 26. In the arrangement shown, as one example, top member 382 is a generally elongated, square tube which extends a length between opposing ends. In the arrangement shown, as one example, top member 382 is positioned at or near the upper end 306 of hose mover assembly 26. In the arrangement shown, as one example, the side members 384 connect to top member 382 near each of the opposing ends of top member 382.

Side Members: In the arrangement shown, as one example, guide assembly 312 includes side members 384. Side members 384 are formed of any suitable size, shape, and design and are configured to set the left and right boundaries for guide assembly 312 in order to help guide hose system 28 into hose mover assembly 26. In the arrangement shown, as one example, side members 384 are generally elongated, square tubes which extend a length between an upper end 392 and a lower end 394. In the arrangement shown, as one example, the upper end 392 of side members 384 connect to top member 382 and the lower end 394 of side members 384 connect to bottom member 386. In the arrangement shown, as one example, there is a gusset 396 connected to each side member 384 in order to help support side members 384 and guide assembly 312. Gussets 396 are generally flat, triangular members which connect to rear end member 320 and side members 384 and extend upward a distance with side members 384.

Bottom Member: In the arrangement shown, as one example, guide assembly 312 includes a bottom member 386. Bottom member 386 is formed of any suitable size, shape, and design and is configured to help connect guide assembly 312 to frame 310 and set a lower boundary for guide assembly 312 in order to help guide hose system 28 into hose mover assembly 26. In the arrangement shown, as one example, bottom member 382 is a generally elongated, square tube which extends a length between opposing ends 398. In the arrangement shown, as one example, side members 384 connect to the top of bottom member 386 at or near each of the opposing ends 398. In the arrangement shown, as one example, bottom member 386 connects to rear end member 320 through any connection means including bolting, screwing, riveting, welding, adhering, or any other suitable means of connection.

In the arrangement shown, as one example, each of the top member 382, the side members 384, and the bottom member 386 include openings. Such openings are configured to receive attachment members 402, such as by way of example and not limitation bolts or screws, from rollers 388 to connect rollers 388 to guide assembly 312.

Rollers: In the arrangement shown, as one example, guide assembly 312 includes rollers 388. Rollers 388 are formed of any suitable size, shape, and design and are configured to facilitate smooth movement of hose system 28 through guide assembly 312 and into hose mover assembly 26. In the arrangement shown, as one example, there are four rollers 388, one connected to the top member 382, one connected to each of the side members 384, and one connected to the bottom member 386. In the arrangement shown, as one example, rollers 388 connect to the top member 382, each side member 384, and the bottom member 386 using attachment members 402. Attachment members 402 may be any suitable means of connection including, by way of example and not limitation, bolts, screws, or rivets. In the arrangement shown, as one example, rollers 388 are idler rollers which are not meant to cause hose system 28 to move into and through hose guide assembly 312 of hose mover assembly 26, rather rollers 388 are configured to simply facilitate the smooth entry of hose system 28 into hose guide assembly 312 of hose mover assembly 26.

Roller System: In the arrangement shown, as one example, hose mover assembly 26 includes roller system 314. Roller system 314 is formed of any suitable size, shape, and design and is configured to move hose system 28 in and out of the anaerobic digester tank or covered lagoon, and move hose system 28 through collection box assembly 24 and box assembly 22. In the arrangement shown, as one example, roller system 314 includes a drive assembly 406, a lower roller assembly 408, and an upper roller assembly 410.

Drive Assembly: In the arrangement shown, as one example, roller system 314 includes drive assembly 406. Drive assembly 406 is formed of any suitable size, shape, and design and is configured to create rotational movement and facilitate the transfer of such rotational movement to the rollers 470 of lower roller assembly 408, thereby causing the movement of hose system 28. In the arrangement shown, as one example, drive assembly 406 is operably connected to frame 310 through the use of drive assembly mounting plate 326 and motor mounting plate 328 of frame 310. In the arrangement shown, as one example, drive assembly 406 includes a motor 414 with a drive shaft 416, a drive chain 418, drive sprockets 420, a plurality of roller sprockets 422 with roller shafts 424 and connector chains 426, and a sprocket guard 428.

In the arrangement shown as one example, drive assembly 406 includes motor 414. Motor 414 is formed of any suitable size, shape, and design and is configured to facilitate movement of the rollers 470 of lower roller assembly 408. Motor 414 may be any type of motor including an electric motor, a gas powered motor, a hydrostatically driven motor, or any other type of power source capable of facilitating movement of rollers 470. In the arrangement shown, as one example, motor 414 is connected to motor mounting plate 328 of frame 310 of hose mover assembly 26, such as by bolting, screwing, riveting, fastening, or other means of connection. In the arrangement shown, as one example, motor 414 includes an elongated drive shaft 416 which is configured to transfer the movement created by motor 414 to the drive chain 418.

In the arrangement shown, as one example, drive assembly 406 includes a drive chain 418. Drive chain 418 is formed of any suitable size, shape, and design and is configured to operably connect to drive shaft 416, drive chain sprockets 420, and at least one of the plurality of roller sprockets 422 in order to transfer movement from motor 414 and drive shaft 416 to rollers 470. In the arrangement shown, as one example, drive chain 418 is formed of links which connect to one another to form a continuous loop. In the arrangement shown, as one example, drive chain sprockets 420 are positioned around drive chain 418 such that drive chain 418 is in a “T” shape when on drive assembly 406. In the arrangement shown, as one example, the portion of drive chain 418 closes to lower end 308 of hose mover assembly 26 extends around a first drive chain sprocket 420 connected to drive shaft 416 of motor 414. In the arrangement shown, as one example, the portion of drive chain 418 closer to the upper end 306 of hose mover assembly 26 extends around a first roller sprocket 422 closer to the rearward end 302 of hose mover assembly 26, and a second roller sprocket 422 closer to the forward end 300 of hose mover assembly 26. In the arrangement shown, as one example, second and third drive chain sprocket 420 are positioned vertically between the first drive sprocket 420 and the first and second roller sprockets 422, and drive chain 418 is positioned such that drive chain 418 contacts a portion of the second and third drive sprockets 420 and this forces drive chain 418 inward, thereby forming the “T” shape of drive chain 418.

In the arrangement shown, as one example, there are three drive chain sprockets 420, positioned as described herein relative to drive chain 418. In the arrangement shown, as one example, drive chain sprockets 420 include teeth which are configured to operably connect and disconnect from the links of drive chain 418 as drive chain sprockets 420 rotate. In the arrangement shown, as one example, one drive chain sprocket 420 is connected to drive shaft 416, which is operably connected to motor mounting plate 328. In the arrangement shown, as one example, the other two drive chain sprockets 420 are connected to frame 310 through drive assembly mounting plate 326. More specifically, in the arrangement shown, as one example, the other two drive chain sprockets 420 are connected to an idler shaft 434 of either first tensioner bar 436 or second tensioner bar 438. In the arrangement shown, as one example, the idler shaft 434 extends through the open center of the drive chain sprocket 420. In the arrangement shown, as one example, the first tensioner bar 436 includes openings 442 which are configured to receive a bolt, screw, or other fastener, which extends through first tensioner bar 436 and through a number of the openings 376 of upper portion 370 of drive assembly mounting plate 326. In the arrangement shown, as one example, the second tensioner bar 438 includes slots 444 of second tensioner bar 438 which are also configured to receive a bolt, screw, or other fastener, which extends through second tensioner bar 438 and through a number of the openings 376 of upper portion 370 of drive assembly mounting plate 326. In the arrangement shown, as one example, second tensioner bar 438 includes slots 444 which are configured to allow the placement of one of the drive chain sprockets 420 to be adjusted in order to have proper tension on drive chain 418. That is, the second tensioner bar 438 is configured to move laterally, which allows for one of the drive chain sprockets 420 to move laterally and, depending on the direction of movement, movement of the drive chain sprocket 420 causes drive chain 418 to become more or less tightly engaged with each of the drive chain sprockets 420, and the two roller sprockets 422 around which drive chain 418 also extends.

In the arrangement shown, as one example, the first drive chain sprocket 420 connected to drive shaft 416 rotates as drive shaft 416 rotated. This rotation of first drive chain sprocket 420 causes drive chain 418, as well as the second and third drive chain sprockets 420 to rotate. Additionally, the rotation of drive chain 418 causes the rotation of a number of the roller sprockets 422. More specifically, in the arrangement shown, as one example, the rotation of drive chain 418 causes a first and second roller sprocket 422 to rotate.

In the arrangement shown, as one example, drive assembly 406 includes a plurality of roller sprockets 422. Roller sprockets 422 are formed of any suitable size, shape, and design and are configured to operably connect to drive chain 418 and rollers 470 of lower roller assembly 408 in order to help transfer rotation from motor 414 to rollers 470. In the arrangement shown, as one example, there are six roller sprockets 422, however any other number of roller sprockets 422 may be used in hose mover assembly 26. In the arrangement shown, as one example, there are the same number of roller sprockets 422 as there are rollers 470 of lower roller assembly 408, and each roller sprockets 422 is configured to connect to one of the rollers 470, however the embodiments are not so limited, and there may be more or less roller sprockets 422 than there are rollers 470 in other arrangements.

In the arrangement shown, as one example, roller sprockets 422 include teeth. The teeth are formed of any suitable size, shape, and design and are configured to operably connect and disconnect from the links of drive chain 418 and/or connector chains 426. In the arrangement shown, as one example, each of the roller sprockets 422 are operably connected to other roller sprockets 422 through connector chains 426. Connector chains 426 are formed of any suitable size, shape, and design and are configured to connect the plurality of roller sprockets 422 to each other in order to ensure rotation of all of the plurality of roller sprockets 422. In the arrangement shown, as one example, connector chains 426 are formed of links which connect to one another to form a continuous loop.

In the arrangement shown, as one example, there are four connector chains 426, however any other number of connector chains 426 may be used. In the arrangement shown, as one example, each connector chain 426 extends around one roller sprockets 422 at one end of connector chain 426, and a second roller sprocket 422 at the other end of connector chain 426. In the arrangement shown, as one example, when the drive chain 418 rotates, two of the roller sprockets 422 are caused to rotate. As these two roller sprockets 422 rotate, the connector chains 426 connected to each of these roller sprockets 422 are caused to rotate, which in turn causes the rotation of two additional roller sprockets 422 at the other end of such connector chains 426. When the two additional roller sprockets 422 are rotated, the respective connector chains 426 connected to these roller sprockets 422 are configured to rotate and, in turn, the roller sprockets 422 at the other end of each of these connector chains 426 rotate as well. In this way, the rotation of drive chain 418 causes each of the roller sprockets 422 to rotate with the help of connector chains 426.

In the arrangement shown, as one example, each roller sprocket 422 also includes a roller shaft 424. Roller shafts 424 are formed of any suitable size, shape, and design and are configured to extend through and rotate with roller sprockets 422 and extend through and cause the rotation of rollers 470 of lower roller assembly 408. In the arrangement shown, as one example, roller shafts 424 are generally elongated, cylindrical rods extending a length between opposing ends. In the arrangement shown, as one example, one opposing end is near one opposing side 304 of hose mover assembly 26 and the other opposing end is near the other opposing side 304 of hose mover assembly 26. In the arrangement shown, as one example, roller shafts 424 extend through the middle of roller sprockets 422 and through the middle of rollers 470 of lower roller assembly 408. As the roller sprockets 422 rotate, roller shafts 424 also rotate and cause rollers 470 of lower roller assembly 408 to rotate as well.

In the arrangement shown, as one example, each roller sprocket 422 is connected to sprocket guard 428. Sprocket guard 428 is formed of any suitable size, shape, and design and is configured to support roller sprockets 422 while allowing roller shaft 424 to extend through sprocket guard 428. In the arrangement shown, as one example, sprocket guard 428 extends between opposing ends 452, a height between a top end 454 and a bottom edge 456, and a depth between an exterior surface 460 and an interior surface 462. In the arrangement shown, as one example, roller sprockets 422 are connected to an exterior surface 460 of sprocket guard 428. In the arrangement shown, as one example, sprocket guard 428 includes a plurality of notches 458. Notches 458 are formed of any suitable size, shape, and design and are configured to allow roller shafts 424 to extend through sprocket guard 428. In the arrangement shown, as one example, notches 458 extend upward from bottom edge 456 to a point near top end 454.

Lower Roller Assembly: In the arrangement shown, as one example, roller system 314 of hose mover assembly 26 includes a lower roller assembly 408. Lower roller assembly 408 is formed of any suitable size, shape, and design and is configured to engage hose system 28 and facilitate the movement of hose system 28. In the arrangement shown, as one example, lower roller assembly 408 includes a lower angle 466, a flange bearing 468, and rollers 470.

In the arrangement shown, as one example, lower roller assembly 408 includes a lower angle 466. Lower angle 466 is formed of any suitable size, shape, and design and is configured to facilitate connection of lower roller assembly 408 to frame 310. In the arrangement shown, as one example, lower angle 466 is a generally L-shaped, elongated member with a base 474 and a vertical portion 476. In the arrangement shown, as one example, base 474 is configured to rest upon and connect to roller mounting plates 324. In the arrangement shown, as one example, vertical portion 476 includes holes 478 extending through vertical portion 476 which allow roller shafts 424 of drive assembly 406 to extend through lower angle 466 in order to extend through rollers 470.

In the arrangement shown, as one example, flange bearings 468 are configured to connect to the vertical portion 476 of lower angle 466. Flange bearings 468 are formed of any suitable size, shape, and design and are configured to support roller shafts 424 as they extend from roller sprockets 422 to rollers 470. In the arrangement shown, as one example flange bearings 468 are two-bolt flange mount bearings which are connected to the vertical portion 476 through the use of bolts, however any other connection means may be used including welding, riveting, screwing, fastening, or any other means of connection. Additionally or alternatively, flange bearings 468 may be any other type of bearing configured to support roller shafts 424 as they extend from roller sprockets 422 to rollers 470.

In the arrangement shown, as one example, lower roller assembly 408 includes rollers 470. Rollers 470 are formed of any suitable size, shape, and design and are configured to receive a roller shaft 424 therein, rotate with roller shaft 424, and engage hose system 28 to facilitate the movement of hose system 28. In the arrangement shown, as one example, there are six rollers 470, however any other number of rollers 470 may be used in hose mover assembly 26. In the arrangement shown, as one example, rollers 470 are generally elongated, cylindrical members with a hollow center (not shown) extending through rollers 470 from one opposing end to the other opposing end of rollers 470. In the arrangement shown, as one example, the hollow center of rollers 470 are shaped and designed to receive a roller shaft 424 therein and engage roller shaft 424 in frictional engagement such that when roller shaft 424 rotates, roller 470 rotates as well.

In the arrangement shown, as one example, rollers 470 are formed of a material with a sufficient coefficient of friction which allows it to engage hose system 28 and cause hose system 28 to move as rollers 470 rotate. In this arrangement, as one example, rollers 470 may be a plastic material with high durability, however any other material may be used as rollers 470 including, by way of example and not limitation, metallic material, any other non-metallic material, a wooden material, a composite material, an alloy, or any other material.

In the arrangement shown, as one example, as rollers 470 rotate and move hose system 28 through hose mover assembly 26, the rollers 494 of upper roller assembly 410 also engage hose system 28 and are caused to rotate by movement of hose system 28 through hose mover assembly 26.

Upper Roller Assembly: In the arrangement shown, as one example, roller system 314 of hose mover assembly 26 also includes an upper roller assembly 410. Upper roller assembly 410 is formed of any suitable size, shape, and design and is configured to accommodate for varying sizes of hose system 28 and help facilitate movement of hose system 28 through hose mover assembly 26. In the arrangement shown, as one example, upper roller assembly 410 includes mounting plates 482, a top angle 484, fasteners 486, springs 488, shaft holders 490, idler roller shafts 492, and rollers 494.

In the arrangement shown, as one example, upper roller assembly 410 includes mounting plates 482. Mounting plates 482 are formed of any suitable size, shape, and design and are configured to operably connect the various components of upper roller assembly 410 to frame 310 of hose mover assembly 26. In the arrangement shown, as one example, there are three mounting plates 482 and each mounting plate 482 is positioned a distance directly above each of the drive assembly mounting plates 326. In the arrangement shown, as one example, mounting plates 482 have rods 500 and nuts 502.

In the arrangement shown, as one example, mounting plates 482 are generally flat and rectangular members which extend between opposing sides, however mounting plates 482 may be formed of any other suitable size, shape, and/or design. In the arrangement shown, as one example, rods 500 extend through a set of outer openings 504 of mounting plates 482. Rods 500 may be formed of any suitable size, shape, and design and are configured to facilitate connection between mounting plates 482 and drive assembly mounting plates 326. In the arrangement shown, as one example, rods 500 are threaded rods which extend through mounting plates 482 and through drive assembly mounting plates 326. Once rods 500 are properly positioned, nuts 502 are threaded onto rods 500 in order to keep rods 500 correctly positioned and connected to mounting plates 482 and drive assembly mounting plates 326.

In the arrangement shown, as one example, mounting plates 482 also include inner openings 506 configured to connect top angle 484 to mounting plates 482. Top angle 484 is formed of any suitable size, shape, and design and is configured to operably connect rollers to mounting plates 482. In the arrangement shown, as one example, there are two top angles 484, one near each of the opposing sides 304 of hose mover assembly 26. In the arrangement shown, as one example, top angle 484 connects to mounting plates 482 through any means of connection such as a bolt, screw, fastener, welding, adhesion, or any other means of connection. In the arrangement shown, as one example, top angle 484 includes a plurality of slots 496. Slots 496 are formed of any suitable size, shape, and design and are configured to allow for idler roller shafts 492 to extend through top angle 484 and move vertically as needed.

In the arrangement shown, as one example, top angle 484 includes tabs 510. Tabs 510 are formed of any suitable size, shape, and design and are configured to receive and hold fasteners 486. In the arrangement shown, as one example, tabs 510 are generally rectangular members which connect to the upper surface 508 of top angle 484 and extend a distance outward from top angle 484. In the arrangement shown, as one example, tabs 510 have a hole 512 extending therethrough which receive fasteners 486. Fasteners 486 are formed of any suitable size, shape, and design and are configured to extend through the holes 512 of tabs 510 and connect to shaft holders 490. In the arrangement shown, as one example, fasteners 486 are bolts or screws which extend downward from tabs 510, through the middle of springs 488, and connect to shaft holder 490.

Springs 488 are formed of any suitable size, shape, and design and are configured to allow upper roller assembly 410 to adjust in order to accommodate different sizes of hose system 28. In the arrangement shown, as one example, springs 488 are positioned between tabs 510 and shaft holder 490, and fasteners 486 extend through the middle of springs 488. In the arrangement shown, as one example, as hose system 28 is moved through hose mover assembly 26, portions of hose system 28 may require more room (due to variations in the diameter of hose system 28) to move through hose mover assembly 26 and springs 488 are allowed to compress and expand in order to create the appropriate spacing needed for hose system 28 to move through hose mover assembly 26.

In the arrangement shown, as one example, fasteners 486 and springs 488 are engaged with shaft holder 490 of upper roller assembly 410. Shaft holder 490 is formed of any suitable size, shape, and design and is configured to operably connect to top angle 484 through fastener 486, and allow idler roller shaft 492 to pass therethrough. In the arrangement shown, as one example, shaft holder 490 is a generally square or rectangular cube member configured to receive fastener 486 through a top opening 514 and receive idler roller shaft 492 through a side opening 516.

In the arrangement shown, as one example, the side opening 516 of shaft holder 490 is generally aligned with slots 496 of top angle 484 such that idler roller shafts 492 may extend through the side opening 516 of shaft holder 490 and through the slots 496 of top angle 484. Idler roller shafts 492 are formed of any suitable size, shape, and design and are configured to extend through rollers 494 of upper roller assembly 410. In the arrangement shown, as one example, idler roller shafts 492 are generally elongated, cylindrical members which extend between opposing ends 518. In the arrangement shown, as one example, idler roller shafts 492 are connected to shaft holders 490 at each opposing end 518 of idler roller shafts 492, thereby ensuring secured engagement of idler roller shafts 492 to upper guide assembly 410. In the arrangement shown, as one example, as idler roller shafts 492 extend from one opposing end 518 to the other opposing end 518, idler roller shafts 492 extend through rollers 494.

In the arrangement shown, as one example, upper guide assembly 410 includes rollers 494. Rollers 494 are formed of any suitable size, shape, and design and are configured to engage with hose system 28 and rotate as hose system 28 is moved through hose mover assembly 26. In the arrangement shown, as one example, there are six rollers 494, each of the six rollers 494 positioned a distance above each of the rollers 470 of lower roller assembly 408. In the arrangement shown, as one example, rollers 494 are generally elongated, cylindrical members with hollow centers (not shown) extending through rollers 494 from one opposing end to the other opposing end of rollers 494. In the arrangement shown, as one example, the hollow centers of rollers 494 are shaped and sized to receive idler roller shafts 492 therein.

In the arrangement shown, as one example, rollers 494 are formed of a material with a sufficient coefficient of friction which allows it to engage hose system 28. In this arrangement, as one example, rollers 494 may be a plastic material with high durability, however any other material may be used as rollers 494 including, by way of example and not limitation, metallic material, any other non-metallic material, a wooden material, a composite material, an alloy, or any other material.

In operation, hose mover assembly 26 facilitates movement of hose system 28 as follows. A user can feed hose system 28 partially into hose mover assembly 26 through guide assembly 312. The user can then start motor 414 of drive assembly 406. As motor 414 operates, motor 414 causes drive shaft 416 to rotate. As drive shaft 416 rotates, a drive chain sprocket 420 connected to drive shaft 416 begins to rotate. The rotation of the first drive chain sprocket 420 causes the teeth of the drive chain sprocket 420 to engage with the links of drive chain 418, thereby causing drive chain 418 to rotate. As described herein, drive chain 418 engages with additional drive chain sprockets 420, as well as a first and second roller sprockets 422. As drive chain 418 rotates, this causes the additional drive chain sprockets 420, as well as the first and second roller sprockets 422 to rotate. As the first roller sprocket 422 rotates, the teeth of such roller sprocket 422 engage the links of a first connector chain 426 extending around such first roller sprocket 422. As the first connector chain 426 rotates, this causes a third roller sprocket 422 (connected to the other end of the first connector chain 426) to rotate as well. Such third roller sprocket 422 has a second connector chain 426 connected thereto, which rotates as the third roller sprocket 422 rotates, thereby causing a fifth roller sprocket 422 (connected to the other end of the second connector chain 426) to rotate as well. Likewise, as the second roller sprocket 422 rotates, this causes the third connector chain 426 connected to the second roller sprocket 422 to rotate, thereby causing a fourth roller sprocket 422 (connected to the other end of the third connector chain 426) to rotate. The fourth roller sprocket 422 is also connected to a fourth connector chain 426, which is caused to rotate, thereby causing rotation of a sixth roller sprocket 422 (which is connected to the other end of the fourth connector chain 426). At this point, each of the roller sprockets 422, as well as the drive sprockets 420 are rotating.

With each of the roller sprockets 422 rotating, the roller shafts 424 extending through each roller sprocket 422 are also rotating. Roller shafts 424 extend through the rollers 470 of lower roller assembly 408 as described herein. As the roller shafts 424 rotate with each roller sprocket 422, the rollers 470 are also forced to rotate with roller shafts 424. As rollers 470 rotate, they engage hose system 28, which is at this point either partially extended through hose mover assembly 26, wholly extended through hose mover assembly 26, or is in the process of being inserted into hose mover assembly 26. When rollers 470 engage hose system 28, hose system 28 is caused to move through hose mover assembly 26 due to the frictional engagement with rollers 470 and the rotation of rollers 470.

As hose system 28 is moved through hose mover assembly 26, hose system 28 also engages rollers 494 of upper roller assembly 410. As hose system 28 engages rollers 494, rollers 494 also begin to rotate. In the arrangement shown, as one example, variations in hose system 28 mean a larger area may be needed for certain sections of hose system 28 to move through hose mover assembly 26. In order to facilitate these variations, rollers 494 may move up and down as needed. As enlarged sections of hose system 28 move through hose mover assembly 26, they exert an upward force on rollers 494 of upper roller assembly 410. As rollers 494 experience this upward force, they transfer this upward force to idler roller shafts 492, which in turn exert an upward force on shaft holder 490. As shaft holder 490 experiences this upward force, shaft holder 490 exerts the upward force on springs 488, which compress under this upward force, thereby allowing shaft holder 490, as well as idler roller shafts 492 and rollers 494 to move upward. When rollers 494 move upward, the enlarged sections of hose system 28 are able to move through hose mover assembly 26 efficiently.

While hose mover assembly 26 and its various components have been described according the arrangement shown, as one example, it will be understood by those skilled in the art that any other configuration of hose mover assembly 26 and its various components may be used in order to facilitate the movement of hose system 28 through, into, and out of box assembly 22, collection box assembly 24, and the anaerobic digester tank or lagoon.

### Hose System:

In the arrangement shown, as one example, system 10 includes a hose system 28. Hose system 28 is formed of any suitable size, shape, and design and is configured to remove material from the floor of the anaerobic digester tank or covered lagoon. In the arrangement shown, as one example, hose system 28 includes an outer hose 530 connected to a gas system (not shown), a hose connector 534, an inner hose 536, an electrical cable 538, and seals 540.

Outer Hose: In the arrangement shown, as one example, hose system 28 includes an outer hose 530. Outer hose 530 is formed of any suitable size, shape, and design and is configured to house other components of hose system 28 and facilitate the floating of hose system 28, or portions of hose system 28, as necessary. In the arrangement shown, as one example, outer hose 530 is a lay flat hose made of a material such as polyurethane, polyvinyl chloride (PVC), rubber, or similar material, however any other type of hose may be used as outer hose 530. In the arrangement shown, as one example, outer hose 530 extends between a first end and a second end. In the arrangement shown, as one example, the first end of outer hose 530 is configured to connect to the gas system and the first end includes a fill valve 546, a pressure relief valve 548, and a pressure gauge 550. Fill valve 546 is formed of any suitable size, shape, and design and is configured to connect to the gas system and allow gas to be inserted into outer hose 530. Pressure relief valve 548 is formed of any suitable size, shape, and design and is configured to allow gas to be released from outer hose 530 when desired or necessary to ensure safe operation of hose system 28. Pressure gauge 550 is formed of any suitable size, shape, and design and is configured to measure and display the pressure within outer hose 530 and hose system 28 in order for a user to monitor pressure and ensure safe operation of hose system 28.

The gas system (not shown) is formed of any suitable size, shape, and design and is configured to insert gas into the outer hose 530 of hose system 28 and control the buoyancy of hose system 28. In the arrangement shown, as one example, the gas system is preferably configured to insert nitrogen gas into outer hose 530 in order to cause hose system 28 to float when the cleaning device is in the anaerobic digester tank or covered lagoon, however any other desired gases may be inserted into outer hose 530 as needed and gas system is not limited to inserting nitrogen gas into outer hose 530. In the arrangement shown, as one example, as the gas system inserts gas into outer hose 530, outer hose 530 expands and, when the cleaning device is cleaning the floor of the anaerobic digester tank or covered lagoon, a portion of the hose system 28 will float up from the floor of the anaerobic digester tank or covered lagoon.

The second end of outer hose 530 is configured to connect to the cleaning device. In the arrangement shown, as one example, the second end of outer hose 530 connects to the cleaning device through hose connector 534.

Hose Connector: In the arrangement shown, as one example, hose system 28 includes hose connector 534. Host connector 534 is formed of any suitable size, shape, and design and is configured to connect hose system 28 to the cleaning device. In the arrangement shown, as one example, hose connector 534 and its various components may be formed of any material capable of being in water without corroding or otherwise compromised. This may be a metallic material or an alloy, a plastics material, any other non-metallic material, a composites material, or any other suitable material. In the arrangement shown, as one example, hose connector 534 is a generally elongated, cylindrical member with a first end 554, a body 556, and a second end 558.

First End: In the arrangement shown, as one example, hose connector 534 includes a first end 554. First end 554 is formed of any suitable size, shape, and design and is configured to connect to the cleaning device. In the arrangement shown, as one example, first end 554 is a hose fitting which is a generally cylindrical member with a first threaded portion 560, an angled portion 562, and a second threaded portion (not shown). In the arrangement shown, as one example, first threaded portion 560 is generally cylindrical and has a radius which is generally smaller than the radius of the second threaded portion. In the arrangement shown, as one example, first threaded portion 560 is externally threaded in order to connect to a corresponding, internally threaded receiver on the cleaning device. In the arrangement shown, as one example, angled portion 562 connects first threaded portion 560 and the second threaded portion.

In the arrangement shown, as one example, angled portion 562 starts with a radius equal to the radius of first threaded portion 560. As angled portion 562 extends towards the second threaded portion, the radius of angled portion 562 becomes larger until it is equal to the radius of the second threaded portion, which is the radius when angled portion 562 connects to the second threaded portion. In the arrangement shown, as one example, the second threaded portion of first end 554 is generally cylindrical and is also externally threaded in order to be threaded into the internally threaded hollow interior 566 of body 556.

Body: In the arrangement shown, as one example, hose connector 534 includes a body 556. Body 556 is formed of any suitable size, shape, and design and is configured to connect the first end 554 and second end 558 of hose connector 534, thereby operably connecting the cleaning device to inner hose 536. In the arrangement shown, as one example, body 556 is formed of multiple pieces connected together through means such as screwing, bolting, fastening, welding, adhering, or other means of connection. Alternatively, body 556 may be formed of a singular, unitary member which is formed through a process such as machining, casting, additive manufacturing, molding, or any other manufacturing process in order to form a single, unitary member.

In the arrangement shown, as one example, body 556 is a generally cylindrical member with an internally threaded hollow interior 566. Internally threaded hollow interior 566 is formed of any suitable size, shape, and design and is configured to receive and operably connect with the second threaded portion of first end 554 and the second threaded portion 584 of second end 558, and allow material to pass from the cleaning device, through hose connector 534, and into inner hose 536. In the arrangement shown, as one example, body 556 also includes top surface 568 which is generally flat and planar, rather than cylindrical. In the arrangement shown, as one example, top surface 568 includes a groove 570 and is configured to connect to cap 572 of body 556 of hose connector 534.

Cap 572 is formed of any suitable size, shape, and design and is configured to connect to top surface 568 of body 556 and allow electrical cable 538 to pass through body 556. In the arrangement shown, as one example, cap 572 includes a bottom surface 574 which is generally flat and planar, and a top surface 576 which is generally curved. In the arrangement shown, as one example, the bottom surface 574 of cap 572 also includes a groove 578. In the arrangement shown, as one example, the flat and planar bottom surface 574 of cap 572 is placed on top of the top surface 568 of body 556 such that the groove 570 of top surface 568 and the groove 578 of cap 572 are in alignment and electrical cable 538 may pass through body 556. In the arrangement shown, as one example, cap 572 is connected to body 556 using screws or bolts, however any other means of fastening or connecting cap 572 to body 556 may be used including, but not limited to, welding or adhesion.

Second End: In the arrangement shown, as one example, the internally threaded hollow interior 566 of body 556 is configured to receive second threaded portion 584 of second end 558. Second end 558 is formed of any suitable size, shape, and design and is configured to connect to inner hose 536. In the arrangement shown, as one example, second end 558 is a hose fitting which is a generally cylindrical member with a first threaded portion 580, an angled portion 582, and a second threaded portion 584. In the arrangement shown, as one example, second threaded portion 584 of second end 558 is generally cylindrical and externally threaded in order to be threaded into the internally threaded hollow interior 566 of body 556. In the arrangement shown, as one example, second threaded portion 584 has a radius which is greater than the radius of first threaded portion 580.

In the arrangement shown, as one example, angled portion 582 connects second threaded portion 584 and first threaded portion 580. In the arrangement shown, as one example, angled portion 582 starts with a radius equal to the radius of second threaded portion 584 where angled portion 582 and second threaded portion 584 meet. As angled portion 582 extends towards first threaded portion 580, the radius of angled portion 582 becomes smaller until it is equal to the radius of the first threaded portion 580 and meets first threaded portion 580. In the arrangement shown, as one example, first threaded portion 580 is generally cylindrical and externally threaded in order to connect to a corresponding, internally threaded fitting on inner hose 536.

Inner Hose: In the arrangement shown, as one example, hose system 28 includes inner hose 536. Inner hose 536 is formed of any suitable size, shape, and design and is configured to be positioned within outer hose 530, operably connect with the cleaning device, and facilitate the removal of waste material when the cleaning device is cleaning the floors of an anaerobic digester tank or covered lagoon. In the arrangement shown, as one example, inner hose 536 is a non-collapsible hose (e.g. a hard hose) which is configured to retain its shape, and not collapse, when the hose is under suction. Additionally, inner hose 536 is a hose capable of being rolled up or flexed in any other manner while still retaining its shape and allowing material to flow through inner hose 536 while it is rolled up or otherwise flexed.

In the arrangement shown, as one example, inner hose 536 connects to the cleaning device, via hose connector 534, at its first end. Additionally, inner hose 536 is configured to connect at its second end to a vehicle, tank, or other vessel which is configured to receive the waste material which is removed from the floor of the anaerobic digester tank or covered lagoon by the cleaning device. In the arrangement shown, as one example, inner hose 536 is configured to rest within the outer hose 530. In this way, when inner hose 536 and outer hose 530 are operably connected to the cleaning device through hose connector 534, inner hose 536 is capable of allowing for the removal of waste material picked up by the cleaning device. Additionally, in this arrangement, as one example, outer hose 530 may be filled with gas, such as nitrogen, using the gas system and hose system 28, including outer hose 530 and inner hose 536, will float in order to connect the second end of inner hose 536 to the vehicle, tank or other vessel for removal of the waste material.

Electrical Cable: In the arrangement shown, as one example, hose system 28 includes electrical cable 538. Electrical cable 538 is formed of any suitable size, shape, and design and is configured to extend through hose system 28 and provide power to the cleaning device. In the arrangement shown, as one example, electrical cable 538 is positioned outside of inner hose 536 and within outer hose 530. In this arrangement, as one example, electrical cable 538 connects at its first end to a power source, such as a generator, outlet, or other source of power, and at its second end to the cleaning device. In this way, electrical cable 538 provides power to the cleaning device. In the arrangement shown, as one example, electrical cable 538 may include any number of electrical cables or conduits for transferring electricity, and electrical cable 538 may be formed of a water resistant material which is capable of protecting the conduits for electricity when electrical cable 538 is within water or any other liquid.

Seals: In the arrangement shown, as one example, hose system 28 includes seals 540. Seals 540 are formed of any suitable size, shape, and design and are configured to connect to the aperture 136 in second end plate 70 of frame assembly 44 of box assembly 22, the aperture (not shown) in the front end plate 262 of collection box(es) 256 of collection box assembly 24, and the aperture (not shown) in rear end plate 264 of collection box(es) 256 of collection box assembly 24, in order to prevent liquid from leaking through aperture 136, the aperture in front end plate 262, and the aperture in rear end plate 264 when hose system 28 is extended through collection box assembly 24 and box assembly 22. In the arrangement shown, as one example, seals 540 include a first half 588 and a second half 590.

Care is applied when choosing the proper material for seals 540, as seals 540 must allow hose system 28 to move through seals 540 while still maintaining a proper seal to prevent liquid from leaking out as hose system 28 moves through seals 540. In the arrangement shown, as one example, seals 540 are formed of a ultra high molecular weight polyethylene which allows hose system 28 to smoothly move through seals 540 and collection box assembly 24 and box assembly 22 while still maintaining the proper seal. Additionally, in one or more alternative arrangements, seals 540 may be a self-lubricating material to allow hose system 28 to easily move through seals 540 while still preventing liquid from out as hose system 28 moves through seals 540. However, seals 540 are not so limited and seals 540 may be formed of any other type of suitable material, including polyethylene, other thermoplastic materials, other plastic materials, composite materials, any other non-metallic material, or other non-plastic material.

First Half: In the arrangement shown, as one example, seals 540 include a first half 588. First half 588 is formed of any suitable size, shape, and design and is configured to connect to second half 590 to form seals 540. In the arrangement shown, as one example, first half 588 is generally in the shape of a semi-circle. In the arrangement shown, as one example, first half 588 has end surfaces 592, a first side 594, and a second side 596. In the arrangement shown, as one example, the first side 594 of first half 588 includes a notch 598 creating a contact surface 600. Notch 598 is formed of any suitable size, shape, and design and is configured to facilitate proper alignment and engagement between seals 540 and the aperture 136 of the second end plate 70 of box assembly 22, the aperture in front end plate 262, and/or the aperture in rear end plate 264. More specifically, for exemplary purposes, when seals 540 are being installed in aperture 136 of second end plate 70 of box assembly 22, the notch 598 of the first side 594 of first half 588 is placed such that the contact surface 600 of notch 598 is in contact with either the exterior surface 139 or the interior surface 138 of second end plate 70 and the remainder of the first side 594 of first half 588 is positioned within the aperture 136 of second end plate 70 of box assembly 22. The first side 594 of first half 588 is similarly positioned with respect to the aperture in front end plate 262 and the aperture in rear end plate 264.

In the arrangement shown, as one example, first half 588 also includes a rounded interior surface 602. Rounded interior surface 602 is a rounded surface which contacts hose system 28 as hose system 28 passes through seals 540. In the arrangement shown, as one example, rounded interior surface 602 serves as a pinch point which facilitates secured engagement of hose system 28 when desired. In the arrangement shown, as one example, hose system 28 may be extended through seals 540 and, when at the desired position, the outer hose 530 of hose system 28 may be filled with gas. As outer hose 530 fills with gas, the gas forces outer hose 530 to inflate and push against the rounded interior surface 602 of seals 540. As the outer hose 530 pushes against rounded interior surface 602, outer hose 530 begins to curve around the rounded interior surface 602, thereby making it harder for outer hose 530 to move in or out. As such, rounded interior surface 602 serves a pinch point to facilitate secured engagement of hose system 28 when desired.

In the arrangement shown, as one example, first half 588 includes a backer ring 604. Backer ring 604 is formed of any suitable size, shape, and design and is configured to provide rigidity and strength to seals 540, as well as facilitate secured engagement of seals 540 to second end plate 70 of box assembly 22, front end plate 262 of collection box(es) 256 of collection box assembly 24, and/or rear end plate 264 of collection box(es) 256 of collection box assembly 24. In the arrangement shown, as one example, backer ring 604 is a generally flat member in the shape of a semi-circle. In the arrangement shown, as one example, backer ring 604 is formed of a rigid material, such as a hard metallic material, a hard plastic material, a composite material, or other any other material capable of providing rigidity and strength to seals 540. In the arrangement shown, seals 540 are securely engaged to one of first end plate 70 of box assembly 22, front end plate 262 of collection box(es) 256 of collection box assembly 24, and/or rear end plate 264 of collection box(es) 256 of collection box assembly 24 by placing connection means such as, by way of example and not limitation, screws, bolts, fasteners, rivets, or other means of connection through seals 540 and backer ring 604. In this arrangement, backer ring 604 provides a rigid surface which the connection means can engage with as they also engage with one of first end plate 70 of box assembly 22, front end plate 262 of collection box(es) 256 of collection box assembly 24, and/or rear end plate 264 of collection box(es) 256 of collection box assembly 24.

In the arrangement shown, as one example, backer ring 604 also serves as an alignment member. In the arrangement shown, as one example, backer ring 604 does not quite reach the end surfaces 592 of first half 588, thereby forming a recess in each end surface 592. These recesses formed by backer ring 604 are configured to receive protrusions formed by backer ring 620 in the end surfaces 608 of second half 590.

Second Half: In the arrangement shown, as one example, seals 540 include a second half 590. Second half 590 is formed of any suitable size, shape, and design and is configured to connect to first half 588 to form seals 540. In the arrangement shown, as one example, second half 590 is generally in the shape of a semi-circle. In the arrangement shown, as one example, second half 590 has end surfaces 608, a first side 610, and a second side 612. In the arrangement shown, as one example, the first side 610 of second half 590 includes a notch 614 creating a contact surface 616, which are configured to be in alignment with, and complimentary to, the notch 598 and contact surface 600 of first half 588.

As with notch 598 and contact surface 600 of first half 588, notch 614 is formed of any suitable size, shape, and design and is configured to facilitate proper alignment and engagement between seals 540 and aperture 136 of the second end plate 70 of box assembly 22, the aperture in front end plate 262, and/or the aperture in rear end plate 264. More specifically, for exemplary purposes, when seals 540 are being installed in aperture 136 of second end plate 70 of box assembly 22, the notch 614 of second half 590 is placed such that the contact surface 616 of notch 614 is in contact with either the exterior surface 139 or interior surface 138 of second end plate 70 and the remainder of the first side 610 of second half 590 is positioned within the aperture 136 of second end plate 70 of box assembly 22. The first side 610 of second half 590 is similarly positioned with respect to the aperture in front end plate 262 and the aperture in rear end plate 264.

In the arrangement shown, as one example, second half 590 also includes a rounded interior surface 618, which is configured to be in alignment with rounded interior surface 602 of first half 588, such that when first half 588 and second half 590 of seals 540 are connected, there is one continuous rounded interior surface comprised of rounded interior surface 602 and rounded interior surface 618. Similar to rounded interior surface 602 of first half 588, rounded interior surface 618 is a rounded surface which contacts hose system 28 as hose system 28 passes through seals 540. In the arrangement shown, as one example, rounded interior surface 618 serves as a pinch point which facilitates secured engagement of hose system 28 when desired. In the arrangement shown, as one example, hose system 28 may be extended through seals 540 and, when at the desired position, the outer hose 530 of hose system 28 is filled with gas. As outer hose 530 fills with gas, the gas forces outer hose 530 to inflate and push against the rounded interior surface 618 of seals 540. As the outer hose 530 pushes against rounded interior surface 618, outer hose 530 begins to curve around the rounded interior surface 618, thereby making it harder for outer hose 530 to move in or out. As such, rounded interior surface 618 serves a pinch point to facilitate secured engagement of hose system 28 when desired.

In the arrangement shown, as one example, second half 590 includes a backer ring 620. Backer ring 620 is formed of any suitable size, shape, and design and is configured to provide rigidity and strength to seals 540, as well as facilitate secured engagement of seals 540 to second end plate 70 of box assembly 22, front end plate 262 of collection box(es) 256 of collection box assembly 24, and/or rear end plate 264 of collection box(es) 256 of collection box assembly 24. In the arrangement shown, as one example, backer ring 620 is a generally flat member in the shape of a semi-circle. In the arrangement shown, as one example, backer ring 620 is formed of a rigid material, such as a hard metallic material, a hard plastic material, a composite material, or other any other material capable of providing rigidity and strength to seals 540. In the arrangement shown, seals 540 are securely engaged to one of first end plate 70 of box assembly 22, front end plate 262 of collection box(es) 256 of collection box assembly 24, and/or rear end plate 264 of collection box(es) 256 of collection box assembly 24 by placing connection means such as, by way of example and not limitation, screws, bolts, fasteners, rivets, or other means of connection through seals 540 and backer ring 620. In this arrangement, backer ring 620 provides a rigid surface which the connection means can engage with as they also engage with one of first end plate 70 of box assembly 22, front end plate 262 of collection box(es) 256 of collection box assembly 24, and/or rear end plate 264 of collection box(es) 256 of collection box assembly 24.

In the arrangement shown, as one example, backer ring 620 also serves as an alignment member. In the arrangement shown, as one example, backer ring 620 extends upward from the top of each end surface 608 of second half 590. In this arrangement backer ring 620 forms protrusions in each end surface 608 which are configured to help align with the recesses formed in the end surfaces 592 of first half 588.

In the arrangement shown, as one example, when first half 588 and second half 590 are properly aligned, a screw, bolt, rivet, or other fastener may be placed through either first half 588 or second half 590 and fastened such that first half 588 and second half 590 are securely connected, thereby forming seals 540. While seals 540 have been described as having a first half 588 and a second half 590, seals 540 are not so limited. Rather, seals 540 may be a single, unitary member formed through a process such as molding, as one example. In the arrangement where seals 540 are formed as a single, unitary member through molding, the backer ring 604 and backer ring 620 may be separate pieces, or they may be one single backer ring, and they may be placed into a mold while material such as ultra high molecular weight polyethylene, as one example, are inserted into the mold and allowed to form around the backer ring. In this way, seals 540 may also be formed as a single member, rather than as a first half 588 or second half 590.

While seals 540 have been described according the arrangement shown, as one example, it will be understood by those skilled in the art that any other configuration of seals 540 may be used in order to prevent liquid from leaking through aperture 136, the aperture in front end plate 262, and the aperture in rear end plate 264 when hose system 28 is extended through collection box assembly 24 and box assembly 22.

In one or more arrangements, as examples, hose system 28 may additionally or alternatively include an inflatable seal assembly 630. Inflatable seal assembly 630 is formed of any suitable size, shape, and design and is configured to prevent liquid from leaking out of system 10 and help control the pressure within box assembly 22. In one or more arrangements, as examples, because inflatable seal assembly 630 is configured to help control the pressure within box assembly 22, inflatable seal assembly 630 acts as a catastrophe prevention system and/or a pressure equilibrium system.

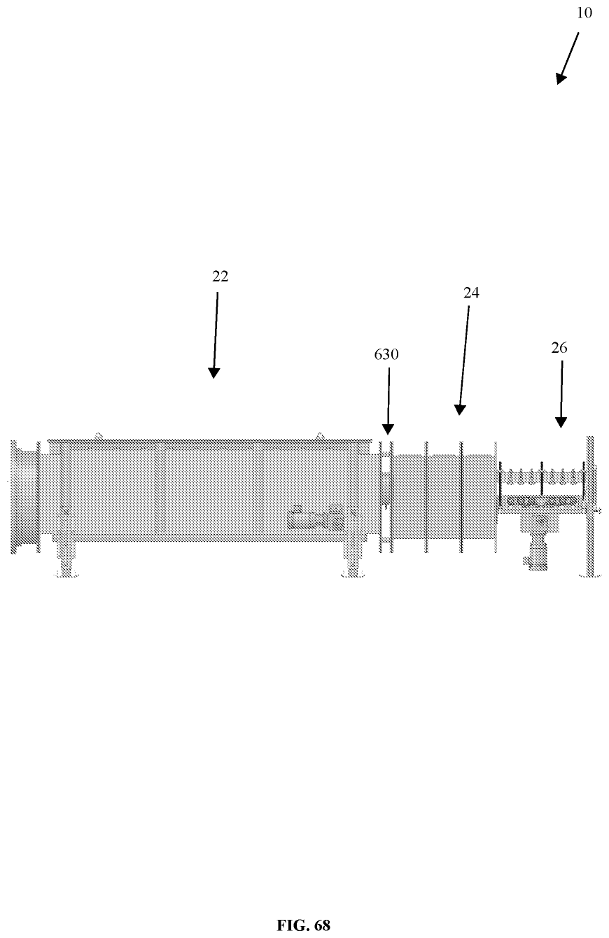

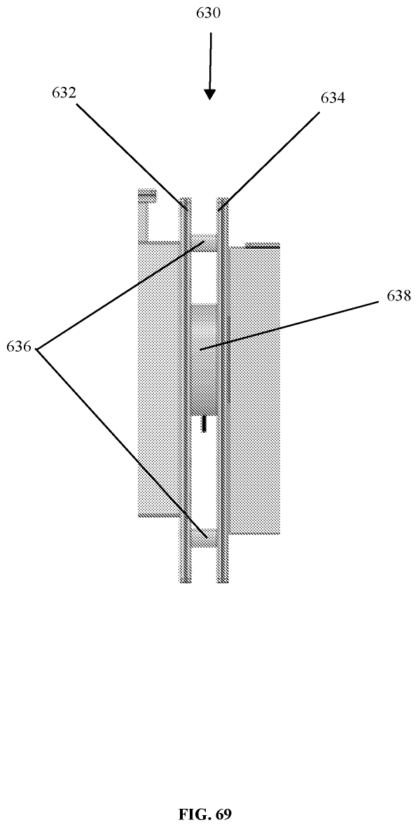

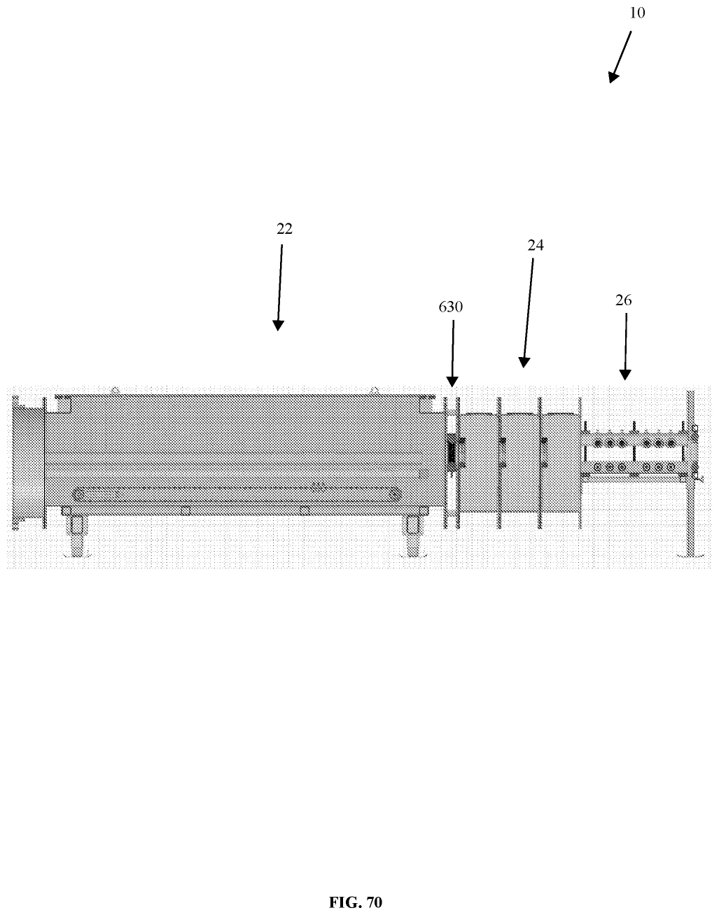

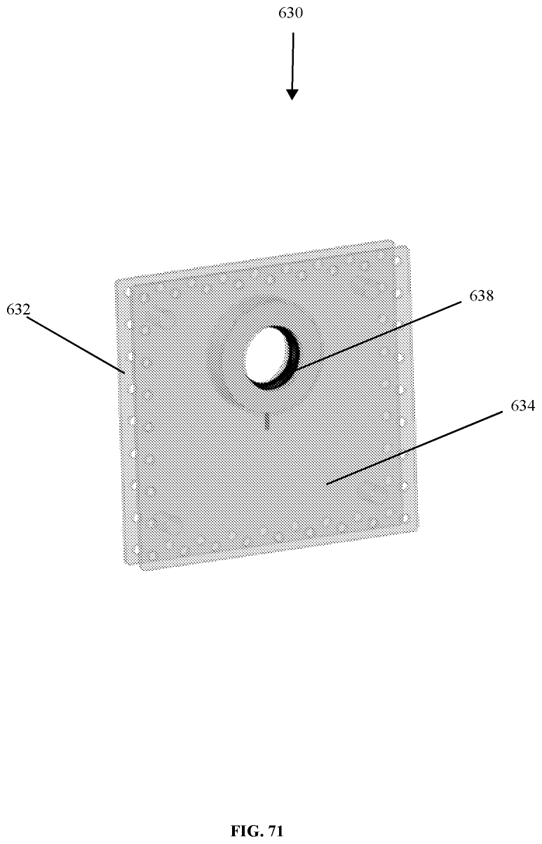

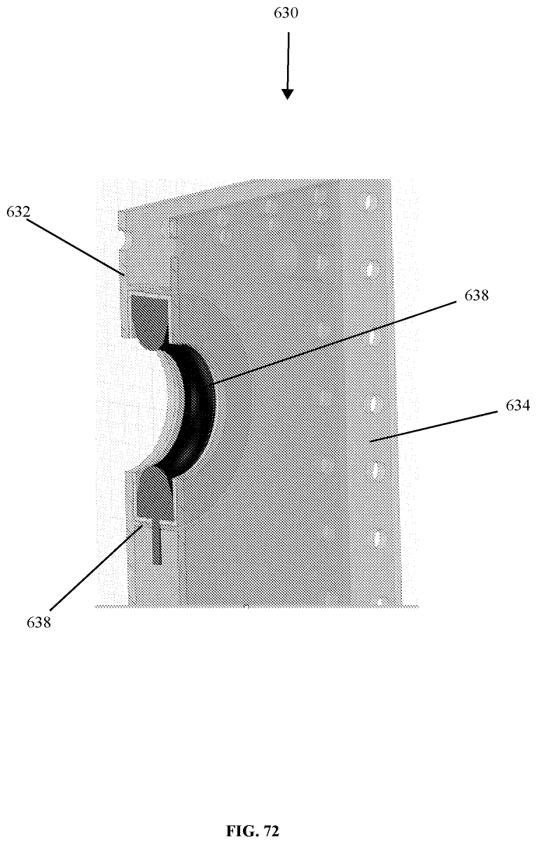

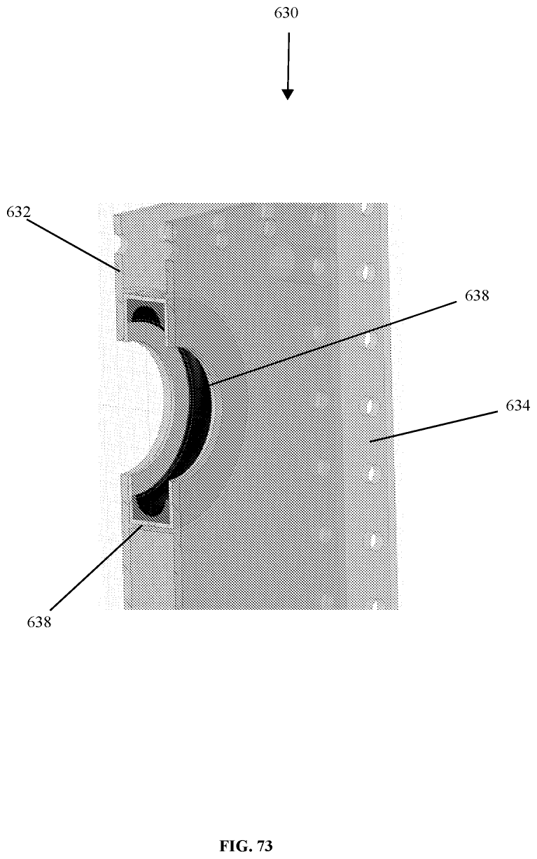

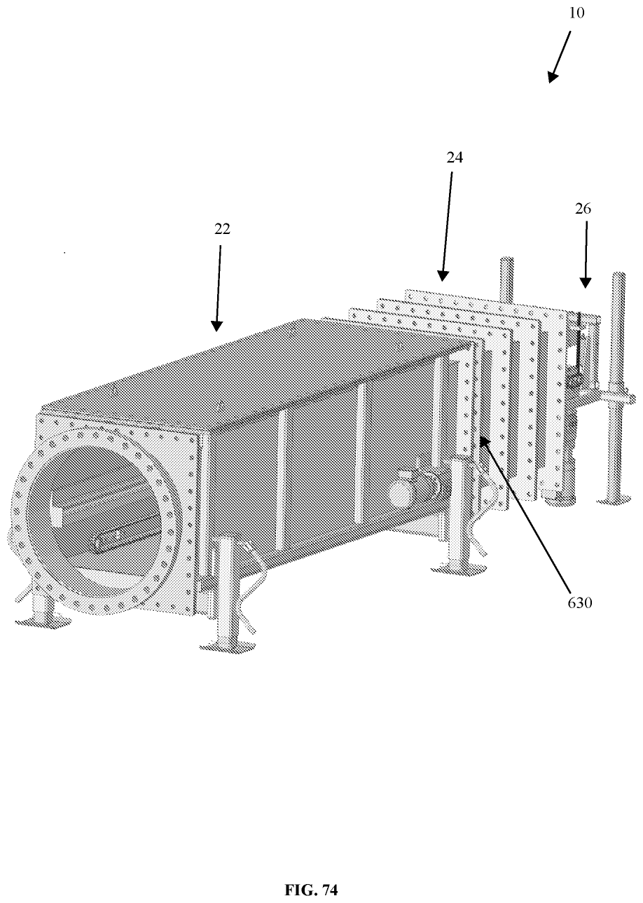

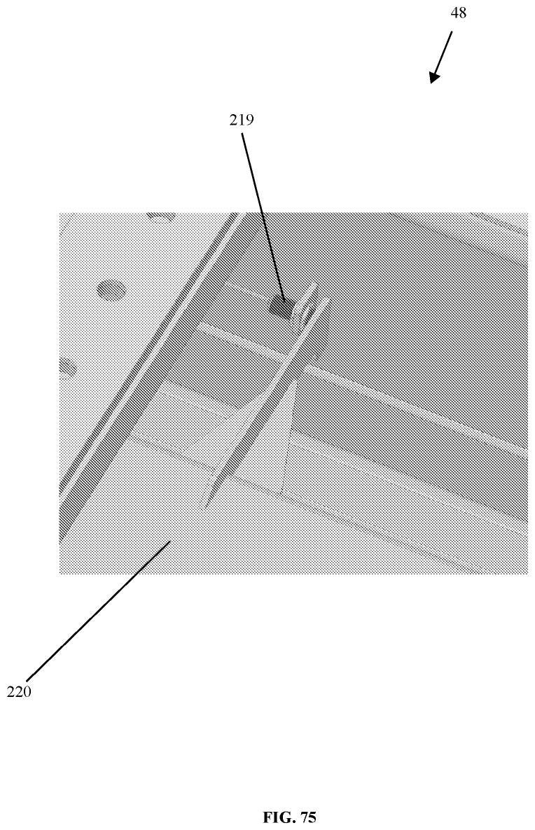

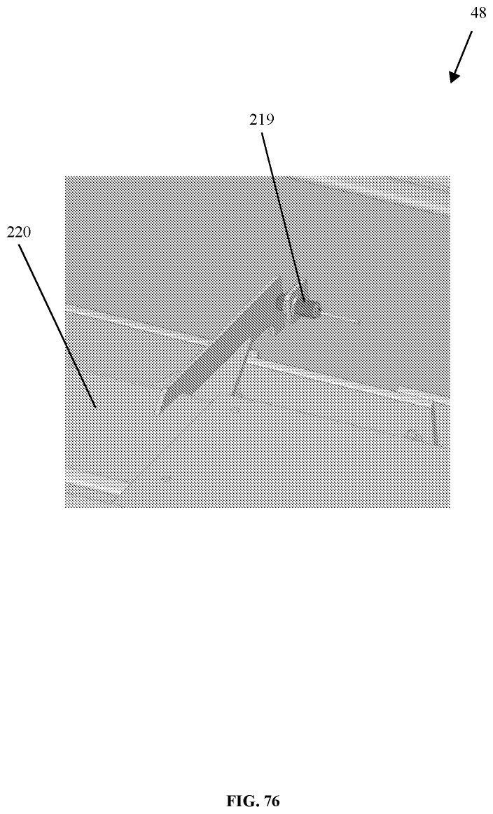

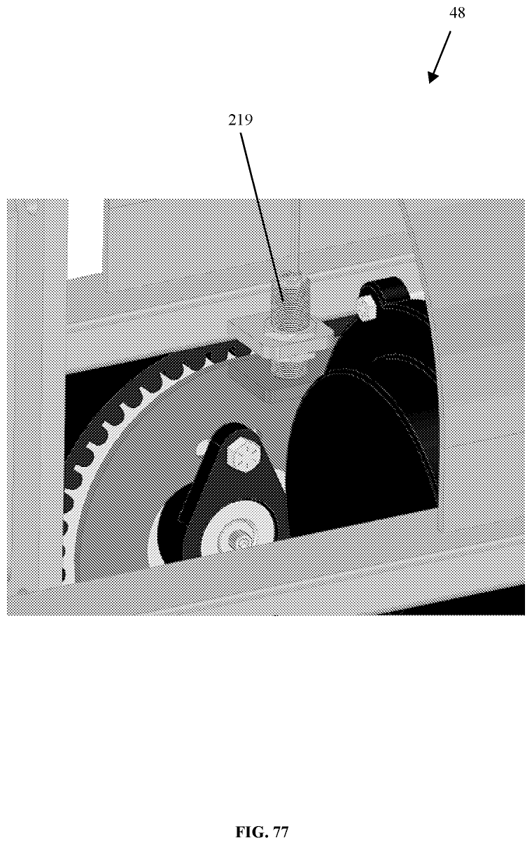

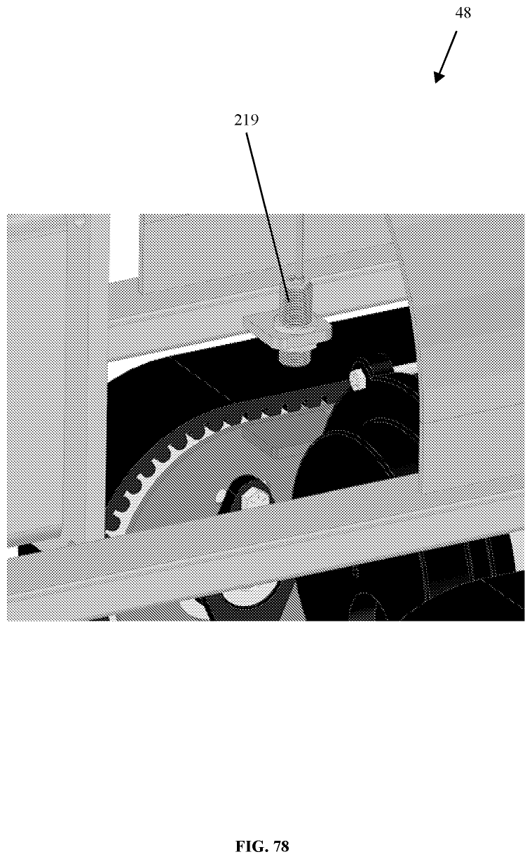

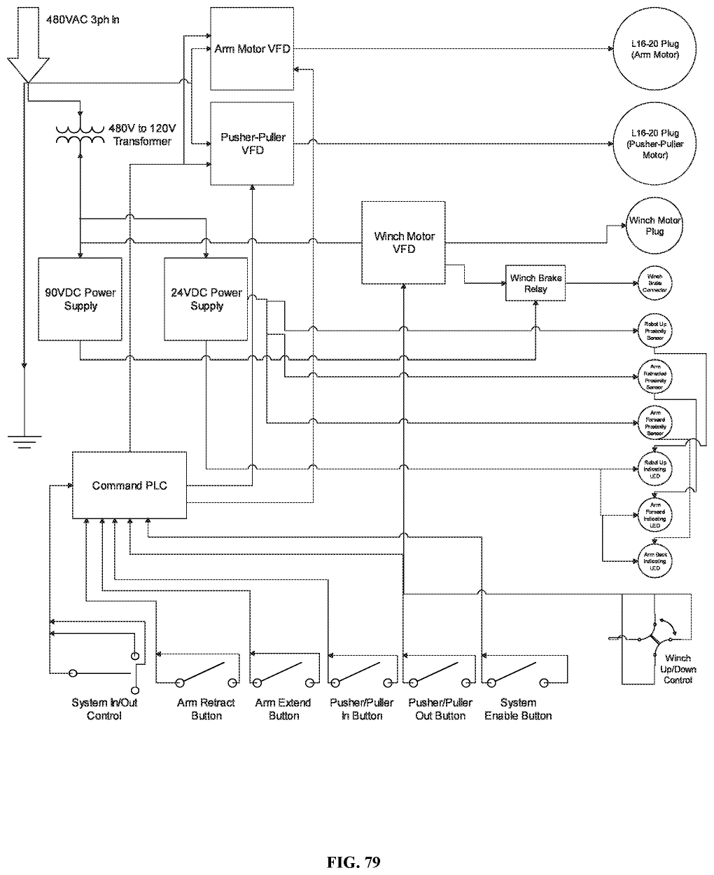

In one or more alternative arrangements, as examples, there may be a gap between box assembly 22 and the first collection box 256 of collection box assembly 24 of system 10, and inflatable seal assembly 630 may be positioned within such gap. One or more examples of such arrangement may be found in FIGS. 68-74. In one or more arrangements, as examples, inflatable seal assembly 630 has a front plate 632, a rear plate 634, spacers 636, and a housing 638.

In the arrangement shown, as one example, front plate 632 and rear plate 634 are generally square or rectangular, planar members shaped and sized similar to second end plate 70 of frame assembly 44 of box assembly 22 and/or front end plate 262 of collection box 256 of collection box assembly 24. In the arrangement shown, as one example, front plate 632 of inflatable seal assembly 630 connects to second end plate 70 of frame assembly 44 of box assembly 22. In the arrangement shown, as one example, the rear plate 634 of inflatable seal system 630 connects to the front end plate 262 of the first collection box 256 of collection box assembly 24. In the arrangement shown, as one example, front plate 632 and rear plate 634 are connected by spacers 636 and housing 638. In the arrangement shown, as one example, front plate 632 may connect to second end plate 70, and rear plate 634 may connect to front end plate 262, through any means of connection such as bolting, riveting, screwing, welding, or any other means of connection.

In the arrangement shown, as one example, spacers 636 are formed of any suitable size, shape, and design and are configured to connect front plate 632 and rear plate 634 and provide rigidity to inflatable seal assembly 630. In the arrangement shown, as one example, spacers 626 are generally elongated cylindrical members, however spacers 626 may be any other shape or design in order to connect front plate 632 and rear plate 634, including an elongated square, rectangular, triangular, or any other shaped member. In the arrangement shown, as one example, there are four spacers 636, one at each of the corners of front plate 632 and rear plate 634. However, any other number of spacers 636 may be used and they may be placed in any other location or arrangement relative to front plate 632 and/or rear plate 634. In the arrangement shown, as one example, spacers 636 may be connected to front plate 632 and/or rear plate 634 through any means of connection including welding, bolting, riveting, adhesives, or any other means of connection.

In the arrangement shown, as on example, housing 638 also extends from front plate 632 to rear plate 634. Housing 638 is formed of any suitable size, shape, and design and is configured to house inflatable seal 640 and allow hose system 28 to pass therethrough. In the arrangement shown, as one example, housing 638 is a generally cylindrical member which extends from front plate 632 to rear plate 634, and housing 638 has a hollow interior. In the arrangement shown, as one example, housing 638 may be connected to front plate 632 and/or rear plate 634 through any means of connection including welding, bolting, riveting, adhesives, or any other means of connection.

In the arrangement shown, as one example, housing 638 is positioned such that the hose system 28 extending through box assembly 22 and collection box assembly 24 may extend through the hollow interior of housing 638. Said another way, in the arrangement shown as one example, the hollow interior of housing 638 is in alignment with the aperture 136 of second end plate 68 of collection box assembly 22 and the aperture (not shown) of front end plate 262 of collection box 256 of collection box assembly 24. In this way, hose system 28 may extend through housing 638.

In the arrangement shown, as one example, housing 638 houses inflatable seal 640. Inflatable seal 640 is formed of any suitable size, shape, and design and is configured to inflate, prevent liquid from leaking out of system 10, and help control the pressure within box assembly 22. In the arrangement shown, as one example, inflatable seal 640 is an inflatable O-ring that is generally in the shape of a circle with an open center. In the arrangement shown, as one example, inflatable seal 640 is positioned within housing 638 such that the exterior sides of inflatable seal 640 contact the interior surfaces of housing 638. In one or more arrangements, as examples, inflatable seal 640 may be permanently or removably connected to the interior of housing 638 such as through adhesives or any other means of connection.

In the arrangement shown, as one example, inflatable seal 640 may be shaped and sized such that the diameter of the open center of the inflatable seal 640 may fluctuate from 8 inches (when uninflated) to 2 inches (when inflated). While the diameter of the open center of inflatable seal 640 may fluctuate from 8 inches to 2 inches, in the arrangement shown as one example, inflatable seal 640 may be any other size and the diameter of the open center of inflatable seal 640 may fluctuate anywhere from 0 inches (a fully closed seal) to 10 inches or more, as system 10 may allow or require.

In the arrangement shown, as one example, the outer hose 530 (and inner hose 536 and electrical cable 538) are configured to extent through the open center of inflatable seal 640. When the outer hose 530 is extended through the open center of inflatable seal 640, the exterior of out hose 530 makes contact with the interior surface of inflatable seal 640 within close connection to create a seal around outer hose 530 that is, or is nearly, liquid tight. As the pressure inside box assembly 22 increases, the seal around outer hose 530 may allow liquid to leak out between outer hose 530 and inflatable seal 640. In order to prevent this leaking of liquid, a user may inflate inflatable seal 640 to a desired level. At this desired level, the seal between inflatable seal 640 and outer hose 530 becomes tighter and the pressure within box assembly 22 is no longer strong enough to push liquid through such seal. In this way, inflatable seal 640 and inflatable seal assembly 630, help to prevent liquid leaking from system 10. In the arrangement shown, as one example, inflatable seal 640 is able to prevent leaks at pressures inside box assembly 22 that are large and would otherwise cause hose seals 540 to fail. Said another way, inflatable seal 640 is able to prevent liquid from leaking, even when under pressures that would cause hose seals 540 to fail. Because pressures will typically be higher in box assembly 22 than in any collection box 256 of collection box assembly 24, in most arrangements, as examples, inflatable seal assembly 630 will be placed between box assembly 22 and the first collection box 256 of collection box assembly 24.

Care is applied when choosing the proper material for inflatable seal 640, as inflatable seal 640 must be expandable and retractable to account for inflation of inflatable seal 640, and inflatable seal 640 must allow hose system 28 to move through inflatable seal 640 while still maintaining a proper seal to prevent liquid from leaking out as hose system 28 moves through inflatable seal 640. In the arrangement shown, as one example, inflatable seal 640 is formed of a ultra high molecular weight polyethylene which allows hose system 28 to smoothly move through inflatable seal 640 and box assembly 22 while still maintaining the proper seal. Additionally, in one or more alternative arrangements, inflatable seal 640 may be a self-lubricating material to allow hose system 28 to easily move through inflatable seal 640 while still preventing liquid from out as hose system 28 moves through inflatable seal 640. However, inflatable seal 640 is not so limited and inflatable seal 640 may be formed of any other type of suitable material, including polyethylene, other thermoplastic materials, other plastic materials, composite materials, any other non-metallic material, or other non-plastic material.

In the arrangement shown, as one example, inflatable seal 640 may be operably connected to the gas system of hose system 28 such that the gas system may insert gas into inflatable seal 640 in order to inflate inflatable seal 640. Alternatively, in one or more arrangements as examples, inflatable seal 640 may be connected to a second gas system which is configured to insert gas into inflatable seal 640 in order to inflate inflatable seal 640. In the arrangement shown, as one example, the gas system operably connected to inflatable seal 640 may be controlled manually or electronically. Additionally or alternatively, in one or more arrangements as examples, system 10 and/or inflatable seal assembly 630 may include sensors and a control circuit which allows inflatable seal 640 to be inflated automatically upon certain events specified in the control circuit. For example, in one or more arrangements, inflatable seal assembly 630 may include sensors (such as pressure sensors) which are configured to measure certain metrics (such as pressure within box assembly 22) and when such sensors measure a metric (such as pressure) which is outside of set limits, the control circuit will operate to automatically inflate or deflate inflatable seal 640. In this way, inflatable seal assembly 630 may act as a catastrophe prevention system. In another arrangement, as one example, the sensors may include a read-out which can be viewed by persons monitoring system 10 and when the read-outs from the sensors shows a measurement outside of set limits, the person monitoring system 10 may activate the gas system connected to inflatable seal 640 in order to inflate or deflate inflatable seal 640 and, in this way, inflatable seal assembly 630 may act as a catastrophe prevention system.

In one or more arrangements, as examples, inflatable seal assembly 630 may also act as a catastrophe prevention system if there is a malfunction with the cleaning device while it is inside the closed system (such as an anaerobic digester tank or covered lagoon). In one or more arrangements, as examples, the hose system 28 may include sensors which measure the flow of fluid through the inner hose 536 of hose system 28. If such sensors measure a disruption in the flow of fluid (which may happen when the inner hose 536 is clogged with a solid material), then the inflatable hose 640 may be inflated, essentially cutting off box assembly 22 from any outside flow, and then the cleaning device may be brought back into box assembly 22 and the issue may be fixed. In this way, inflatable seal 640 acts as a type of emergency cut-off and catastrophe prevention system if something malfunctions in system 10 while a cleaning operating is being performed.

In one or more arrangements, as examples, inflatable seal assembly 630 may also operate to equalize pressure in box assembly 22 and the close system (such as an anaerobic digester tank or covered lagoon) prior to opening the gate of such closed system. In one or more arrangements, as examples, persons operating and monitoring system 10 know the pressure inside the closed system and, prior to opening the gate of such closed system, the persons operating system 10 may extend outer hose 530 through the open center of inflatable seal 640 and connect hose system 28 to the cleaning device through hose connector 534. Next, in this arrangement as one example, the person operating system 10 may fill inflatable seal 640 with gas to a desired level corresponding to the pressure within the closed system. Once inflatable seal 640 is at the desired level of inflation, the person operating system 10 may then use the gas system connected to hose system 28, or any other gas system, to insert gas into box assembly 22 until the pressure within box assembly 22 is equal to the pressure within the closed system. In this way, when the gate of such closed system is opened, box assembly 22 will already be at an equal pressure to the closed system and this will prevent a strong rush of liquid into box assembly 22 once the gate is opened. In this way, inflatable seal 640 may act as a pressure equilibrium system.

### In Operation:

System 10 is operated by a user to clean the floor of an anaerobic digester tank or covered lagoon. In this operation, box assembly 22 may be placed adjacent a gate complex of the anaerobic digester tank or covered lagoon. The user may raise or lower the height of box assembly 22 by using the adjustment mechanism 198 of legs 46 to raise or lower box assembly 22 to the proper height, such that the open center 130 and the gate connection member 134 (if present) of first end plate 68 lines up with the opening of the gate complex of the anaerobic digester tank or covered lagoon. Box assembly 22 may then be operably connected to the gate complex such as through bolting, riveting, welding, screwing, fastening, or any other connection means.

Either before or after connecting box assembly 22 to the gate complex of the anaerobic digester tank or covered lagoon, collection box assembly 24 is connected to box assembly 22. In the arrangement shown, as one example, the front end plate 262 of a first collection box 256 is connected to the second end plate 70 of frame assembly 44 of box assembly 22 through any connection means such as bolting, riveting, welding, screwing, fastening, or any other connection means. Care will be taken when connecting front end plate 262 to second end plate 70 to ensure that aperture 136 of second end plate 70 is in alignment with the aperture (not shown) extending through front end plate 262. If desired, additional collection boxes 256 may be connected to the first collection box 256 to form collection box assembly 24. Additional collection boxes 256 are added by connecting the front end plate 262 of an additional collection box 256 to the rear end plate 264 of the immediately preceding collection box 256 through connection means such as bolting, riveting, welding, screwing, fastening, or any other connection means. Additional collection boxes 256 may be added in this manner until the desired number of collection boxes 256 in collection box assembly 24 is met.

Either before or after collection box assembly 24 is connected to box assembly 22, and before or after box assembly 22 is connected to the gate complex of the anaerobic digester tank or covered lagoon, seals 540 may be installed. In the arrangement shown, as one example, a first seal 540 is connected to aperture 136 of second end plate 70. In the arrangement shown, as one example, the first seal 540 is placed adjacent the aperture 136 such that the contact surface 600 of first half 588 and contact surface 616 of second half 590 are in connection with the interior surface 138 of second end plate 70 and the remainder of the first side 594 and first side 610 are positioned inside the aperture 136. Any means of connection are used to securely connect seals 540 to second end plate 70. At this time, a second seal 540 is connected to the aperture (not shown) in the rear end plate 264 of a first collection box 256. The second seal 540 is placed adjacent the aperture in the rear end plate 264 such that the contact surface 600 of first half 588 and contact surface 616 of second half 590 are in connection with the forward surface 286 of rear end plate 264 and the remainder of the first side 594 and first side 610 are positioned inside the aperture in the rear end plate 264. If a second collection box 256 is included in collection box assembly 24, a third seal 540 may be placed adjacent the aperture in the rear end plate 264 of such collection box assembly 24 as described above.

Once collection box assembly 24 is connected to box assembly 22, hose mover assembly 26 may be connected to collection box assembly 24. Hose mover assembly 26 is placed such that the connection plates 330 of frame 310 of hose mover assembly 26 are engaged with the rear surface 288 of rear end plate 264 of the last collection box 256 of collection box assembly 24. In the arrangement shown, as one example, a user can then raise or lower the height of hose mover assembly 26, as desired, by loosening the tightening mechanism 360 of leg tubes 354, allowing for frame 310 to move up or down along legs 322. Once the desired height is met, the user can tighten tightening mechanism 360 and connection means such as a bolt, rivet, screws, fasteners, or any other connection means may then be used to securely connect connection plates 330 to rear end plate 264.

When done properly, hose mover 26 should be aligned such that once hose system 28 moves through the roller system 314 of hose mover assembly 26, hose system 28 will be led directly into the aperture (not shown) of rear end plate 264 of collection box 256. Once hose mover assembly 26 is securely connected to collection box assembly 24, hose mover 26 may be turned on by the user to extend hose system 28 through system 10. Once hose system 28 is through the aperture (not shown) of rear end plate 264, hose system 28 will then extend through the interior of said collection box 256 and through the aperture (not shown) in the front end plate 262 of said collection box 256. If said collection box 256 is connected to an additional collection box 256, hose system 28 will also extend through the aperture (not shown) in the rear end plate 264 of the additional collection box 256, extend through the interior of the additional collection box 256, and then extend through the aperture (not shown) in the front end plate 262 of the additional collection box 256. Hose system 28 will extend through as many collection boxes 256 in such a manner until it comes to the collection box 256 connected to the second end plate 70 of frame assembly 44.

Once hose system 28 reaches second end plate 70, it will extend through aperture 136 of second end plate 70 and into the interior of box assembly 22. At such time, hose system 28 will then extend into and through the orifice 226 of main tube 220 of carriage 214 of carrier assembly 48. Once hose system 28 extends through the orifice 226 of carriage 214, it is able to be connected to the cleaning device. In the arrangement shown, as one example, the first threaded portion 560 of first end 554 of hose connector 534 extends outward from outer hose 530 and inner hose 536. The first threaded portion 560 of first end 554 of hose connector 534 is threaded into a corresponding, internally threaded receiver on the cleaning device. In this way, inner hose 536 is operably connected to the cleaning device such that waste material removed by the cleaning device may be sucked through inner hose 536. At this point, the electrical cable 538 of hose system 28 is also connected to the cleaning device in order to provide power to the cleaning device. With hose system 28 extending through hose mover assembly 26, collection box assembly 24, and box assembly 22, the cleaning device is ready to enter the anaerobic digester tank or covered lagoon in order to clean the floor of such tank or covered lagoon.

When the cleaning device is ready to be inserted, the gate complex of the anaerobic digester tank or covered lagoon will be opened. Once the tank if opened, liquid will begin to enter into box assembly 22. At this time, a first knife gate valve 240 of drain assembly 52, which is connected to the pipe nipple 238 connected to the drain opening 128 of floor panel 66 of box assembly 22, is open. This allows for liquid which enters into box assembly 22 to enter into the box assembly pipe section 242 where it will continue to drain away from box assembly 22, however liquid will be entering box assembly 22 quicker than it will be drained through drain opening 128 and box assembly 22 will fill with liquid. Once box assembly 22 is filled with liquid, the first knife gate valve 240 of drain assembly 52 is closed, thereby preventing any more liquid from draining from box assembly 22. At this point, the pressure inside box assembly 22 will be approximately equal to the pressure within the anaerobic digester tank or covered lagoon. At this point liquid will want to escape box assembly 22 through aperture 136, however seal 540 will prevent the majority of liquid from leaving box assembly 22. Whatever liquid does leave box assembly 22 will enter into the first collection box 256 of collection box assembly 24. A second knife gate valve 240 of drain assembly 52, which is connected to the pipe nipple 238 connected to the drain opening of bottom plate 259 of collection box 256, is opened. As liquid enters into collection box 256, it will be drained through the drain opening. If needed or desired, an additional collection box 256 may be provided and, if the first collection box 256 fills with liquid, the second knife gate valve 240 may be closed and liquid will have filled the first collection box 256. Liquid will then want to escape from the first collection box 256 through the aperture in the rear end plate 264, however seal 540 will again prevent most of the liquid from leaking through. If any liquid does leak through, it will enter into a second collection box 256 operated similar to first collection box 256. As many collection boxes 256 may be provided to present liquid from escaping system 10 as a whole.

Once box assembly 22 is filled with liquid, hose mover assembly 26 may be activated to move enough of hose system 28 into the box assembly 22 to allow the cleaning device connected to hose system 28 to be inserted into the tank or covered lagoon. Carrier assembly 48 is then used to push the cleaning device towards the anaerobic digester tank or covered lagoon. In order to push the cleaning device towards the anaerobic digester tank or covered lagoon, the motor 230 of chain drive system 228 of carrier assembly 48 is activated. Motor 230 will cause the drive shaft (not shown) of motor 230 to rotate. The drive shaft will then transfer its rotational movement to carrier chains 234, which begin to rotate and move carriage 214 forward, which will in turn push the cleaning device forward, through the open center 130 and gate connection member 134 (if present) of first end plate 68, and into the tank or covered lagoon.

Once the cleaning device is inside the tank or covered lagoon, it will either enter on the floor, or it will descend to the floor of the tank or covered lagoon and the hose system 28 will also descend with the cleaning device. At this time, a user may use a gas system to pump gas, such as nitrogen, into outer hose 530, thereby causing outer hose 530 to become buoyant and, at least partially, float. The cleaning device will start cleaning the floor of the tank or covered lagoon. As the cleaning device cleans the floor, waste material will be sucked in to the cleaning device and out of system 10 through inner hose 536. When the cleaning device has finished cleaning an area of the floor of the tank or covered lagoon, a user may use hose mover assembly 26 to force more of hose system 28 into and through collection box assembly 24 and box assembly 22 to allow the cleaning device to move to a further area of the floor to clean that area. This process is repeated, with more of hose system 28 being moved into the tank or covered lagoon by hose mover assembly 26 as needed until the entire floor, or desired portion of the floor, of the anaerobic digester tank or covered lagoon is cleaned.

Once the entire floor, or desired portion of the floor, of the anaerobic digester tank or covered lagoon has been cleaned by the cleaning device and waste material removed through inner hose 536, the cleaning device can be brought back into the interior of box assembly 22. To pull the cleaning device back to box assembly 22, winch assembly 218 may be used, and hose mover assembly 26 is also put in reverse and used to pull hose system 28 back such that hose system 28 and the cleaning device are both pulled back until the cleaning device is back resting within the interior of box assembly 22. Once the cleaning device is back, the gate assembly of the anaerobic digester tank or covered lagoon will close and each of the knife gate valves 240 may be opened so that any liquid contained in the box assembly 22, as well as any collection box(es) 256 of collection box assembly 24 can be drained using drain assembly 52. Once all liquid is drained through drain assembly 52, operation of system 10 is complete.

From the above discussion it will be appreciated that the system 10 presented herein improves upon the state of the art. Specifically, in one or more arrangements, a system 10 is presented which: improves upon the state of the art; is safe to operate; is relatively easy to build; is relatively friendly to build; can be built relatively quickly and efficiently; is easy to operate; is relatively cost friendly to manufacture; is relatively easy to transport; is aesthetically appealing; is robust; is relatively inexpensive; is not easily susceptible to wear and tear; has a long useful life; is efficient to use and operate.

What is claimed:

1. A cleaning system for a liquid storage system, the system comprising:
a box assembly;
wherein the box assembly is configured to operably attach to the liquid storage system;
a hose system;
wherein the hose system is comprised of an inner hose positioned within an outer hose;
wherein the hose system is configured to connect to a cleaning device;
wherein the hose system is configured to extend through the box assembly;
wherein the cleaning system is configured to selectively deploy the cleaning device into the liquid storage system and selectively remove the cleaning device from the liquid storage system.

2. The system of claim 1 wherein the hose system is configured to move through the box assembly and into the liquid storage system.

3. The system of claim 1 further comprising:
the box assembly having an aperture;
the hose system configured to extend through the aperture of the box assembly;
a seal;
the seal positioned at least partially within the aperture of the box assembly;
wherein the hose system extends through the aperture of the box assembly and through the seal;
wherein the seal is configured to engage the hose system and prevent or reduce liquid from escaping through the aperture of the box assembly.

4. The system of claim 1 wherein the outer hose is a lay-flat hose.

5. The system of claim 1 wherein the inner hose is a non-collapsible hose.

6. The system of claim 1 further comprising:
a gas system connected to the hose system;
wherein the gas system is configured to insert gas into the outer hose of the hose system; and
wherein the gas system is configured to control buoyancy of a portion of the hose system positioned within the liquid storage system.

7. The system of claim 1 further comprising:
an electrical cable;
wherein the electrical cable is positioned outside the inner hose and within the outer hose; and
wherein the electrical cable is configured to provide power to the cleaning device.

8. The system of claim 1 further comprising:
a hose mover assembly;
the hose mover assembly operatively connected to the box assembly;
wherein the hose mover assembly is configured to help facilitate movement of the hose system into and out of the liquid storage system.

9. A cleaning system for a liquid storage system, the system comprising:
a box assembly;
the box assembly having an aperture;
wherein the box assembly is configured to house a cleaning device;
a hose system;
the hose system connected to the cleaning device;
a seal;
the seal positioned at least partially within the aperture of the box assembly;
wherein the hose system is configured to extend through the aperture of the box assembly and through the seal of the aperture and into the liquid storage system;
wherein the seal is configured to engage the hose system and prevent or reduce liquid from escaping through the aperture of the box assembly.

10. The system of claim 9 wherein the hose system is configured to move through the box assembly and the liquid storage system.

11. The system of claim 9 wherein the seal is comprised of a thermoplastic material.

12. The system of claim 9 wherein the seal is comprised of polyethylene.

13. The system of claim 9 wherein the seal is comprised of ultra high molecular weight polyethylene.

14. The system of claim 9 wherein the seal is self-lubricating.

15. The system of claim 9 further comprising:
a gas system;
the gas system operatively connected to the hose system;
wherein the gas system is configured to insert gas into the hose system.

16. The system of claim 9 wherein the cleaning device is configured to clean the liquid storage system.

17. The system of claim 9 further comprising:
a hose mover assembly;
the hose mover assembly operatively connected to the box assembly;
wherein the hose mover assembly is configured to help facilitate movement of the hose system into and out of the liquid storage system.

18. A cleaning system for a liquid storage system, the system comprising:
a box assembly;
wherein the box assembly attaches to the liquid storage system;
a hose system;
the hose system configured to extend through the box assembly and retractably extend into the liquid storage system;
a cleaning device;
the cleaning device operatively connected to the hose system;
a hose mover assembly;
the hose mover assembly connected to the box assembly;
wherein the hose system extends through the hose mover assembly; and
wherein the hose mover assembly is configured to help facilitate movement of the hose system in and out of the liquid storage system.

19. The system of claim 18 further comprising:
the box assembly having an aperture;
the hose system configured to extend through the aperture of the box assembly;
a seal;
the seal positioned at least partially within the aperture of the box assembly;
wherein the hose system extends through aperture of the box assembly and through the seal;
wherein the seal is configured to reduce or prevent liquid from escaping through the aperture of the box assembly.

20. The system of claim 18 wherein the hose system is comprised of an inner hose positioned within an outer hose.

21. The system of claim 18 further comprising:
a gas system;
the gas system connected to the hose system;
wherein the gas system is configured to insert gas into the hose system; and
wherein the gas system is configured to control buoyancy of the hose system.

22. The system of claim 18 wherein the cleaning device is configured to clean the liquid storage system.

23. The system of claim 3 wherein the seal is inflatable.

24. The system of claim 3, wherein the seal is inflatable and wherein when the seal inflates gas may be inserted into the box assembly in order to equalize the pressure inside the box assembly with the pressure inside the liquid storage system.

25. The system of claim 9 wherein the seal is inflatable.

26. The system of claim 9, wherein the seal is inflatable and wherein when the seal inflates gas may be inserted into the box assembly in order to equalize the pressure inside the box assembly with the pressure inside the liquid storage system.

27. The system of claim 19 wherein the seal is inflatable.

28. The system of claim 19, wherein the seal is inflatable and wherein when the seal inflates gas may be inserted into the box assembly in order to equalize the pressure inside the box assembly with the pressure inside the liquid storage system.
